(19) United States
(12) Patent Application Publication
(10) Pub. No.: US 2025/0208163 A1
(43) Pub. Date: Jun. 26, 2025

(54) PROBES, APPARATUSES AND METHODS FOR USE IN SCANNING PROBE MICROSCOPY

(71) Applicant: YEDA RESEARCH AND DEVELOPMENT CO. LTD., Rehovot (IL)

(72) Inventors: Shahal ILANI, Rehovot (IL); Alon INBAR, Rehovot (IL); John BIRKBECK, Rehovot (IL); Jiewen XIAO, Rehovot (IL)

(21) Appl. No.: 19/073,551

(22) Filed: Mar. 7, 2025

Related U.S. Application Data
(63) Continuation-in-part of application No. PCT/IL2023/050201, filed on Feb. 27, 2023.
(60) Provisional application No. 63/375,916, filed on Sep. 16, 2022.

(51) Int. Cl. G01Q 10/02; G01Q 10/04; G01Q 60/16; G01Q 60/38

(52) U.S. Cl. CPC G01Q 10/02; G01Q 10/04; G01Q 60/16; G01Q 60/38

(57) ABSTRACT

A system is presented for use in Scanning Probe Microscope (SPM) including: a stage for carrying a sample; a head for mounting thereon an AFM cantilever or an STM probe, and a rotation motor associated with the stage or head to perform controllable rotation of one of them with respect to the other to provide desired orientation alignment between them. Also, a probe is provided for conducting measurements on a sample, comprising: a tip having core with apex covered by a layer arrangement having a support layer of vdW material and an active layer, which is 2D material of not more than 10 monolayers coupled by vdW forces and is placed on the support layer to be further away from the core; and an outer exposed layer. The layer arrangement upon contacting a planar surface forms a contact area with a linear dimension of at least 10 nm.

### CROSS-REFERENCE TO RELATED APPLICATIONS

This application is a continuation-in-part of PCT Patent Application No. PCT/IL2023/050201, filed on Feb. 27, 2023, which claims the priority benefit under 35 U.S.C. § 119 of U.S. Provisional Patent Application No. 63/375,916, filed on Sep. 16, 2022, the contents of each are hereby incorporated in its entirety by reference.

### TECHNOLOGICAL FIELD

This disclosure relates to the field of scanning probe microscopy (SPM).

### BACKGROUND

Scanning probe microscopy (SPM) is a branch of microscopy that forms images of the mechanical and electronic properties of surfaces using a physical probe that scans across the sample. It includes such types as atomic force microscopy (AFM), scanning tunneling microscopy (STM), and others. AFM includes such a sub-type as conductive AFM (CAFM, C-AFM) or current sensing AFM (CS-AFM). Other names for such techniques, or related techniques, are local-conductivity AFM (LC-AFM), conductive probe AFM (CP-AFM), conductive scanning probe microscopy (C-SPM) or conductive scanning force microscopy (C-SFM).

It is known to build CAFM with a sharp conductive probe to map local variations in a sample's conductivity with nanoscale resolution. It is used to study a sample's conductivity and image electrical properties such as charge transport and charge distribution on the nanoscale. CAFM is applied in the nanoelectronics field, solar cell and semiconductor industries for a wide variety of high resolution measurements including semiconductor dopant profiling and quality control for dielectric films and oxide layers.

The conducting probe in CAFM typically has a thin conducting coating. Common electrically conducting coatings are platinum, gold, tungsten, and conductive diamond.

CAFM is usually operated in contact mode: a bias voltage is applied between AFM tip and sample when they are in contact, and the current flow is measured between them as the probe raster scans across the surface. The contact area between tip and sample typically has a diameter in the 10 nm range.

At the same time, the topography of the surface is measured by detecting the deflection of the cantilever where the tip resides using an optical system (for example, a laser combined with a photodiode) or using a piezoresistive technique. Additionally, localized single-point measurements of current-voltage (I-V) curves can be collected with CAFM without moving the probe over the sample: when the probe is placed upon the desired point on the sample, a bias voltage may be, for example, tuned to increase in steps; and current may be measured at each step.

### GENERAL DESCRIPTION

In CAFM, the scanning contact mode of operation can lead to an aggressive tip-sample interaction that can wear down the tip quickly. At the same time, surface contamination and a water film between tip and sample, commonly present at ambient conditions, can reduce the reliability and repeatability of CAFM. Only a few nanometers of debris on the tip can block the flow of electrical current. Consequently, higher forces are often needed, requiring harder tip materials or coatings like conductive diamond-like coatings or platinum silicide since these higher forces will degrade the tip faster.

In such circumstances, the inventors have addressed a general need for sensitive SPM techniques for the characterization of the electronic structure of the sample.

The inventors have found techniques which can be used in contact mode to obtain the current measurements. The technique of the present disclosure is not limited to be implemented in CAFM; but rather can be used in systems which differ from CAFM in the structures of the probe; and/or in the type of the measured current or specifics of the characterization which it brings about; and/or in samples at which these techniques are primarily aimed; and/or in the setup and method realizing the scanning in the contact mode. The inventors have termed the relevant techniques/systems as Quantum Twisting Microscopy.

The probes suitable for use in the scanning techniques of the present disclosure are characterized by such features as a tip having a core with an apex, where this apex is covered by an active layer presenting a two-dimensional (2D) material of not more than monolayers coupled by van der Waals (vdW) forces, and the active layer is placed on a support layer of a vdW material: the active layer at that apex is thereby further away from the core than the support layer at that apex (and the active and support layers form a vdW heterostructure at the apex).

Also, the probes utilized in the technique of the present disclosure share the feature of a layer arrangement, covering the apex and the core of the tip and including at the apex at least the support layer and the active layer, which is configured to form, under a pressure against a planar surface, a contact area containing a square with a side of 10 nm or more. The contact area may take various geometrical shapes, but it contains a square with a side of 10 nm or more. The flat or flattened contact area may be larger or smaller than the apex area.

An outer layer of the layer arrangement (by which it faces the sample) is an exposed layer. The exposed layer may be configured as flat plateau (of any geometrical shape); or may be formed with a convex surface region at the apex configured to flex under contact with the planar surface into a plateau comprising said contact area.

Furthermore, the probes utilized in the technique of the present disclosure share the feature that the layer arrangement is configured to conduct an electric current to the active layer from outside (i.e. from an exposed layer if this is not the active layer, but a more externally placed layer) and then, at the apex, in a lateral dimension (substantially or even only) and through the active layer/in a vertical dimension (substantially or only).

In a first group of examples of the probe of the present disclosure (embodiments of the probe), the active layer at the apex is the exposed layer.

In a second group of examples, the tip at the apex is further covered by a tunnel barrier layer placed on the active layer; and it is the tunnel barrier layer which is the exposed layer. This tunnel barrier layer is thereby configured to present a flow path for a tunneling current between the sample and the 2D material of the active layer. The layer arrangement, which at the apex additionally includes the tunnel barrier layer, conducts the electric current by the tunneling through this layer (and then in a lateral dimension and through the active layer/along the vertical dimension).

In a third group of examples, the tip at the apex is covered instead by a defect-assisted tunneling layer on the active layer (i.e., instead of the tunnel barrier layer). The defect-assisted tunneling layer is the exposed layer and includes at least one atomic defect which presents a tunneling path for tunneling between the sample and the active layer. Each such atomic defect may provide a peak of tunneling conductance at a certain unique voltage between (a) a region proximate to the defect on the active layer and (b) a region proximate to the defect and located beyond the exposed defect-assisted tunneling layer. The sample is to be placed into the latter region. Here, the term “unique voltage” is used meaning that voltages are expected to differ for different defects. The layer arrangement, which at the apex additionally includes the defect-assisted tunneling layer, conducts the electric current by at least the tunneling via the at least one atomic defect in this layer when the applied voltage allows it (and then in a lateral dimension and through the active layer).

The defect may be of a small electronic wavefunction extent, e.g., less than 2 nm. The defect may be of the type addressed by light. Also, the defect may be of the type close to degenerate spin state (which can be used to measure magnetic fields). Further, the defect may be of energy less than 200 mV from the Fermi energy, thus allowing to use it as a local detector of electric potential.

In all the above groups, the core presents the bulk of the tip and it may be made of a conductive material, such as a metal or a semiconductor or an alloy (e.g., Tungsten, Platinum, Platinum-Iridium, doped silicon, etc.); or of a dielectric (e.g., silicon, quartz, sapphire, diamond, etc.). For practical purposes, hereinafter by the dielectric material, a material with the bandgap larger than 2 eV is meant; and by the semiconductor, a material with non-zero bandgap smaller than 2 eV is meant.

The core may have a length larger than 1 micron (μm); and/or smaller than 10 mm (lengths closer to this value may correspond to cores which are similar to STM tips). In some of the experiments conducted by the inventors, the length was in a range 1.2-1.6 μm.

In general, 2D materials are substances with a thickness of a few nanometers, which are characterized by a layered crystal structure with strong bonds-covalent or ionic-within each layer, and where layers are coupled together by relatively weak vdW forces. Currently, hundreds of 2D materials are known. Many are natural semiconductors, along with metals, semimetals, superconductors, and various kinds of insulators (band 5 insulators, topological insulators, and Mott insulators).

In the active layer made of the 2D material the carriers, for example, electrons, are free to move in the 2D plane at the apex, but their motion is restricted in the third direction outside of the active layer (with the quantum mechanical tunneling being the mechanism limiting the restriction). The 2D material may have not more than any smaller number of monolayers instead of 10: for example, the upper limit for the number of monolayers may be 7, or 4, 3, 2, or 1). The monolayers may differ in chemical composition, and the 2D material forming the active layer may be itself formed from monolayers of different 2D materials when they couple by vdW forces.

Examples of the suitable 2D material for the active layer include the semimetal graphene, transition metal dichalcogenides (TMDs) semiconductors including but not limited to WSe₂, WS₂, MoSe₂, MoS₂, TaSe₂, TaS₂, NbSe₂, WTe₂ and so forth, RuCl₃ or similar 2D magnetic layers, BiSCCO or similar layered high-superconducting-temperature materials.

The support layer carrying at the apex the active layer is made of a vdW material. The support layer allows for the active layer to have the proper functionality: the active layer has to be sufficiently thin to be 2D, but if it was placed directly on the apex of the tip's core of some conventional material, it would bend and strain and thus loose its desired mechanical and/or electrical properties, since the apex could be too rugged. Thus, the support layer is selected to mitigate or prevent the chance that the vdW material of the active layer would not form the appropriately conducting and mechanically suitable for use in the probe 2D vdW material.

The support layer does not have to be a 2D material. It will have more than 10 monolayers. It can be a dielectric, or a semiconductor, or even a conductor, such as semimetal or a metal if an interface between the active layer and the support layer has a very small probability for a carrier to get transmitted therethrough upon one impinging on the interface. The latter can happen, for example, in case of a mismatch between lattices of the active layer and the support layer, or different orientations if they are made of the same material, resulting for example in a contact resistance greatly suppressing the current. In any case, the contact resistance higher than 10 times Sharvin resistance between the active layer and the support layer is suitable (a skilled person would readily find this resistance; but in any case, the formula for the ballistic case, which can serve as a reference, for different contact interfaces was originally presented in Sharvin, Yu. V. “A possible method for studying Fermi surfaces”. Sov. Phys. JETP 21, 655 (1965), which is incorporated herein by reference).

In some sense, such a layer arrangement allows the 2D vdW material forming the active layer to behave differently from the same material in its bulk form, and vice versa: due to the active layer being a 2D vdW material conducting the current laterally, the support layer substantially does not receive the current to conduct therethrough due to the nature of the interface between the active and support layers, or practically does not conduct it itself. For example, the layer arrangement may be configured in such a way that the current through the active layer can be three, or five, or ten, or fifty times higher a residual current, if any, through the support layer.

Examples of the suitable vdW materials for the support layer include, but are not limited to, insulating hexagonal boron nitride (hBN), conductors like graphite, semiconductors including but not limited to WSe₂, WS₂, MoSe₂, MoS₂ and 2D magnets such as RuCl₃ and similar materials.

As for the feature that the layer arrangement forms under a pressure against a planar surface a mechanical contact with this surface where the contact area contains (i.e. encompasses) a square with a side of 10 nm or more, this size is expected to be sufficient to allow the 2D material of the active layer to operate with two dimensions during current measurements, while stay restricted in the third. Also, this size helps to screen the sample surface from the fringing fields and fields originating not from the active layer, especially since the probe may be operated in the contact mode, and the active layer is either exposed or separated from the sample possibly by some layer thin enough or configured to allow tunneling. At the same time, when the contact area has a linear dimension (diameter), for example, of at least: 20 nm, or 50 nm, or 100 nm, or 150 nm, or 1 μm, the probe may be used to provide less local, but more momentum-resolved imaging in at least one lateral direction. In the disclosure below, the terms “linear dimension” and “diameter” are used interchangeably.

Hence, the contact area does not need to be symmetric like a square or a circle: it is sufficient if it includes the square therein as explained above, while a different functionality can be added by making it more elongated in one direction, depending on the specific aim of the measurements. The inventors have considered that on the practical level the contact would lead to a somewhat different functionality if the contact area has dimensions being combinations of a linear dimension (diameter) of at least: 20 nm, or 50 nm, or 100 nm, or 150 nm, or 1 μm in one direction, and any linear dimension (diameter) from the following list: 20 nm or more, 50 nm or more, or 100 nm or more, 150 nm or more, and 1 μm or more in the perpendicular direction. For example, the larger diameter (generally, linear dimension) may be effectively used for the momentum-resolved imaging at cryogenic temperatures (or at room temperature if the coherence length of the carriers is large). At the same time, the linear dimension (diameter) of the contact area may be selected not to exceed 1 μm, or 5 μm.

Also, in some examples, the layer arrangement at the apex of the tip may be elongated in a certain lateral direction or configured to become so elongated under the pressure, with a linear dimension (diameter) of the contact area selected to allow momentum-resolved imaging of a certain resolution; and configured for a relatively localized measurement in a perpendicular direction.

For example, the contact area may have at least: 20 nm, or 50 nm, or 100 nm, or 150 nm, or 1 μm diameter in one direction, and the diameter not exceeding 20 nm or 30 nm in the perpendicular direction.

Both measurements may be performed in the contact mode, with scanning the 2D momentum space by rotating the probe with respect to the sample (this is so for all three types of probes, since the probe of the third type may be used for momentum-resolved imaging if the defect-assisted tunneling layer behaves like the tunnel barrier layer at voltages different from the unique voltage(s) of the at least one atomic defect).

The planar surface for testing the probes may be made of graphite, hBN, WSe₂, WS₂, MoSe₂, MoS₂, some any other vdW material, or a clean silicon, or another semiconductor (e.g. GaAs). However, in some examples, the exposed layer (be it the active layer, the tunnel barrier, the defect-assisted tunneling layer) has a plateau at the apex with dimensions being combinations of a diameter of at least: 20 nm, or 50 nm, or 100 nm, or 150 nm, or, or 1 μm or more in one direction, and any diameter from the following list: 20 nm or more, 50 nm or more, or 100 nm or more, 150 nm or more, and, or 1 μm or more in the perpendicular direction. In such cases, testing the probe against the planar surface is not needed. The plateau may be, but does not have to be, atomically flat: it will flatten when pressed against the sample. Still, if the exposed layer does not have the plateau before the contact mode is used, possibly due to a too curved form of the apex, it may acquire the plateau shape when operated in the contact mode. To check this, the respective testing may be performed. Testing the probe against the planar surface may not result in a tip crash, i.e. it may be performable without breaking the probe and therefore is non-destructive: the layer arrangement may be sufficiently elastic thanks to vdW layers. Also, the pressure for testing the probes may be limited to 1 GPa, or 10 GPa, or 30 GPa in magnitude: such pressures are not expected to lead to the tip crash or to inelastically modify the layer arrangement at the apex.

Additionally, there are examples where the layer arrangement has at least three folds directed from the apex, e.g. from the plateau at the apex; there is even a smaller chance of tip crash for such probes: instead of tearing some layer at the apex, the folds may re-arrange. The same holds for the examples where there is a space between the layer arrangement and the core of the probe, and this space is filled with vacuum, or a fluidic matter, for example, a gas, a liquid, or a gel: with a part of layer arrangement bordering such a space, it may flex into it and/or out of it and thus allow obtaining the plateau of the desired dimensions at the apex.

In the second group of examples, the tunnel barrier layer may be made of a vdW semiconductor or a vdW dielectric or insulator (e.g. TMDs or hBN). It may have a thickness of up to 9 monolayers.

In the third group of examples, the defect-assisted tunneling layer as well may be made of vdW materials, such as TMDs or hBN. Also, it may be made, for example, of vdW semiconductors including but not limited to WSe₂, WS₂, MoSe₂, MoS₂, TaSe₂, TaS₂, NbSe₂, WTe₂. It may have a thickness of up to 9 layers. The atomic defect may be a vacancy of a single atom or of a complex or a cluster of atoms, a substitutional atom or a complex or a cluster of substitutional atoms, or an interstitial atom or a complex or a cluster of such atoms; or a complex or cluster of defects of two or three of these types.

Since probes from the third group of examples may be used for very localized measurements, in some cases such probes may be adapted to have a diameter of the contact area limited to 40 nm, or 30 nm, or 25 nm, or 20 nm (in all directions; this may be useful, for example, for simultaneous use in conductivity and topography imaging of less smooth samples similarly to CAFM).

The inventors have used some of their invented probes with vdW samples and with a customized AFM setup adapted to allow controlled rotation of a stage holding the sample around the probe besides the common shifting of the sample along two orthogonal linear directions. The samples were rather smooth and while the probe was operated in the AFM contact mode, the primary reason was to apply the necessary force to create the contact for measuring the current rather than measure the particularities of the topography of the sample. The diameter of the probe was larger than of typical CAFM; however, in the third group of examples the resolution of the obtained current map corresponds to the size of the atomic defect(s) (if there is more than one atomic defect as described above in the defect-assisted tunneling layer, then the used defect can be switched by changing the voltage between the active layer and the sample to match to the unique voltage corresponding to the peak of the desired defect). At the same time, in the first and second group of examples measurements have been performed with twisting the probe and thereby scanning the relative momenta of the states in the probe with respect to those in the sample; and thus obtaining momentum-resolved tunneling data (where for probes in the first group of examples carriers tunnel directly between the sample and the active layer of the probe, and in the second group they tunnel via the tunnel barrier layer).

At the same time, the measurements can be conducted with all three types of probes because debris and probe wear have not presented an obstacle for such measurements as for CAFM, despite the larger diameter of the probe than in typical CAFM and consequently a higher probability of existence of debris. Apparently, debris is pushed out from the interface between the probes of the present disclosure and samples, for example, due to adhesion between vdW layers in the sample and the probe and elasticity of the layer arrangement of the probe (and possibly elasticity of the sample): the state with a dirt between the sample and the probe has to be energetically unfavorable. This has to be an even more common case for the probes where the layer arrangement has at least three folds directed from the apex; and/or in cases where the layer arrangement where there is a space between the layer arrangement and the core of the probe, as mentioned above. Both of these features are realized, for example, in a tent structure as discussed below.

Thus, according to one broad aspect of the present disclosure, it provides a probe for mechanically contacting a sample and for use in conducting measurements on the sample. The probe can be used in electrical, or mechanical, or optical measurements. The probe comprises a tip having a core with an apex, where the apex is covered by a layer arrangement comprising at least a support layer of a vdW material and an active layer presenting a 2D material of not more than 10 monolayers coupled by vdW forces, the active layer being placed on the support layer at said apex and being thereby further away from the core than the support layer at said apex. An outer layer of said layer arrangement is an exposed layer; and the layer arrangement is configured to form, upon contact with a planar surface, a contact area with a linear dimension of at least 10 nm.

The layer arrangement may be configured to conduct an electric current in a lateral dimension through the active layer and in a vertical dimension from the active layer to the planar surface.

The core of the probe can be shaped as a generic 3D structure by additive deposition method such as focused ion beam deposition, or by 3D nano-printing or nano-etching methods.

According to another broad aspect of the present disclosure, it provides an SPM apparatus, comprising the above-described probe and being configured and operable as AFM or STM, comprising:
a stage configured to carry a sample,
a head holding an AFM cantilever or the STM probe to probe a sample carried by the stage,
a rotation motor configured and operable to perform rotation of the stage with respect to the head or of the head with respect to the stage, and
a control unit configured and operable to control said rotation to provide a desired orientation alignment between the stage and the head.

The SPM apparatus may also include one or more linear motors configured and operable to perform linear lateral translations of the stage in a plane of said rotation. The control unit is thus further configured and operable to control the linear lateral translations of the stage such that a selected point of interest of the sample is brought to a center of the rotation of the stage/head during operation of the SPM.

In some embodiments, the one or more linear motors are arranged on top of the rotation motor, thereby providing that, once the linear lateral translations of the stage bring the point of interest to an alignment position with the center of the rotation, said alignment position is maintained during the rotation of the stage/head.

According to yet further broad aspect of the present disclosure, there is provided a Scanning Probe Microscope (SPM) apparatus comprising:
a stage configured to carry a sample,
a head configured to hold an AFM cantilever or an STM probe,
a rotation motor configured and operable to perform rotation of the stage with respect to the head or of the head with respect to the stage, and
a control unit configured and operable to control said rotation to provide a desired orientation alignment between the stage and the head.

The system may further include one or more linear motors configured and operable to perform linear lateral translations of the stage in a plane of said rotation (plane of a sample). The control unit may thus be further configured and operable to control the linear lateral translations of the stage, such that a selected point of interest of the sample is brought to a center of the rotation of the stage/head during operation of the SPM.

In some embodiments, the one or more linear motors are arranged on top of said rotation motor, thereby providing that, once the linear lateral translations of the stage bring the point of interest to an alignment position with the center of the rotation, said alignment position is maintained during the rotation of the stage/head.

When an AFM cantilever or an STM probe (e.g., the probe of the present disclosure configured as described above) is mounted on said head, the system can operate as a Scanning Probe Microscope.

The present disclosure also provides a method of measurement of an electronic structure of a sample using the above-described probe of the present disclosure. According to this method, the probe is pressed to the sample; and a voltage is applied between the sample and the probe enabling measurement of a current through the active layer of the probe. The technique of the present disclosure enables electrical measurements only within the sample or only within the probe, which are sensitive to the contact area between the tip and probe; as well as enables electrical measurements of a defect which are sensitive to the contact area between the tip and probe (and optical measurements can be used as well).

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In order to better understand the subject matter that is disclosed herein and to exemplify how it may be carried out in practice, embodiments will now be described, by way of non-limiting examples only, with reference to the accompanying drawings:

FIGS. 1A-C present, respectively, schematic illustration of the probe with the exposed active layer according to the present disclosure (side view); schematic illustration of the probe with the exposed tunnel barrier layer according to the present disclosure (side view); and schematic illustration of the probe with the exposed defect-assisted tunneling layer according to the present disclosure (side view).

FIG. 2 schematically shows an example of a probe contact area (a front view) according to the present disclosure.

FIGS. 3A and 3B schematically show examples of a connection of the active layer of the probe with its contact electrode and the support layer of the probe, according to the present disclosure.

FIG. 4 schematically illustrates an example of a probe with a gate electrode layer according to the present disclosure.

FIGS. 5A and 5B schematically illustrate that a probe according to the present disclosure may have a proto-plateau.

FIG. 6 schematically shows an example of an SPM/AFM apparatus, according to the present disclosure, allowing to rotate a stage for carrying a sample with respect to a head holding an AFM cantilever.

FIGS. 7a-j to FIGS. 10a-e (see the descriptions in the section “Additional Description” below) exemplify the operational principles of Quantum Twisting Microscope (QTM), wherein FIGS. 7a-j show the QTM setup and in-situ twistronics experiments; FIGS. 8a-h show momentum resolved tunneling between two twisted graphene monolayers; FIGS. 9a-h show QTM imaging of the energy bands of twisted bilayer graphene (TBG); and FIGS. 10a-e show imaging the effects of applied pressure on the TBG energy bands.

FIGS. 11a-g to FIG. 28 (see the descriptions in the section “Supplementary Information” below) illustrate specific non-limiting examples of the probe fabrication and operation techniques; wherein FIGS. 11a-g show the QTM tip characterization;

FIGS. 12a-d show QTM flat side substrate and devices; FIGS. 13a-c show room-temperature QTM measurement setup; FIGS. 13d and 13e show two different configurations of the translational and rotational degrees of freedom of the QTM;

FIG. 13f shows a configuration where the tip is mounted on a rotational degree of freedom and the lateral degrees of freedom (e.g., X and Y) are placed in between the rotational degree of freedom and the tip; FIG. 14 show the bias dependence of top/bottom chemical potential μ_{T/B} and electrostatic potential ϕ for MLG-MLG tunneling junction; FIG. 15 is a schematic of the charge-neutral MLG-MLG tunneling experiment (of FIGS. 8a-h above); FIGS. 16a-b show (a) measured d²I/dV² from FIG. 8c above, with the local maximum (minimum) being traced at positive (negative) bias, along the ‘onset’ features (black dots), and (b) plot of the black dots from panel together with bare Dirac dispersion (Eq. S5.5) with v_{F}=1.05·10⁶ m/s (blue) and Dirac dispersion that is renormalized by interactions; FIGS. 17a-b show rescaling rotation angle θ to the electrostatic potential ϕ; FIGS. 18a-f to 20a-f show for the same measurement, respectively, back-gate voltage dependence of momentum-resolved tunneling current in a MLG-MLG junction, Back-Gate voltage dependence of dI/dV, and Back-Gate voltage dependence of d²I/dV²; FIG. 21 is a schematic of the MLG-MLG tunneling junction for experiments with a finite back gate voltage; FIGS. 22a-b show measured and calculated d²I/dV² vs. θ and V_{b}, at V_{BG}=−10V (similar to FIGS. 20c,f); FIG. 23 shows determination of the electron lifetime at low bias; FIGS. 24a-c show a second toy model, explaining the momentum resolved features; FIG. 25 shows how the ‘onset’ and ‘Dirac matching’ features evolve between low temperature (k_{B}T=1 meV, blue) and room temperature (k_{B}T=25 meV, dashed red); FIGS. 26a-g show comparison of the second toy model with the measurements; FIGS. 27a-e illustrate how the main features obtained in the experiments using toy models appear in the full calculation; FIG. 28 shows the energy band shift, ϕ, as a function of V_{b}, (red dots) extracted from the feature that follows the MLG bands in the MLG-TBG measurement in FIG. 9d;

FIG. 29 (see the description in the section “Experiments with a probe of a smaller lateral size” below) shows an image of the whole area of sample detected by a probe fabricated by the inventors while being moved along the surface of the sample and imaged multiple times by the defects.

FIGS. 30a to 30g show results of phonon dispersion measurements with the cryogenic QTM, wherein FIG. 30a shows the schematics of the cryogenic QTM (inset), where a continuously-twistable interface between two van der Waals materials at T=4K (main panel) may be formed, an inelastic momentum-conserving electronic tunnelling process is used to emit and measure phonons at the interface with a well-defined momentum, continuously tunable by twisting (black arrow); FIG. 30b shows schematically a twisted junction between two graphite flakes (few tens of nm thick), in which the experiments are performed; a bias V_{b} is applied across the junction and measure current, I, and conductance

$$G = \frac{dI}{{dV}_{b}}$$

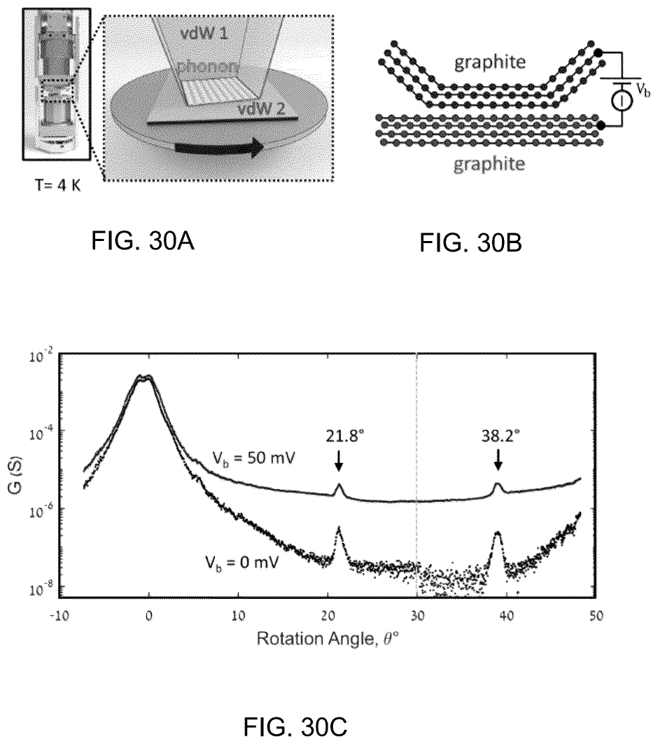

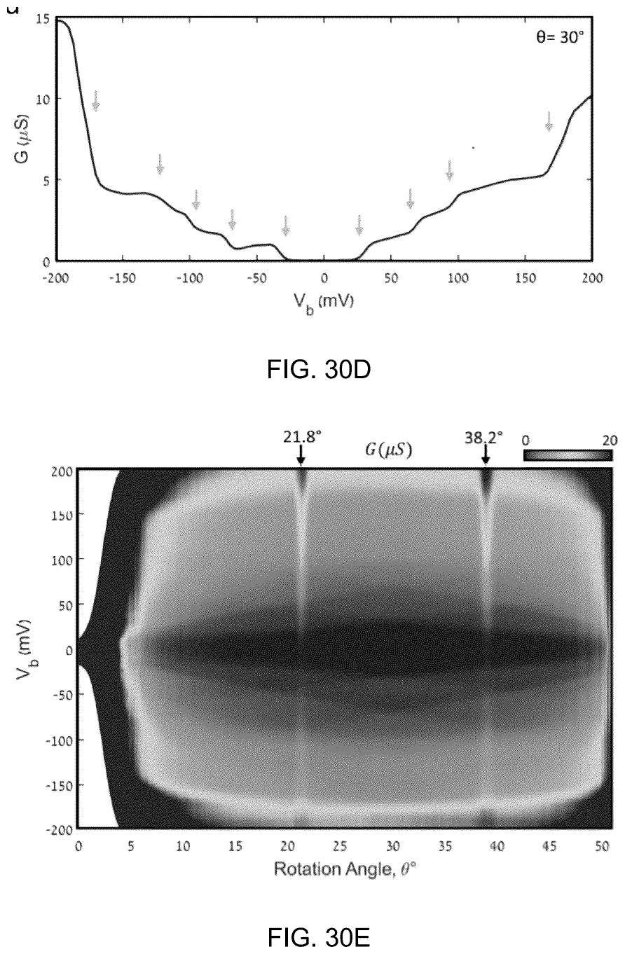

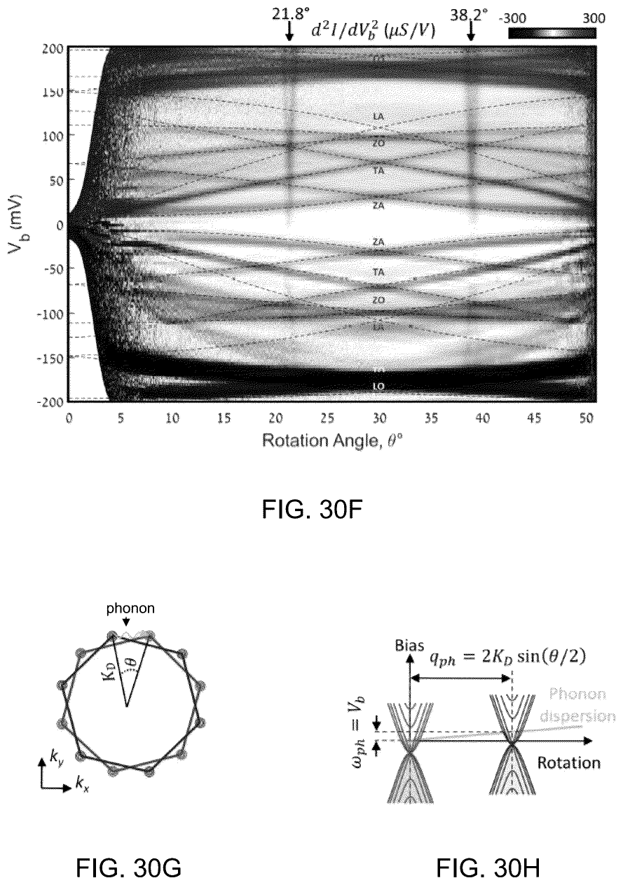

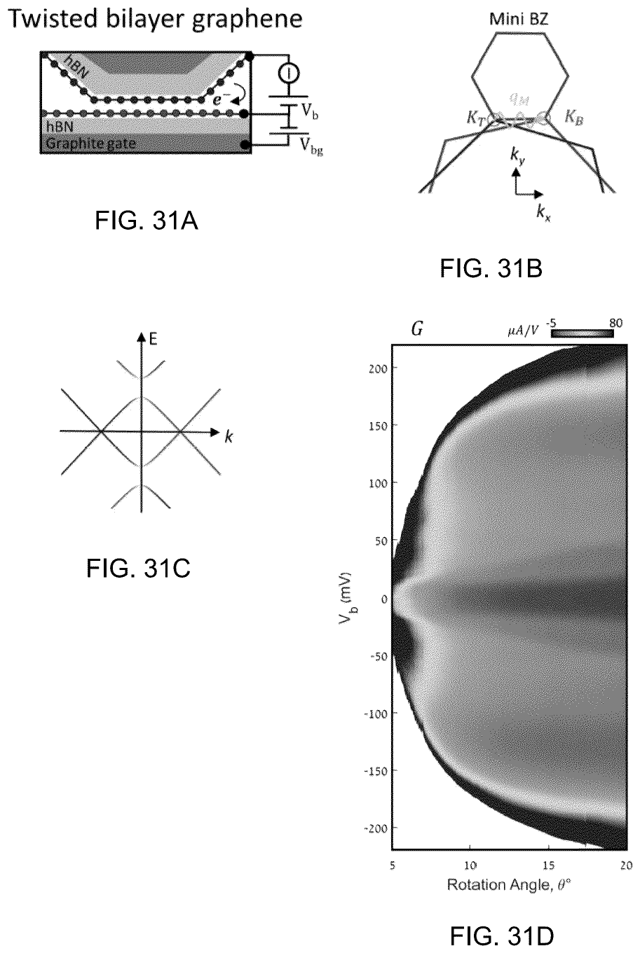

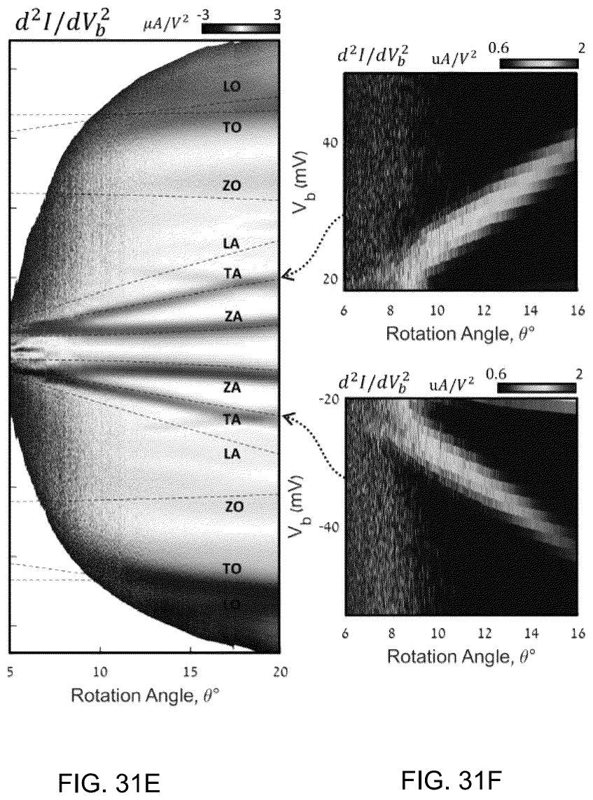

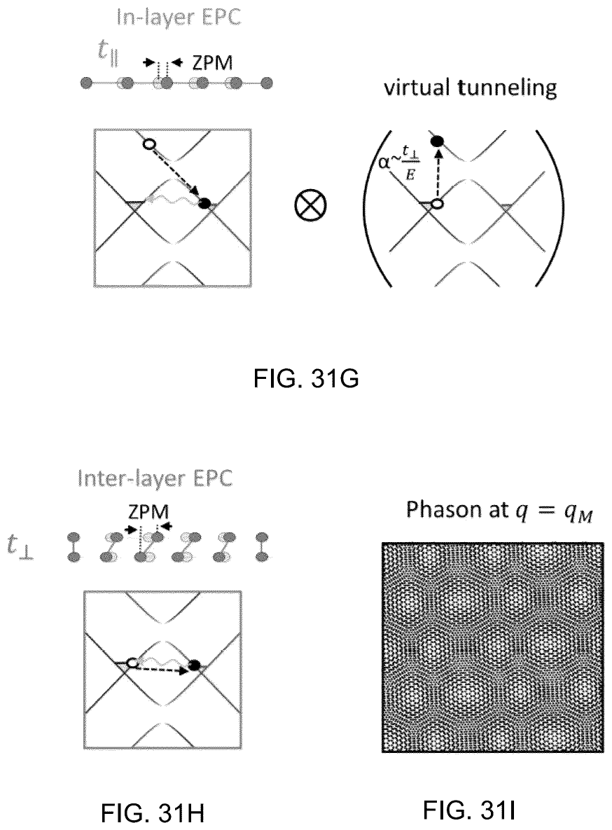

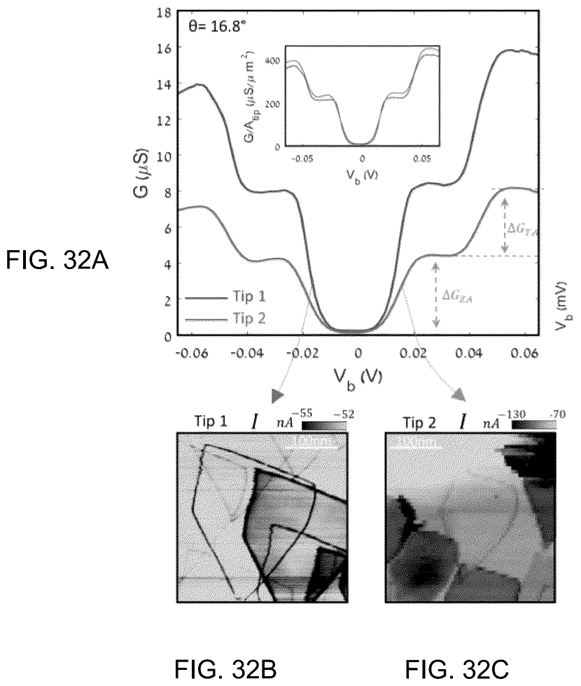

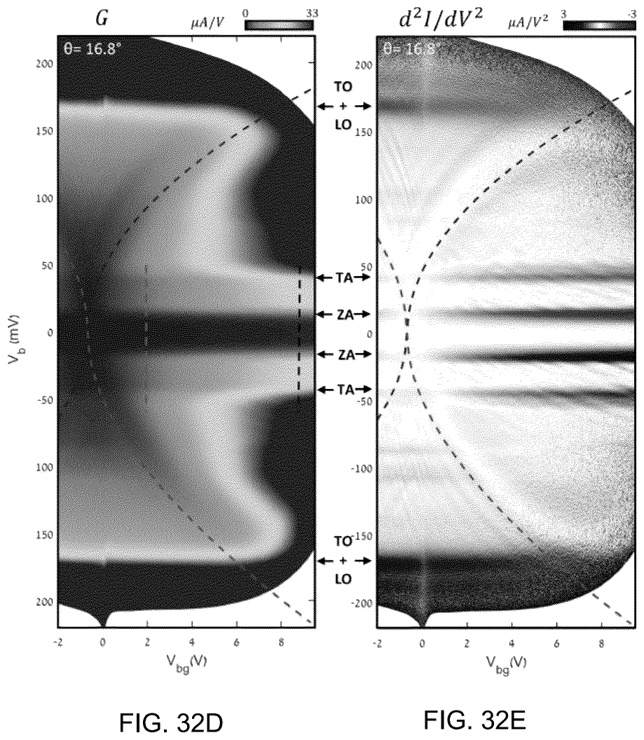

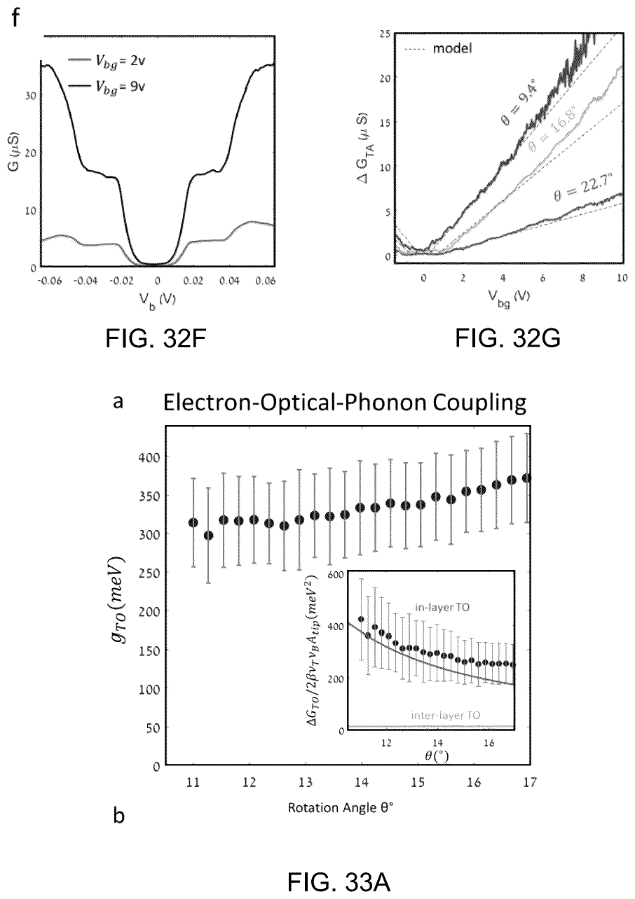

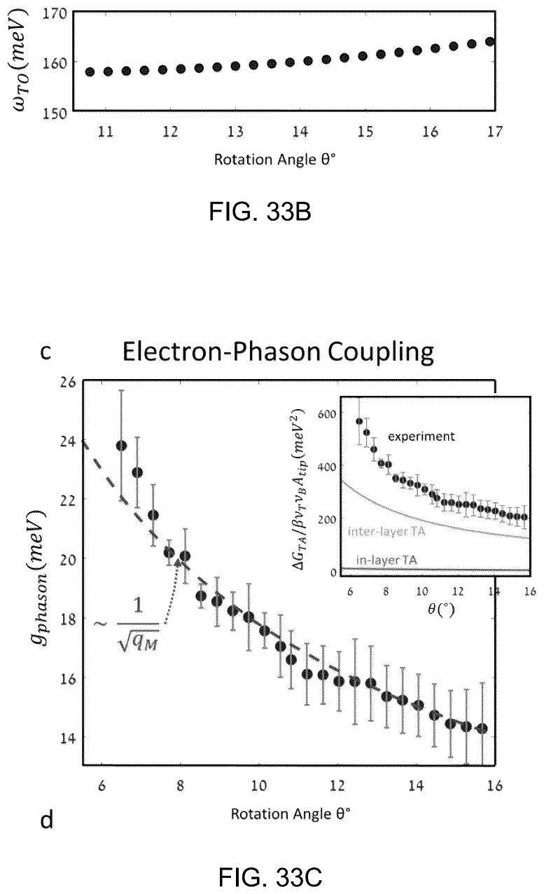

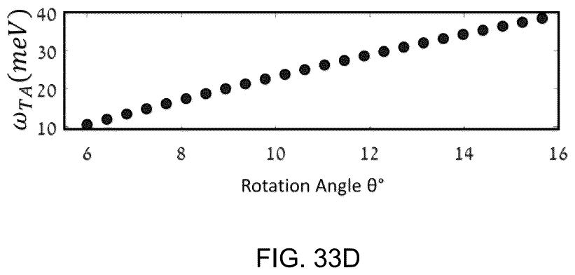

are measured; FIG. 30c shows the measured G vs. twist angle, θ, for V_{b}=0 mV (black) and 50 mV (blue); FIG. 30d shows measured G vs. V_{b} at θ=30°, exhibiting discrete steps (arrows), indicative of a series of inelastic tunnelling processes; FIG. 30e shows two-dimensional measurement of G vs. θ and V_{b}, showing that the steps in G appear at all twist angles and that their turn-on bias disperses smoothly with θ; FIG. 30f shows the second derivative, d²I/dV², obtained numerically from FIG. 30e highlighting the steps in G that now appear as peaks; FIG. 30g shows the Fermi surfaces in k-space of the top (blue) and bottom (red) graphite layers; and FIG. 30h shows the corresponding energy bands, where at a finite twist angle, there is a momentum mismatch between these energy bands, and momentum-conserving electronic tunnelling between the layers can occur only via the emission of a phonon that provides the missing momentum,

$${q}_{ph} = 2 {K}_{D} sin ( \frac{θ}{2} ) ,$$

by following the turn on in the θ−V_{b} plane, the phonon dispersion line (orange) can be directly mapped;

FIGS. 31a to 31i show measured phonon spectrum and electron-phonon coupling (EPC) in Twisted Bilayer Graphene (TBG), wherein FIG. 31a shows a tunable TBG being formed by bringing into contact a monolayer graphene on tip (blue) with a monolayer graphene on a flat sample (red), both backed by hBN, and with a global graphite back-gate; FIG. 31b shows TBG's mini-Brillouin zone (BZ), with Dirac points of the top and bottom layers at its corners (labeled K_{T} and K_{B}), the measured inelastic tunnelling processes involve an electron tunnelling between the layers while emitting a mini-BZ phonon that provides the missing momentum (q_{M}, orange); FIG. 31c shows the corresponding TBG band structure along the K_{T}-K_{B} line, colour-coded by layer weight; FIG. 31d shows measured conductance, G, vs. bias voltage, V_{b}, and twist angle, θ, exhibiting steps in G that disperse with θ; FIG. 31e shows the second derivative, d²I/dV_{b}², obtained numerically from FIG. 31d, overlaid with the theoretically calculated phonon spectrum of graphite (dashed lines, various modes labeled); FIG. 31f shows zoom-ins on the TA phonon peaks in FIG. 31e, at positive and negative bias, but with a colormap that reveals the variation of d²I/dV_{b}² peak amplitude with θ; FIG. 31g shows In-layer EPC mechanism, originating from the phonon modifying the in-layer hopping amplitude, t_{∥} (top illustration); FIG. 31h shows Inter-layer EPC mechanism where an antisymmetric motion of atoms in the two layers (a phason of the moire lattice) directly modifies the tunnelling amplitude t_{⊥} between them (top illustration); and FIG. 31i shows the experiment which probes phasons with momentum q=q_{M} (illustrated);

FIGS. 32a to 32g show area and density of states (DOS) dependence of electron-phonon coupling induced inelastic tunnelling, wherein FIG. 32a shows tip area dependence of the inelastic tunnelling steps: measured G vs. V_{b} for TBG with θ=16.8° and V_{bg}=4V for two tip contact areas, Aₜᵢₚ, the height of the inelastic steps corresponding to the ZA and TA phonon modes are marked (ΔG_{ZA}, ΔG_{TA}); Inset: same traces but normalized by the measured Aₜᵢₚ; FIGS. 32b and 32c show the imaged current in a spatial scan of the tip along fixed atomic defects located in a WSe₂ layer placed on top of the bottom graphene, exhibiting multiple copies of the tip shape, each produced by a different single defect; FIG. 32d shows DOS dependence of the inelastic tunnelling steps: measured G vs. V_{b} and V_{bg} for TBG with θ=16.8°, dashed lines are the charge neutrality of the top (blue) and bottom (red) graphene layers, calculated from an electrostatic model of the junction (SI 5), inelastic tunnelling steps in G are visible as horizontal lines (corresponding phonon modes are marked); FIG. 32e shows the second derivative, d²I/dV_{b}², obtained numerically from FIG. 32d, exhibiting horizontal lines that correspond to the various phonon modes; FIG. 32f shows measured linecuts of G vs. V_{b} taken from FIG. 32d at V_{bg}=2V and 9V (vertical dashed lines in panel d); FIG. 32g shows amplitude of the conductance step of the TA mode, ΔG_{TA} VS. V_{bg} extracted from FIG. 32d (θ=16.8°) and from two similar measurements done at θ=9.4° and 22.7°, dashed lines plot the theoretical model that predicts a linear dependence of ΔG_{TA} on V_{bg}; and

FIGS. 33a to 33d show electron-optical-phonon and electron-phason coupling in TBG, wherein FIG. 33a shows in the inset the measured inelastic conductance step, vs. θ, corresponding to the intervalley optical TO mode, normalized following Eq. (1) using the measured tip area and densities of states; Solid lines are theoretically calculated in-layer (green) and interlayer (yellow) contributions, and the main panel shows the intervalley optical TO mode EPC, g_{TO}, determined from the measurements in the inset, Error bars are obtained from differences between measurements at positive and negative bias and all other experimental uncertainties; FIG. 33b shows TO phonon energy as a function of θ extracted from FIG. 31e; FIG. 33c shows in the inset measured inelastic conductance step, vs. θ, corresponding to the acoustic TA mode, normalized following Eq. (1) using the measured tip area and densities of states. Solid lines are the theoretically calculated in-layer (green) and inter-layer (yellow) contributions, and the main panel shows the electron-phason coupling, gₚₕₐₛₒₙ, determined from the measurements in the inset. Error bars are obtained from differences between measurements at positive and negative bias and all other experimental uncertainties; and FIG. 33d shows TA mode energy as a function of θ extracted from FIG. 31e.

### DETAILED DESCRIPTION OF THE ASPECTS AND EMBODIMENTS

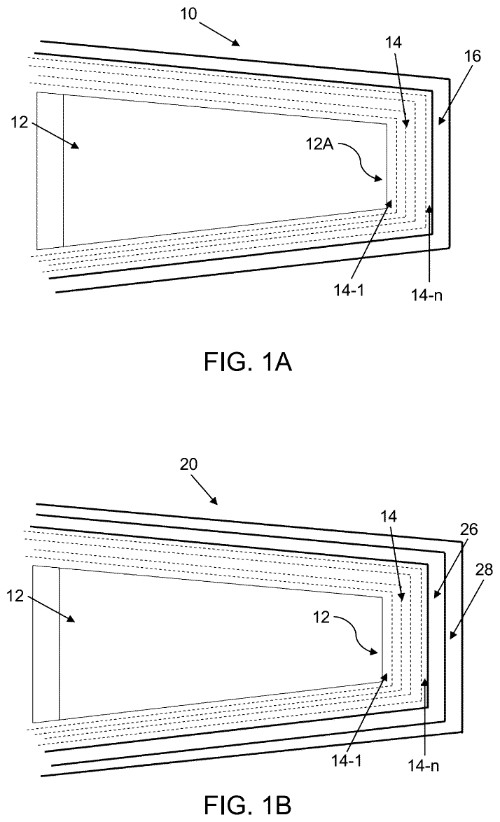

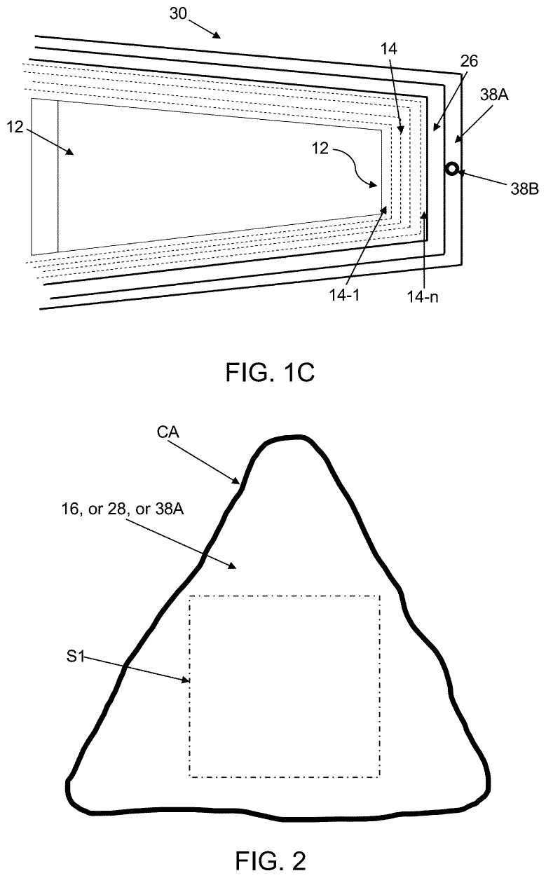

Reference is made to FIGS. 1A-C schematically exemplifying probes according to the three groups as mentioned above, respectively. FIGS. 1A-C show side views of the probes.

A probe 10 of FIG. 1A is an exemplary probe which may be used for mechanically contacting a sample and conducting electrical measurements on the sample. It includes a tip presented in this example by a core 12 with an apex 12A. Also, probe 10 includes an active layer 16 presenting a 2D material of not more than 10 monolayers coupled by vdW forces, and a support layer 14 of a vdW material including layers 14-1 to 14-n. The active layer 16 is placed on the support layer 14 at the apex 12A; and it is further away at the apex 12A from the core 12 than the support layer 14. In other words, the active layer 16 and the support layer 14 form a vdW heterostructure covering the apex 12A, and the vdW heterostructure is turned with the support layer 14 towards the apex 12A. The active layer 16 at the apex 12A is exposed for contacting a sample.

In probe 10, a layer arrangement, covering apex 12A and including the support layer 14 and the active layer 16, i.e. their vdW heterostructure, has a plateau at the exposed layer. This plateau contains a square with a side of 10 nm or more. Hence, the contact area is expected to contain the square with a side of 10 nm or more under pressure against a planar surface.

The layer arrangement at the apex 12A in probe 10 conducts an electric current substantially, or even only, in a lateral dimension and substantially, or only, through the active layer 16.

In FIG. 1A the active layer 16 extends away from the apex 12A, but along core 12 of the tip, and it stays exposed on the side of the tip, to which it is attached via the extension of the support layer 14. The extension of the active layer thus may be used for connecting to a contact electrode, which could lie on be pressed to the exposed extension of the active layer. In different examples, the active layer may extend away from apex 12A towards the contact electrode without being mechanically connected to the core 12. The contact electrode may be bulk and may be included into the probe, or it may be separate from the probe. For example, the contact electrode may be made on a side of the core 12 and be included into the tip as it's another part, additional to core 12; or if the core 12 is grown on or attached to a substrate, the contact electrode may be made on a substrate. The active layer 16 may be on top of or beneath the contact electrode where they intersect.

In FIG. 1B a probe 20 is shown. In this example, the probe includes an active layer 26 instead of 16; and it includes a tunnel barrier layer 28. Other elements are the same as in FIG. 1A. The active layer 26 may differ from the active layer 16 in some respects: on the one hand, active layer 26 does not have engage in a direct contact with the sample, but on the other hand it has to be compatible with tunnel barrier layer 28, for example, possibly to attach this layer to probe 20 if it is not attached to this probe in some other way (for example, to a substrate if it is included into the probe).

FIG. 1C shows an example of a probe 30 in which the active layer 26 is covered by a defect-assisted tunneling layer 38A, which is exposed. This defect-assisted tunneling layer 38A includes an at least one atomic defect 38B presenting a flow path for a tunneling current between the sample and the active layer 26. The layer arrangement, which at the apex 12A includes the defect-assisted tunneling layer 38A in addition to the heterostructure of the support layer 14 and the active layer 26, is allowed to conduct the electric current at least by tunneling through this defect-assisted tunneling layer 38A via the atomic defect 38B when the applied voltage coincides with the peak of the tunnel conductance of the defect, and then in a lateral dimension and through the active layer 26. By the “atomic defect” is meant either one or a complex (or cluster) of few missing atoms, one or a complex of few substitutional atoms, one or a complex of few interstitial atoms; or a complex combining defects from two or three of these types. Hence, the current will depend on the free carrier density of state and the local electrostatic potential in the sample in a vicinity of the defect and the energy distribution of the carriers.

FIG. 2 schematically shows an example of a front view of a contact area CA of each of the probes 10, 20 and 30 against a planar surface. For probe 10, the exposed layer is the active layer 16; for probe 20, the exposed layer is the tunnel barrier layer 28; and for probe 30, the exposed layer is the defect-assisted tunneling layer 38A. In each case, the contact area contains a square S1 with a side of 10 nm or more.

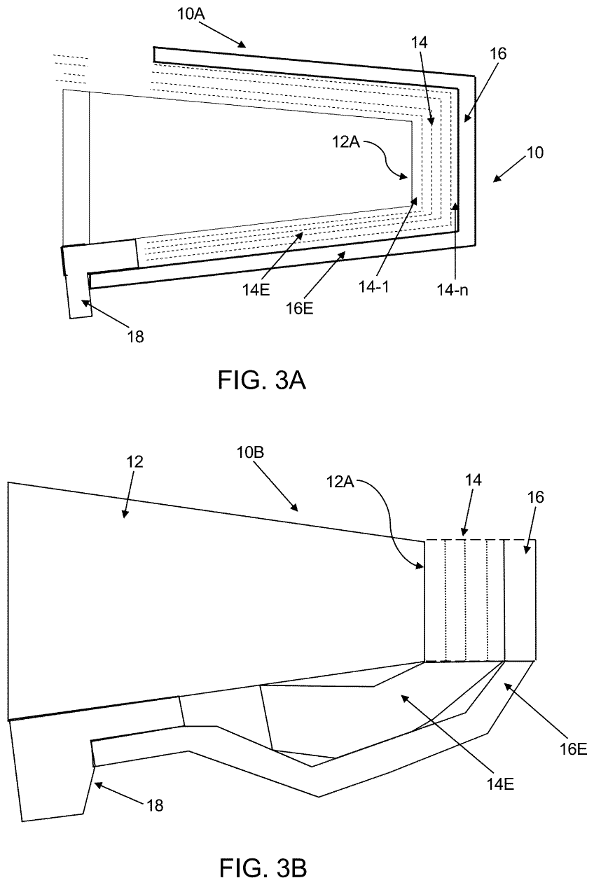

FIG. 3A provides an example how a contact electrode may be added to the probe, in accordance with one of the options mentioned above. In this example, probe 10A is similar to probe 10, but its active layer 16 extends along the core 12 further away from apex 12A than the support layer 14. The tip of the probe 10A is equipped with a contact electrode 18 grown, placed, or deposited on the core 12, and the active layer 16 extends to this contact electrode 18. Still, in all cases, according to another option the contact electrode may additionally or alternatively be deposited on top of the active layer.

FIG. 3B provides an alternative example with respect to how the active layer 16, the support layer 14 and the core 12 may be positioned with respect to each other on the side of the core 12. In this example, probe 10B is similar to probes 10 and 10A, but it has an active layer extension 16E of a shape with folds, and a support layer extension 14E of another shape with folds. This may happen, for example, due to a different combination of an angle of between the core side wall and the apex 12A and flexibilities of the active and support layers. In this example, the active layer extension 16E does not adhere to the support layer extension 14E at some segments of its length even though it covers the support layer extension as the most proximate layer from one side; i.e. in the present example there is a gap between the active layer 16 and the support layer 14 (even two such gaps in FIG. 3B). Similarly, support layer extension 14E does not adhere to the core 12 in its certain segment (however, it has to be remembered that the support layer extension and the active layer extension may adhere to each other in a differently oriented cross-section; and similarly for the support layer extension and the core).

Such gaps or spaces may be used to reduce a risk of tip crash: with a part of the layer arrangement bordering such a gap, this part (i.e. one or more of respective segments in FIG. 3B) may flex into it and/or out of it. Depending on the measurements (for example, cryogenic or not), such spaces may be filled with vacuum, or a fluidic matter, for example, a gas, a liquid, or a gel, and thus allow the plateau of the desired dimensions at the apex to be formed upon the contact with the planar surface.

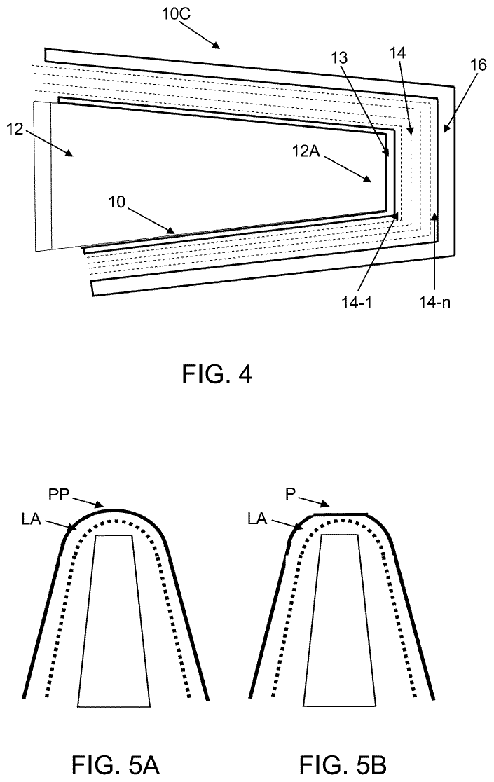

FIG. 4 schematically illustrates that a gate electrode layer 13 may be added to the probe. In this specific example probe 10C is based on probe 10, with the gate electrode layer lying between apex 12A and the support layer 14. However, a gate electrode layer such as the layer 13 also can be used in all other probes of the present disclosure. By applying a voltage bias between the gate electrode layer and the active layer, the properties of the active layer can be continuously modified, thereby allowing to change the properties measured in the experiment. Specifically, the changes may involve tuning the carrier density in the active layer, the density of states, and/or the workfunction of the active layer. Each of these parameters is useful for controlling the current measurement. For example, in the third embodiment (with the defect-assisted tunneling layer) a voltage bias between the gate electrode layer and the active layer influences the workfunction of the latter, which in turn gates the defect and shifts its energy level. The gate can thus be used to continuously tune the energy level of the defect.

FIGS. 5A and 5B schematically illustrate that a probe may lack a plateau containing the square of 10 nm size on the exposed layer when it is not used, but in such a case its layer arrangement LA may have a convex surface region PP (a proto-plateau) flexing under pressure or mechanical contact with a sample into a plateau P containing such a square. This possibility is relevant to all probes according to the present disclosure (including the illustrated exemplary probes 10, 20, 30, 10A and 10B in those their modifications which without pressure lack the plateau covering the square of 10 nm).

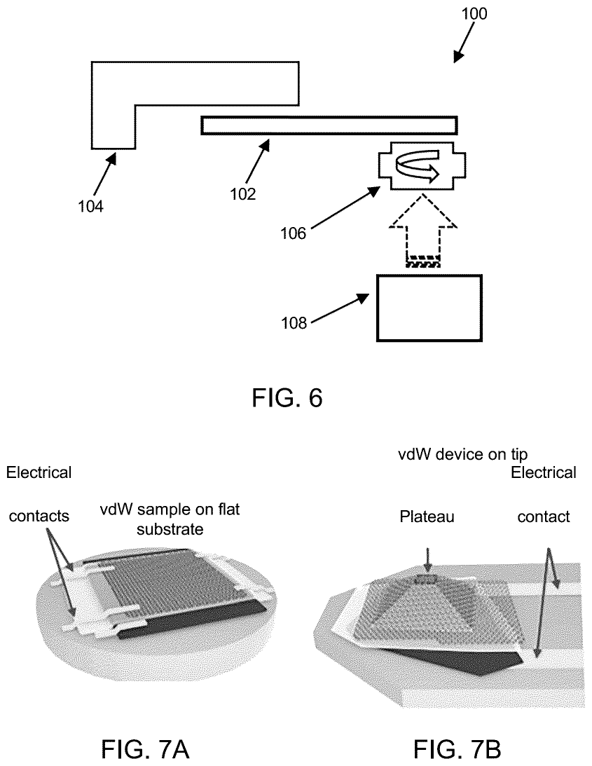

FIG. 6 schematically shows an example of an SPM apparatus 100 according to the present disclosure. In the present example, the SPM apparatus is implemented as an AFM apparatus, but a skilled person would readily understand from FIG. 6 also how an STM apparatus may be configured according to the present disclosure: the AFM apparatus would be replaced with an STM apparatus, and an STM probe would be used instead of the AFM cantilever. This STM probe may be implemented as any of the probes in the present disclosure.

Hence, the AFM apparatus 100 includes a stage 102 to carry a sample, a head 104 to hold an AFM cantilever above the stage 102, an electric motor 106 (rotation motor) for laterally/spatially rotating the stage 102 with respect to the head 104 (or a rotation of the head with respect to the stage), and a control unit 108 for controlling the lateral rotation (i.e. rotation in a sample's plane) with an accuracy better than 5 degrees, or 1 degree, or 0.1 degree, or 0.01 degree, or 0.001 degree to provide a desired orientation alignment between them. The arrow in FIG. 6 indicates the control. FIG. 6 represents both an AFM that works at room temperature and also an AFM that works at cryogenic temperatures.

Such a modification of the AFM according to the present disclosure is useful for conducting momentum-resolved measurements, to scan along the momentum space without disengaging the probe in the contact mode from the sample. Also, it is useful for forming a hybrid interface with a tunable twist angle and probing its physical properties at different twist angles. These properties as well may be local, for example, the local conductivity or carrier density.

It should be noted that the AFM according to the present disclosure can be operable to provide access for optical signal to come in and out for inspection purposes and for conducting optical measurements on the tip-sample junction.

The following section called “Additional Description”, and then related to it “Supplementary Information”, includes a description which, along with figures referred therein, provides some further details of the inventors' considerations and specific experiments, as well as more examples of probes corresponding to the disclosure above, including information on some fabrication techniques and results which such probes have already brought about.

### Additional Description

### The Quantum Twisting Microscope:

The scanning probe microscopy has revolutionized the way electronic phenomena are visualized. While present-day probes can access a variety of electronic properties at a single location in space, a scanning microscope that can directly probe the quantum mechanical existence of an electron at multiple locations would provide direct access to key quantum properties of electronic systems. Here, a conceptually new type of scanning probe microscope is demonstrated—the Quantum Twisting Microscope (QTM)—capable of performing local interference experiments at its tip. The QTM is based on a unique van-der-Waals tip, allowing the creation of pristine 2D junctions, which provide a multitude of coherently-interfering paths for an electron to tunnel into a sample. With the addition of a continuously scanned twist angle between the tip and sample, this microscope probes electrons in momentum space similar to the way a scanning tunneling microscope probes electrons in real space. Through a series of experiments, the inventors have demonstrated room temperature quantum coherence at the tip, studied the twist angle evolution of twisted bilayer graphene, directly imaged the energy bands of monolayer and twisted bilayer graphene, and finally, applied large local pressures while visualizing the evolution of the flat energy band of the latter. The QTM opens the way for novel classes of measurements and experiments on quantum materials.

An electron in a solid is a quantum mechanical object best described by an extended wave function, reflecting its existence in a superposition of spatial locations. The STM dramatically changed how electrons in real space can be visualized. It was followed by a large array of other scanning probe techniques that now allow local measurements of various electronic properties. To date, existing scanning microscopes can only probe electronic properties apparently at one location at a time. Therefore, they are unable to probe the interference of several tunneling trajectories, which would map the evolution of the quantum mechanical phase in space. To do so requires a scanning interferometer that probes an electron at several locations simultaneously and quantum coherently.

Thus, the inventors demonstrate a conceptually new type of scanning probe microscope—the Quantum Twisting Microscope (QTM)—capable of performing local interference experiments at its tip. The invented technique is based on a unique van-der-Waals (vdW) tip, which is brought into contact with a vdW sample, forming a 2D interface that can be twisted and spatially scanned with high angular and positional precision. The QTM enables at least two orthogonal and complementary classes of experiments: 1) “In-situ twistronics”—measuring a continuously twistable interface between a pair of vdW materials (e.g. twisted bilayer graphene). Here, the active vdW layers are placed in the tip and sample in direct contact, such that their wavefunctions strongly couple, and then the transport properties of the hybridized interface are probed. 2) Momentum-resolved tunneling—Here, a tunnel barrier (e.g. a few layers of a transition metal dichalcogenide) is inserted between the active vdW layers in the tip and sample. This barrier decouples their wavefunctions, allowing the tip to act as a momentum-resolved probe (non-invasive) for the sample's energy bands. Since an electron can coherently tunnel into a sample at many locations along the 2D interface, this junction acts as an interferometer on a tip. Specifically, this implies that in the absence of electron-phonon, electron-electron and impurity scattering, an electron would tunnel only between states of equal momenta. In this modality, the microscope's twisting degree of freedom is used for scanning an arc in the momentum space of the sample, and imaging along it the sample's energy bands.

### The QTM's Operating Principle

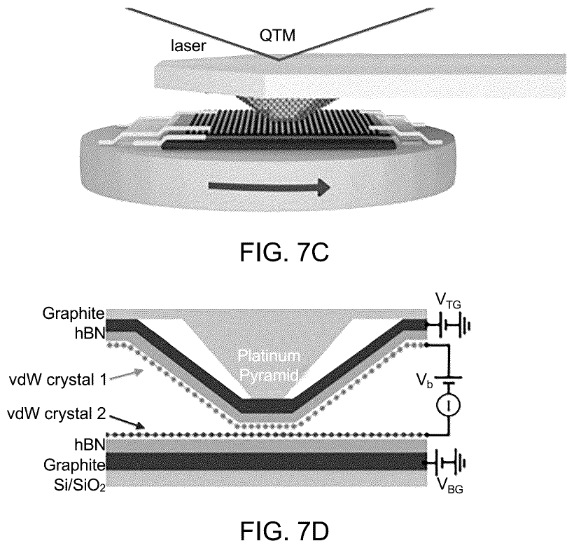

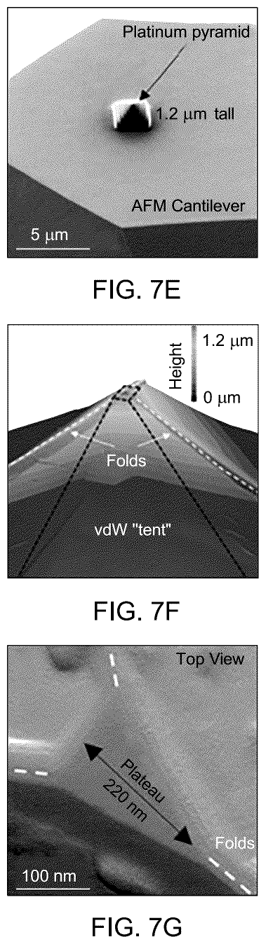

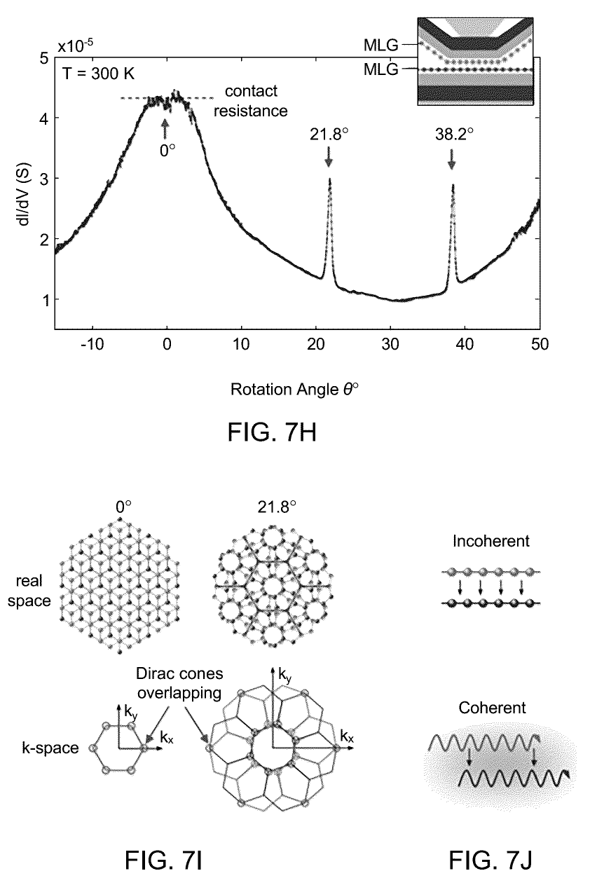

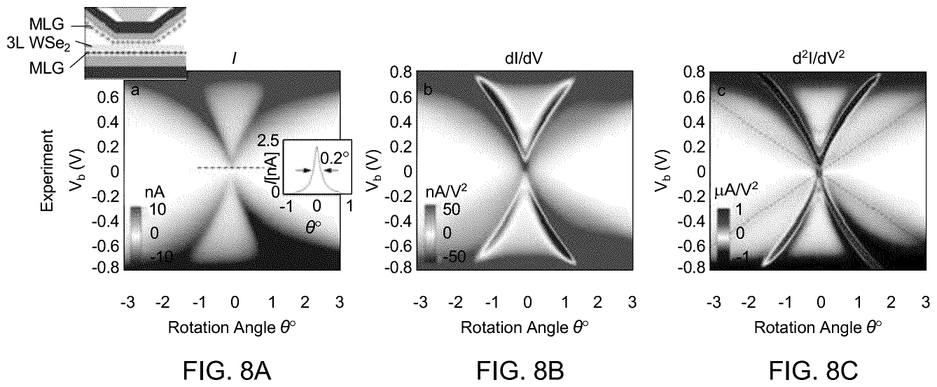

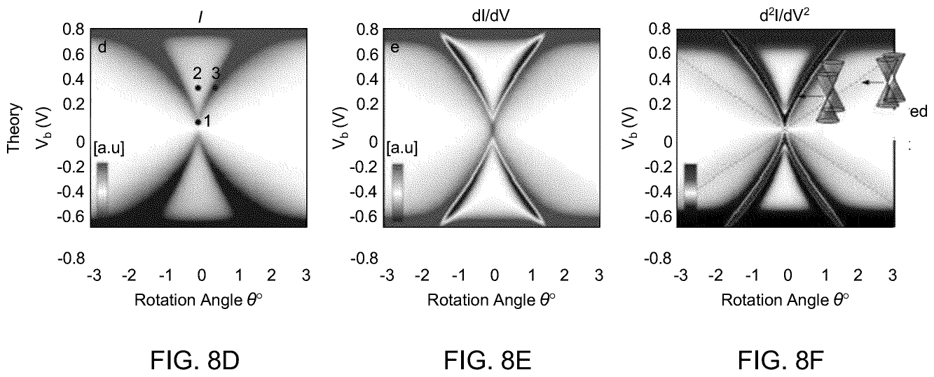

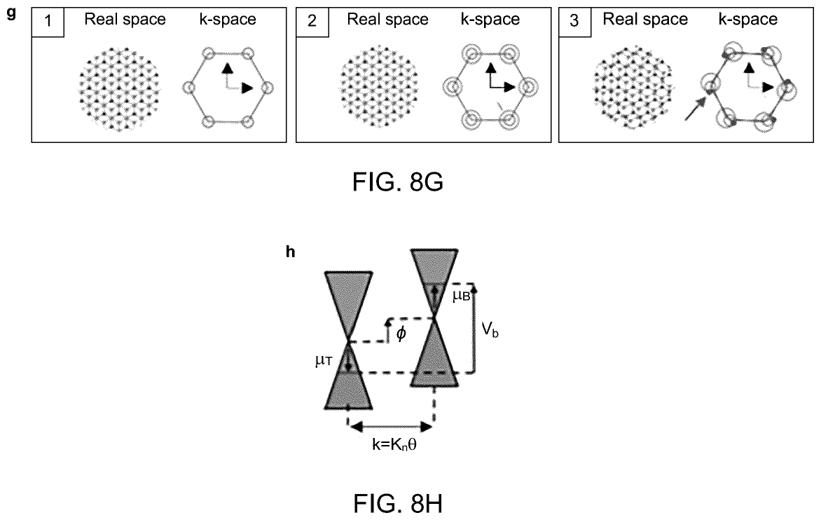

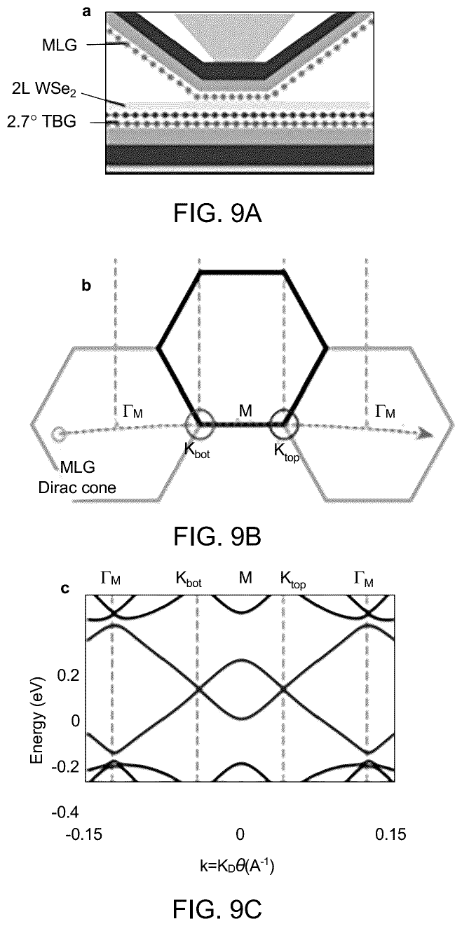

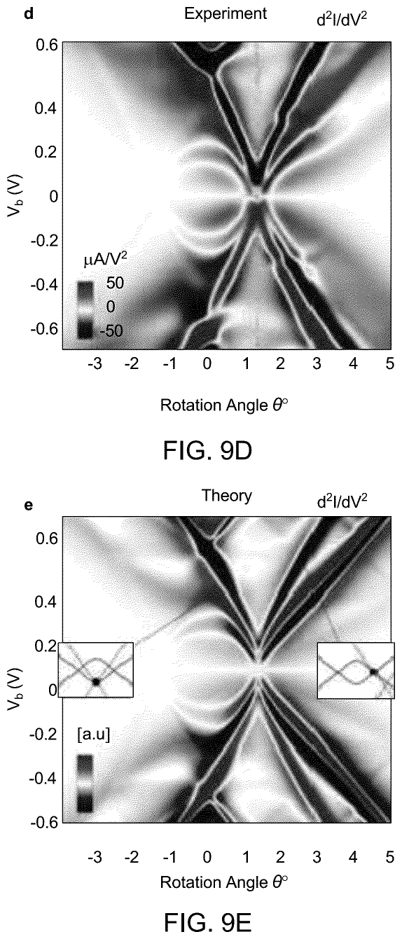

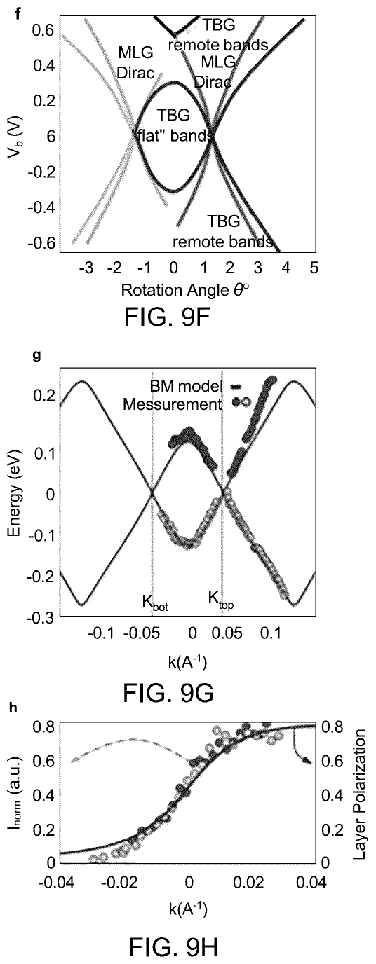

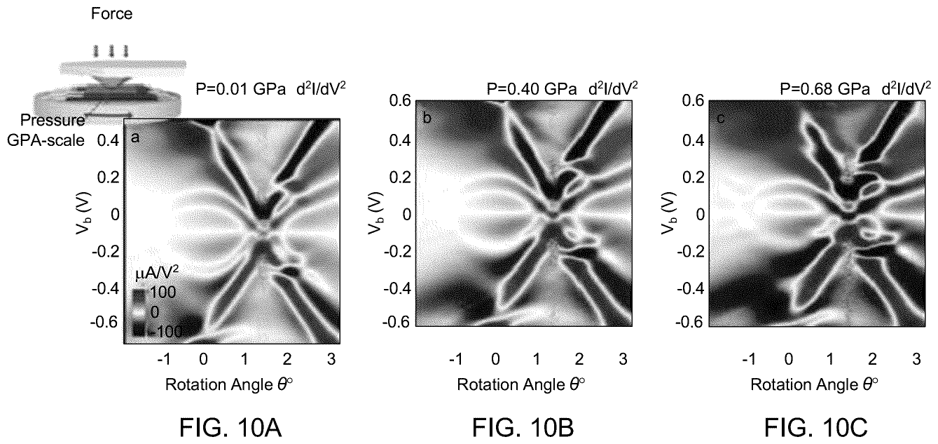

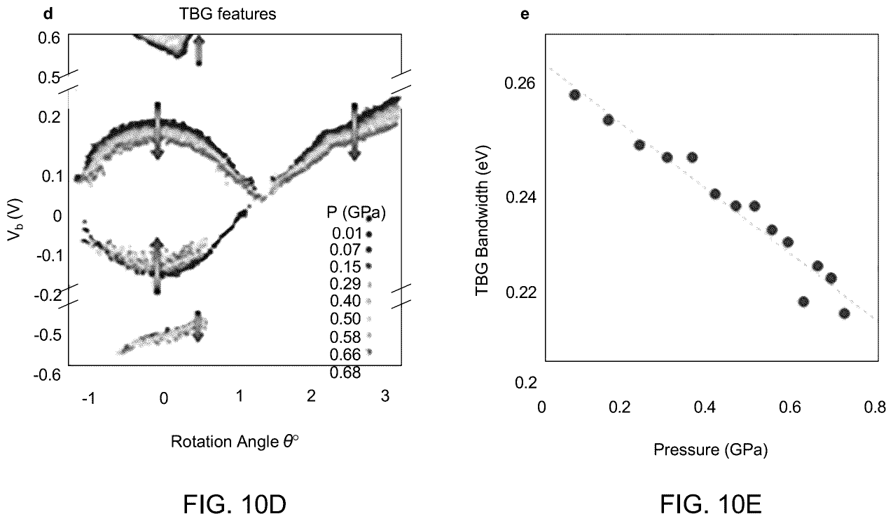

To date, existing approaches for in-situ twisting experiments are based on electrical devices fabricated with a rotatable part and an external mechanical device, such as an atomic force microscope (AFM) tip, which pushes this part. The QTM of the inventors, in contrast, elevates the AFM tip to become an integral part of the twisted device, which is now split into two parts: the first is a standard vdW device formed on a flat substrate (FIG. 7a, Supp. Info. S2). The second is a vdW device formed on a specially-designed pyramid at the edge of an AFM cantilever (FIG. 7b, Supp. Info. S1). Both sides have independent electrical contacts. The inventors have used a commercial AFM to bring the two parts into contact and to maintain a constant force across the interface throughout the entire experiment (FIG. 7c). On the AFM stage, they have mounted a piezoelectric rotator with X and Y nanopositioners on top (Supp. Info. S3). This setup allows rotating the bottom sample with an angular resolution of 0.001° and positioning the point of interest in the sample at the center of rotation. In addition, the standard scanning capability of the AFM (in X and Y directions) enables lateral scanning of the tip across the sample.

A useful ingredient of the QTM is its tip design, facilitating the formation of a flat vdW at its apex. To achieve this in some non-limiting experiments, the inventors started with focused-ion-beam deposition of a platinum pyramid (˜1.2-1.6 μm tall) on a tipless AFM cantilever (FIG. 7e). This is followed by sequentially transferring graphite, hBN and the active vdW layer (e.g., monolayer graphene) on the pyramid using a polymer membrane. The graphite screens the substrate's disorder potential, and the hBN acts as a spacer. FIG. 7f shows an AFM image of the resulting tip: visibly, the vdW stack forms a “tent” over the pyramid with three or more folds climbing up to the pyramid's apex. At the apex, a flat plateau spontaneously forms in the vdW stack, whose corners are determined by the folds (FIG. 7g). The typical bending angles of the vdW tent (˜10-30°) are smaller than the pyramid's angle (˜45°). Thus, apart from a small touching point at the apex, the tent is mostly suspended (Supp. Info. S1). Due to the flexural rigidity of the graphite/hBN layers, the formed vdW plateau is wider than the pyramid apex, resting on it as a pivoting point. Therefore, when this tip is brought into contact with the sample, the plateau self-aligns its tilt to become parallel to the sample. By varying the pyramid geometry and graphite/hBN flake thicknesses (typically tens of nanometers), the inventors have achieved plateaus of varying linear dimensions between 50 nm and 1 μm. These dimensions are small enough to make their QTM tip a local scanning probe, yet large enough (˜1000 atoms across or more) for wavefunctions on the plateau to have a well-defined momentum (ΔP˜ 1/1000 of the Brillouin zone size). Contrary to etched boundaries in lithographic devices, the active vdW layer on the plateau is continuously extended to the rest of the pyramid, avoiding dangling bonds or buckles. This setting makes the wavefunctions smoothly connect to the rest of the vdW layer on the pyramid. FIG. 7d overlays the measurement circuit on a schematic cross-section of the junction: a bias voltage, V_{b}, is applied between the two active layers (vdW crystals 1 and 2), and the corresponding current, I, is measured. Buried bottom and top graphite layers can serve additionally as bottom and top gates for the junction.

### In-Situ Twistronics

The inventors have started with a “twistronic” measurement of a twistable interface between two graphene monolayers (MLG) in direct contact. This interface has remained elusive for existing in-situ twistronics techniques since MLG easily crumbles upon twisting. FIG. 7h shows the MLG-MLG interface conductance, dI/dV, measured vs. twist angle, θ, at T=300K. Throughout the entire measurement, the sample and tip are kept in continuous contact. The layers do not show any sign of locking at θ=0°, and the conductance traces are highly reproducible, highlighting the unique mechanical robustness of the QTM junction. The conductance is mirror symmetric around θ=30°, (θ→60°−θ), where its value is minimal. It rises continuously toward θ=0° but plateaus at small angles (|θ|≤4°) where it becomes limited by the resistance away from the tip (“contact resistance”). Similar to the measurements in graphite-graphite and graphite-MLG interfaces by other groups, the inventors have seen extremely sharp conductance peaks at θ=21.8° and 38.2°. At these angles, the two layers form commensurate stackings in real-space with a \sqrt{7}×\sqrt{7} supercell (FIG. 7i).

On the origin of the large conductance enhancement at commensurate angles, the inventors contemplated the following. One possibility is a better real-space registry of the atoms in the two layers. However, by definition, whenever unit cells are commensurate in real-space, their corresponding Brillouin zones (BZ) are also commensurate in k-space, implying that at commensurate angles, momentum states are also matched. Specifically, at θ=0° the Dirac cones of the two layers overlap at the corners of the 1^{st} BZ, and at θ=21.8° they overlap at the corners of the 3^{rd} BZ (FIG. 7i). The relevance of real vs. momentum space matching is directly connected to the quantum coherence of the 2D tunnel junction: in an incoherent junction, the tunneling events of electrons at different locations are independent, and sum up classically to yield the total current (FIG. 7j, top). In such a case only the real-space matching is relevant. Conversely, in a coherent junction, tunneling events at different locations interfere, yielding a tunneling current that is sensitive also to the local phases of the wavefunctions (FIG. 7j, bottom). In particular, tunneling is possible only between wavefunctions with matching energy and momentum.

### Local Momentum Resolved Tunneling

To observe also the momentum conserving nature of the QTM the inventors have added a tunneling barrier between the two MLG layers (trilayer WSe₂. FIG. 8a, top inset). This barrier suppresses the hybridization between tip and sample, enabling the tip to act as a probe for the unperturbed energy bands of the sample. The barrier also significantly increases the tunnel junction resistance, assuring that an applied bias falls predominantly across this junction and that the measurement is not affected by contact resistance even near θ=0°. FIG. 8a shows the measured tunneling current, I, vs. the interlayer bias, V_{b}, and θ at T=300K. Around θ=0°, I increases slowly with V_{b} at low bias, and then sharply increases along a curved-X feature in the θ−V_{b} plane. Interestingly, this increase is followed by a sharp drop at slightly higher V_{b}. At much higher biases (˜0.8V), I rises again, this time exponentially with V_{b}, and rather homogenously for all 0. FIG. 8b shows the measured conductance, dI/dV. Here, the sharp drop of I manifests as a strong negative differential resistance (NDR), as was seen previously in lithographic devices. Finer details are revealed when the inventors have plotted the second derivative, d²I/dV² (FIG. 8c): in addition to the strong curved-X (dashed white lines), the inventors have observed a straight-X feature (dashed black lines), along which d²I/dV² shows peaks (/dips) on the positive (/negative) bias side.

To understand the observed curved-X feature three points in the θ−V_{b} plane (FIG. 8d) can be considered: at point 1 (θ=0°, small V_{b}) the atoms of the two layers are registered in real-space and their energy surfaces are matched in momentum-space (FIG. 8g, panel 1). Increasing V_{b} while keeping θ=0° (point 2) maintains the real-space registry but offsets the relative energies of the Dirac cones. Consequently, for almost all energy slices within the bias window, the equal energy states have mismatched momenta (one such slice is shown in panel 2 of FIG. 8g). Thus, the observed drop of I is concomitant with the loss of energy-momentum-matched cigenstates in the two layers. By twisting the layers to a finite θ, while maintaining V_{b} (point 3), the layers lose the registry in real space but regain overlap of states in momentum space, enabling momentum-conserving tunnelling processes (FIG. 8g panel 3). Indeed, at this point the measured I becomes large again, demonstrating its momentum conserving nature. The inventors have estimated the level of momentum conservation from a plot of I vs. θ at small V_{b}=40 mV (FIG. 8a, right inset). The extremely narrow peak (Δθ≈0.2°) implies an excellent momentum resolution, ˜0.004 of the BZ size, comparable to state-of-the-art ARPES detectors. In the experiment in FIGS. 8a-h, the back gate voltage is zero and the measurement shows a good symmetry between positive and negative bias directions, suggesting an overall charge-neutral system. Additional experiments with finite back gate voltages (Supp. Info. S6) further show a rich evolution of the features with the total charge in the system.

The inventors have compared their measurements to theory of momentum-resolved tunneling between twisted layers presented in Bistritzer, R. & MacDonald, A. H. Transport between twisted graphene layers. Physical Review B 81, 245412 (2010). Sec FIGS. 8d-f. Since the quantum and geometrical capacitances of the junction are generally comparable, the applied bias divides into shifts of the chemical potential of the top and bottom layers, μ_{T} and μ_{B}, and an electrostatic potential shift between them, ϕ, namely, V_{b}=ϕ+μ_{B}−μ_{T} (FIG. 8h). To calculate the tunneling current at any point in the θ−V_{b} plane, the inventors have first determined μ_{T}, μ_{B} and ϕ by solving the above equation self-consistently with the equations-of-state of the individual layers, μ_{T}(n_{T}) and μ_{B}(n_{B}), (Supp. Info. S4). They then have summed the tunneling rates for all energy-momentum conserving tunneling processes within the bias window. The inventors further add a Nordheim-Fowler contribution due to the breakdown of the WSe₂ barrier. All expressions include the effects of finite temperature and lifetime. Overall, the agreement with the experiments has been excellent, both in terms of the locations of the various features, and in terms of their relative magnitude. The theory further has allowed the inventors to identify the experimentally observed features: the straight-X corresponds to the onset of momentum resolved tunneling, happening when the Fermi surface of one layer touches the empty bands of the other layer (‘k-resolved onset’ condition, FIG. 8f). The curved-X feature corresponds to nesting of the energy bands (‘nesting’ condition, FIG. 8f). Here, a macroscopically large number of energy-momentum conserving states become available to tunnel, explaining the large increase of I along this feature. With a further increase of V_{b} or a further decrease of θ most of the states cease to be energy-momentum conserving, explaining the consequent large drop in I.

The simplicity of graphene's dispersion has allowed the inventors to obtain analytic expressions for the k-resolved onset and nesting conditions. Specifically, for a non-interacting charge-neutral system, the onset condition becomes (Supp. Info S5) V_{b}=ℏv_{F}K_{D}θ, where K_{D} is the Dirac point momentum. Namely, V_{b} and θ substitute the energy and momentum in the standard Dirac equation. Overlaying this expression on the measurement (dashed black lines, FIG. 8c) yields an excellent fit with v_{F}=1.05±0.02·10⁶ m/s, consistent with a measured Fermi velocity of graphene. Additionally, the nesting line provides the energy shift between the bands, ϕ, at any value of V_{b}, from which the electronic compressibility of the system can be straightforwardly determined (Supp. Info. S5). This measurement thus provides simultaneous information about the excitation spectrum of the system and its thermodynamic properties.

### Momentum-Resolved Imaging of Twisted Bilayer Graphene Energy Bands

Having probed the energy bands of MLG, the inventors have turned to a system with more intricate energy bands—twisted bilayer graphene (TBG). The experiment comprises of a MLG probe, a bilayer Wse₂ barrier, and TBG with a 2.7° twist (FIG. 9a). In momentum space, the TBG mini-BZ hosts at its corners the Dirac cones of the underlying top and bottom graphene sheets (red and blue circles at Kₜₒₚ and K_{bot}, (FIG. 9b). In the experiment, the MLG is rotated with respect to the TBG, and correspondingly its Dirac cone (purple circle, FIG. 9b) scans the energy bands of the TBG along a constant radius arc in momentum space (dashed purple arc, FIG. 9b), cutting precisely through Kₜₒₚ and K_{bottom} and passing very close to the Γ_{M} points of adjacent mini-BZ's. Along this k-space linecut, the TBG is theoretically predicted to exhibit the “flat bands” around zero energy and remote bands at higher energies (blue and black in FIG. 9c). FIG. 9d shows the dI²/dV² measured vs. V_{b} and θ. The second derivative diminishes the smoothly evolving background, allowing to clearly resolve the key features. The measurement shows a wealth of features, the most prominent of which are traced in FIG. 9f. Interestingly, it exhibits a superposition of the ‘system’ and ‘probe’ energy bands, including the TBG's flat bands (blue), remote bands (black), as well as two copies of the MLG Dirac bands (purple).

A theoretical calculation of the MLG-TBG momentum-resolved tunneling (FIG. 9e) shows excellent agreement with the experiment, down to small details. Specifically, the theory reproduces the features due to the flat and remote TBG bands, as well as the two displaced copies of the MLG Dirac bands. Furthermore, from the theory the inventors have been able to conclude that the band imaging is performed effectively by Dirac points: for example, when the MLG Dirac point matches in energy and momentum a state on the TBG flat bands (left inset, FIG. 9e), the d²I/dV² exhibits a peak. This peak of d²I/dV² corresponds to a minimum in I, reflecting the minimal tunnelling density of states at the Dirac point. Similarly, when one of the two TBG's Dirac points matches the MLG bands (right inset, FIG. 9e) a strong feature appears in dI²/dV² (this time with an opposite sign, see toy model in Supp. Info S8). Consequently, the two TBG Dirac points trace out two copies of the MLG bands, displaced by Δθ=2.7°. In addition to these ‘Dirac matching’ conditions that are insensitive to band filling, there are also ‘onset’ features, which appear whenever the Fermi level of one side (tip/sample) crosses the bands of the other side (for details see Supp. Info. S8).

The inventors have obtained the flat-band energy dispersion directly from the measurements by using the simultaneously measured MLG Dirac bands to calibrate the energy shift at each V_{b} (Supp. Info. S8). FIG. 9g compares the extracted ∈(k) of the flat bands (red and grey dots) with the prediction of the BM model (blue). The overall agreement is rather good, although the experiment shows an electron-hole asymmetry (˜12% along the K_{bot}−M−Kₜₒₚ branch and ˜20% along the Kₜₒₚ−Γ_{M} branch), contrasting the nearly-perfect e-h symmetry of in the BM model. The inventors' measurements also reveal a quantity that is inaccessible to other probes—the layer polarization of individual wavefunctions at different momenta: visibly, when the MLG lattice is rotationally aligned with the top TBG layer (θ=+1.35°) the measured dI²/dV² amplitudes are strong. In contrast, when the MLG is rotationally aligned with the bottom TBG layer (θ=−1.35°) they are substantially weaker. This highlights the fact that the experiment probes the weight of the wavefunction on the top layer. In FIG. 9h the inventors have plotted the magnitude of I along the traced flat band features (blue, FIG. 9f) between Kₜₒₚ and K_{bot} (dots), and compared it with the layer polarization as a function of k from the BM model. The inventors have been able to see that this quantity is indeed a good proxy for the layer polarization.

### Imaging Twisted Bilayer Graphene Energy Bands Under Pressure

The inventors have proceeded also to showing another unique capability of the QTM—its ability to apply a large local pressure while simultaneously imaging the way it affects the energy bands. Pressure provides a key tuning parameter for vdW materials, as it directly controls the interlayer tunneling. In TBG, this was predicted and shown to tune the flat bands in and out of the magic-angle condition. However, the challenges in cryogenic pressure cell transport experiments have limited such experiments to very few measurements. Here, instead, the inventors have used the ability of the AFM to apply μN-scale forces across the small QTM junction to achieve GPa-scale pressures at the interface (FIG. 10a, inset).

FIGS. 10a-c plots the measured dI²/dV² vs. θ and V_{b}, for the junction of FIGS. 9a-h, but now under pressures of P=0.01, 0.4, and 0.68 GPa. Each frame is taken with a constant pressure during twisting, and the results are reversible upon repeatable increase and decrease of pressure between frames. Visibly, with increasing P the flat bands gradually shrink toward zero V_{b}, whereas the remote bands get further away from zero V_{b}. To show this more quantitatively, in FIG. 10d the inventors have traced the flat and remote bands over a larger sequence of pressures. The inventors have been able to clearly see the opposite motion of the flat and remote bands with pressure (arrows). This contrasting response reflects a band anti-crossing that increases with P, as expected from increased interlayer tunneling. Converting V_{b} to the energy shift using the simultaneously measured MLG bands, the inventors have plotted the energetic width of the flat bands vs. P (FIG. 10e). Notably, the width shrinks linearly with P, reaching a 17% reduction at P=0.68 GPa. This compares reasonably to the 6-14% reduction predicted theoretically. A linear extrapolation of the measurements conducted by the inventors would suggest that the bands of 2.7° TBG could become fully flat at P≈4 GPa, well within the pressures achievable by AFM without damaging graphene. This could lead to fully flat bands with a moiré periodicity that is much shorter than in magic-angle TBG, and correspondingly to proportionally larger Coulomb interactions, potentially taking this system into uncharted regimes of strong interactions.

The QTM demonstrated here and based on the probes and techniques according to the present disclosure may be employed in industrial and scientific setting for characterization of various devices. Additionally, it may be used for creating highly controllable novel interfaces between a large variety of quantum materials. Specifically, it enables continuous control with 0.001° resolution of one of the critical parameters of these interfaces—their twist angle. In the Additional Description with Supplementary Information, the inventors have explored systems based on graphene and WSe₂, but the technique should be applicable quite generally to a plethora of layered conductors, and superconductors.

In any case, in view of the above, it is clear that the inventors have enabled a novel scanning microscope that has direct access to the energy-momentum dispersion of electronic systems. As such, it may probe the dispersion of any excitation, charged or neutral, as long as it can be excited by a tunneling electron. The measurements can be performed at large magnetic fields, with variable carrier density and electrical displacement fields controlled by local gates, and with a continuously tunable pressure. As for the lateral scanning degrees of freedom of the QTM, they result naturally from its SPM (AFM or STM) platform. These degrees of freedom allow preforming spatially-scanned momentum resolved measurements within electronic devices with a high spatial resolution (˜100 nm). Lateral scanning also provides control over the lateral displacements between vdW materials, most likely down to atomic dimensions, capturing another key tuning parameter of the energy dispersions at these interfaces.

The following presents more details on FIGS. 7a-j to 10a-e:

FIGS. 7a-j: The Quantum Twisting Microscope setup and in-situ twistronics experiments, a, b and c, Illustrations of the components of the QTM. a. van-der-Waals (vdW) heterostructure assembled on a flat substrate with electrical contacts. b. vdW heterostructure assembled on a pyramid positioned near the edge of an atomic force microscope (AFM) cantilever, with electrical contacts. At the apex of the pyramid, the vdW-device-on-tip has a flat plateau. c. These devices are brought into contact using a commercial AFM, fitted with a piezoelectric rotator that allows to control the relative angle between tip and sample, θ, continuously with a 0.001° resolution, in addition to the usual lateral (X/Y) scanning capabilities of the AFM. d. Measurement circuit plotted over a schematic cross-section of the QTM junction. A voltage bias, V_{b}, is applied between the two active vdW layers (vdW crystals 1 and 2), and the corresponding current, I, is measured. Buried top and bottom graphite gate voltages, V_{BG} and V_{TG}, can modify the local carrier density and electric field in the junction (in this Additional Description with Supplementary Information, the top gate is physically shorted to the top graphene layer such that V_{TG} is identically zero) e. SEM image of an AFM cantilever with a custom-made platinum pyramid deposited by a focused-ion-beam. f. The topography of a vdW-device-on-tip (graphite/hBN/monolayer graphene (MLG)), imaged by AFM. The vdW layers form a tent over the Pt pyramid, with folds (dashed white) leading to a flat plateau. g. Zoomed-in AFM image around the pyramid's apex (peak-force-error signal), showing the spontaneously formed flat plateau. h. Measured conductance, dI/dV, vs. rotation angle, θ, between two graphene monolayers (MLG, top inset) in direct contact, V_{b}=50 mV, V_{BG}=0, T=300K. The two vdW devices are kept in continuous contact throughout the measurement. i, Real-space and momentum-space registry for the commensurate angles of 0° and 21.8°. j, Illustrations of the incoherent and coherent tunneling across the 2D junction: in the former, electrons tunneling at various locations are incoherent, and the tunneling is proportional only to the local wavefunction squared. In the latter, tunneling trajectories within the coherence length interfere, and the tunneling is sensitive also to the variation of the phases of the top and bottom wavefunctions along the junction.

It should be noted that the cantilever may be formed with electrical electrodes (generally two or more electrodes). These electrodes have electrical contacts to the active layer or to separate conductive layers in the stack of the probe.

FIGS. 8a-h: Momentum resolved tunneling between two twisted graphene monolayers. a. Top inset: Schematic cross-section of the experiment, comprising of an MLG/trilayer WSe₂/MLG tunnel junction. The WSe₂ tunnel barrier suppresses the hybridization between the MLG layers allowing one to probe the unperturbed energy bands of the other. Main panel: Tunneling current, I, measured as a function of rotation angle, θ, and interlayer bias, V_{b}, at T=300K. Right inset: a plot of I vs. θ at V_{b}=40 mV (along the black dashed line in the main panel). The peak's full-width-half-max (FWHM) is 0.2°. b. A lock-in measurement of the differential conductance, dI/dV, as a function of θ and V_{b}, showing strong negative differential resistance (NDR, blue) along a curved-X feature. The measurement shows a good symmetry between the positive and negative bias directions. c. The second derivative, d²I/dV², vs. θ and V_{b}, obtained by a numerical derivative of the data in panel b. The black and white dashed lines correspond to two specific alignment conditions between the bands, ‘k-resolved onset’ and ‘nesting’, shown in panel f and described in the main text and Supp. Info. S5. d-f. Theoretically calculated momentum conserving tunneling I, dI/dV, and d²I/dV² between two MLG layers spaced by a tunneling barrier, as a function of θ and V_{b}, based on the Bistrizer-MacDonald expression for momentum conserving tunneling between rotated vdW layers. The calculation includes finite temperature, k_{B}T=25 meV, and a finite inverse electron lifetime, γ=γ₀+γ₁|∈−μ|, where ∈ is the electron energy and μ is the chemical potential. γ₀=4 meV, γ₁=0.035 are the experimentally fitted values. The lifetime at low energies corresponds to a coherence length of l_{ϕ}≈150 nm, comparable to the size of some of the inventors' tips, setting a lower bound on the decoherence by electron-phonon and electron-electron interactions at room temperature. The illustrations show the relative alignment of the two Dirac cones at the ‘k-resolved onset’ and ‘nesting’ conditions, along the corresponding dashed black and dashed white lines. g. panels 1-3 illustrate the relative alignment of the two MLG layers in real space and momentum space, corresponding to points 1-3 in panel d. h. Schematic band alignment of the two layers under finite V_{b} and θ. V_{b} divides between shifts to the chemical potentials of bottom and top layers, μ_{B} and μ_{T}, and the energy band shift (=electrostatic potential shift), ϕ. The Dirac points are shifted in momentum by k=K_{D}θ, where K_{D} is the momentum of the Dirac point.

FIGS. 9a-h. QTM imaging of the energy bands of twisted bilayer graphene (TBG) a. Schematics of the experiment, comprised of an MLG/bilayer WSe₂/2.7° TBG tunnel junction b. The mini-Brillouin zone (BZ) of the TBG, with the Dirac cones of the underlying top and bottom layers (represented by blue and red circles) located at two K-points (K_{bot} and Kₜₒₚ). Also shown are the Γ_{M} points of adjacent mini-BZs. When the MLG probe layer is rotated with respect to the TBG, its Dirac cone (purple circle) traces the TBG energy bands along an arc in momentum space (dashed purple), crossing through the K_{bot} and Kₜₒₚ points, and very close to the Γ_{M} points. c. Theoretical energy bands of 2.7° TBG along the dashed purple arc in panel b, calculated using the Bistrizer-MacDonald model. The “flat” and remote bands are shown in blue and black, respectively. d. The second derivative, d²I/dV², measured as a function of θ and V_{b} at T=300K. e. Theoretically-calculated d²I/dV² for this junction, as a function of θ and V_{b}. The theory is based on the Bistrizer-Macdonald expression for momentum conserving tunneling and includes finite temperature, k_{B}T=25 meV, and finite electron lifetime, γ=γ₀+γ₁|∈−μ| with γ₀=4 meV, γ₁=0.02. The insets show the relative alignment of the MLG and TBG energy bands at two points in the θ−V_{b} plane. Left inset: the MLG Dirac point matches in energy and momentum a point on the flat TBG bands. Right inset: the TBG Dirac point matches in energy and momentum a point on the MLG Dirac band. f, Tracing of the main features of the measurement in panel d, including features related to the TBG flat (blue) and remote (black) bands, as well as two copies of the MLG Dirac bands (purple). g. The TBG energy vs. momentum dispersion (red and grey dots) determined from the measurement in panel d after converting V_{b} to the energy axis (see text), together with the bands of the BM model (blue). h. The magnitude of the tunneling current, I, traced along the features that corresponds to the flat bands (blue curves, panel f) between K_{bot} and Kₜₒₚ (gray/red points for the positive/negative bias side). The inventors have normalized the current values by a constant to compare with the theory. Blue line: the theoretically calculated layer polarization of the wavefunction vs. momentum.

FIGS. 10a-e. Imaging the effects of applied pressure on the TBG energy bands: a. inset: Illustration of the experiment-applying a fixed AFM force across the junction results in GPa-scale pressures at the interface. In the experiment the inventors have kept the pressure on while twisting. a-c. Measured d²I/dV² vs. θ and V_{b} for the junction in FIGS. 9a-h, but under applied pressures of P=0.01, P=0.4 and P=0.68 GPa. T=300K. d. Evolution of the TBG energy bands with P. In this figure the inventors have traced features that reflect the flat and remote bands as a function of pressure (see key). For every pressure, the inventors have plotted points that were obtained from tracing the relevant feature (‘onset’ feature for the flat bands, zero dI²/dV² contour for the remote bands). Visibly, with increasing P, the flat bands gradually shrink toward zero V_{b} while the remote bands shift to higher V_{b} (arrows), consistent with a pressure controlled anti-crossing. e. The bandwidth at the M point of the TBG “flat” energy bands vs. P (red dots), determined from linecuts at θ=0°. The inventors have converted V_{b} to the energy from the simultaneously measured MLG Dirac bands (curved-X on the right side in panels a-c, see Supp. Info S8). Dashed line is a linear fit to the data. At the highest applied pressure (0.68 GPa), the bandwidth shrinks by ˜17%.

Supplementary Information (also called “Supp. Info” before):
S1. Fabrication of vdW-device-on-tip
S2. Fabrication of the flat devices
S3. Configuring a commercial AFM for QTM experiments
S4. Calculation of momentum resolved tunneling in a QTM junction.
   S4.1. Solving the electrostatics of the QTM junction self-consistently
   S4.2 Momentum-resolved tunneling current calculation
   S4.3 Band structure of TBG based on Bistrizer-MacDonald model
   S4.4 Nordheim-Fowler Contribution and WSe₂ barrier breakdown
S5. Understanding MLG-MLG momentum resolved tunneling experiments
   S5.1 Momentum-resolved onset condition
   S5.2 Nesting condition
S6. Additional experiments: back-gate dependence of MLG-MLG k-resolved tunneling
S7. Electron lifetime in MLG-MLG k-resolved tunneling experiment
S8. Understanding MLG-TBG momentum resolved tunneling experiments
   S8.1 First Toy Model-tracing energy bands with a Dirac cone.
   S8.2 Second toy model-explaining the k-resolved ‘onset’ features
   S8.3 Temperature dependence of ‘onset’ and ‘Dirac matching’ features
   S8.4 Comparing the second toy model with the experiment
   S8.5 The full calculation—origin of the features in the MLG-TBG k-resolved tunneling
      S1. Fabrication of vdW-Device-On-Tip

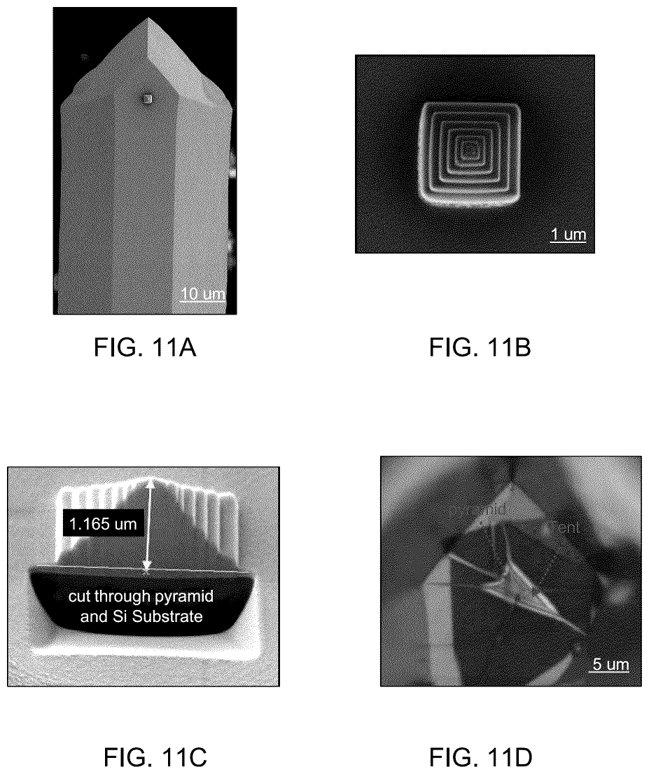

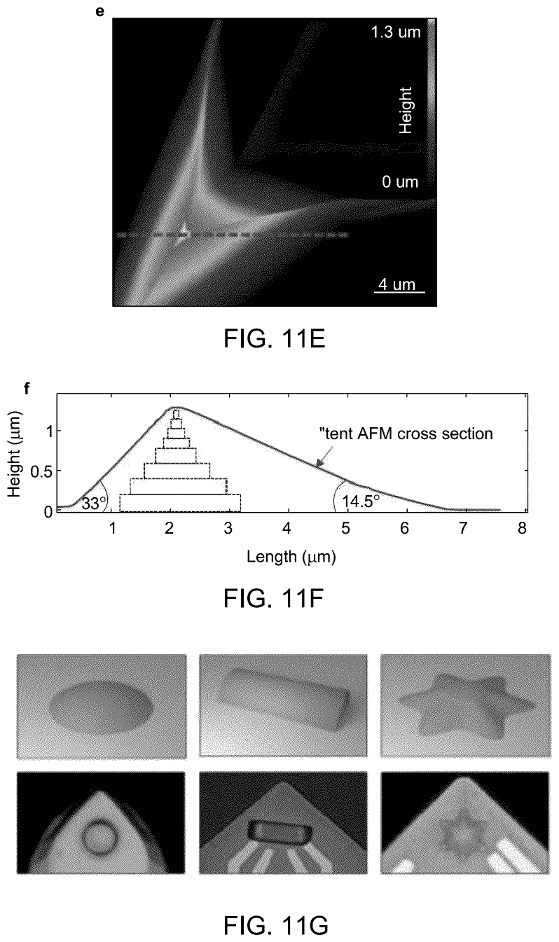

To fabricate the vdW-device-on-tips, the inventors have started with commercial tipless AFM cantilevers with a nominal spring constant of K=40 [N/m], length L=232 [μm], width W=37 [μm] and thickness T=7 [μm]. The inventors have coated the bottom side of the cantilevers with 4/100 nm Cr/Au using an e-beam evaporator. This coating serves as the electrical connection for the active vdW layer and the buried graphite, such that they are at the same electrical potential. Next, the inventors have deposited
a ˜1.2-1.6 μm tall platinum (Pt) pyramid with a ˜2 μm square base using focused ion beam (FIB) deposition (FIGS. 11a-c). The nominal size of the pyramids' apex is ˜50 nm.

To assemble the vdW-device-on-tip, the inventors have used the polymer membrane transfer technique1. Briefly, the inventors have spin-coated polypropylene carbonate (PPC) onto a Si/(90 nm) SiO2 wafer, followed by exfoliating graphene/hBN crystals. The inventors then have cut a window into a piece of adhesive tape and use it to pick up the PPC film with the target crystal. The crystal is then aligned and transferred on top of the platinum pyramid, followed by melting (˜120° C.) and washing-off (acetone) of the PPC film to leave behind the vdW crystal. The inventors have assembled the vdW heterostructure by successive transferring and cleaning of each layer. For example, for the experiments done in this Additional Description and Supplementary Information where the active vdW layer on the tip is monolayer graphene, the inventors have started by transferring a graphite flake, ˜20-40 nm thick, on top of the Pt pyramid, followed by an insulating hBN flake, ˜20-40 nm. These two layers act as an atomically flat mechanical support for the active vdW layer (monolayer graphene), which is transferred at the last step. The thicker underlayers also define the shape of the plateau obtained at the tip apex. By varying the thickness of these layers, it is possible to obtain plateaus of variable sizes in the range of 50 nm to 1 μm.

FIGS. 11a-f: QTM tip characterization. a. SEM image of FIB deposited Pt pyramid on a tipless AFM cantilever b. Top view of Pt pyramid c. Cross-section of a Pt pyramid cut using local FIB cutting d. Optical image of an MLG/hBN/graphite vdW heterostructure on top of a pyramid e. AFM topography of vdW heterostructure in panel d. f. A linecut from the AFM topography of the vdW tent (red, taken along the dashed red line in panel e) overlayed with a schematic drawing of the Pt pyramid to scale. The top part of the pyramid is smaller than the plateau formed at the top part of the vdW tent.

FIG. 11g shows examples of novel tip structures shaped using a technology developed by the inventors. Generally, the core part of the probe can be shaped as a generic 3D structure by additive deposition method such as focused ion beam deposition, or by 3D nano-printing or nano-etching methods. By designing the 3D geometry of the tip, it is possible to guide and control the way the van der Waals layers fold as they are placed on the tip. The figure shows three specific but not limiting examples of the tip geometry—a spherical dome shape (slice out of a sphere), a semi cylinder, and a Manchette shaped tip. The bottom panels show the actual tips fabricated at the end of an AFM cantilever using a two photon nano 3D printer.

It should be noted that in these examples, nanosurf quantum in grayscale writing mode was used. However, the presently disclosed subject matter is not limited to this specific technique, and the inventors have also created 3D tip shapes via other technologies such as focus ion beam and selective etching.

The two possible mechanisms for a flake to adapt to the shape of the tip is either by creating folds (“curtaining”) or by developing strain, as occurs in a balloon. Whichever scenario is at play is intimately connected to the underlying 3D shape. For instance, placement on a sharp tip generally leads to folding, whereas placement on a semi-cylindrical surface which has zero gaussian curvature results in no folds and minimal strain. By achieving precise control over the 3D geometries of QTM, the inventors established a way to control the strain fields and fold pattern. This is especially important when one places on the tip thin layers (made of van der Waals materials, complex oxide membranes or others) that are brittle, and therefore can be strongly effected by folds, or materials which change their properties due to strain. In addition to demonstrating the fabrication of arbitrary 3D shapes for tips, the inventors have also established the procedure to gently transfer graphene, hBN and brittle Transition Dichalcogenides layers on these tips. Finally, the inventors have demonstrated high quality momentum resolved tunneling with a Transition Dichalcogenides layer on a 3D shaped tip, proving that these layers can maintain their high quality without any local damage even when they are placed on such tips.

### S2. Fabrication of the Flat Devices

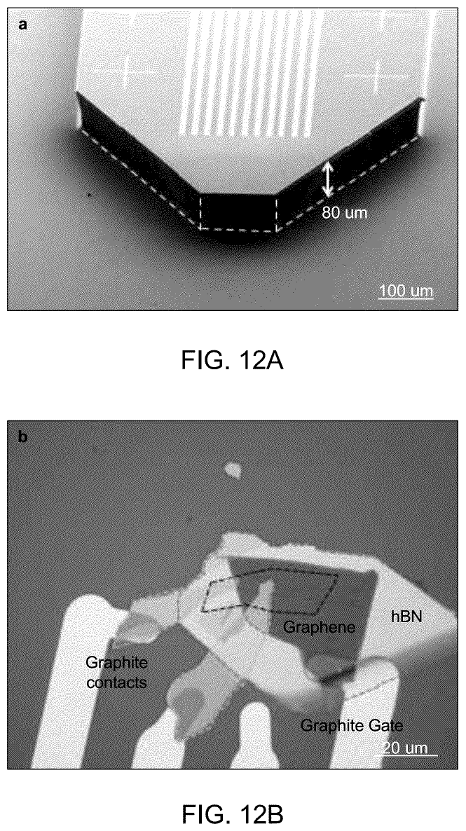

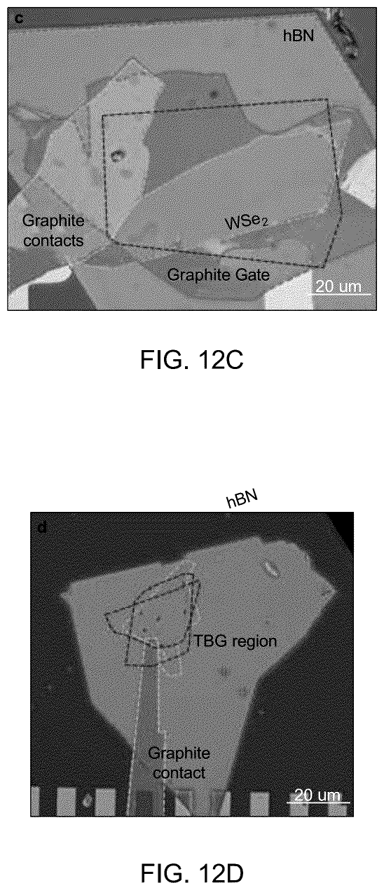

In this Additional Description with Supplementary Information, the inventors have performed two types of experiments: In-situ twistronics experiments, in which two MLG layers are brought into direct contact (without an insulating barrier in between) and the conductance of the combined system is measured as a function of the twist angle (FIG. 7h), and momentum resolved tunneling, in which the inventors have put a WSe₂ barrier between the MLG probe and the system (MLG or TBG). Here, rotation is used to scan the momentum axis. For the former, the devices consist of MLG placed on top of an hBN substrate and a graphite gate (FIG. 12b). For the latter, the inventors have used MLG or TBG on top of hBN and graphite, but now have capped it from the top with 2-3 layer WSe₂ (FIGS. 12c, d). All inventors' devices have been assembled using the standard dry transfer technique. Briefly, a polypropylene carbonate (PPC) coated polydimethylsiloxane (PDMS) is used to pick up the hBN, MLG (or TBG created using laser cut and stack method), and WSe₂ layers. The inventors have then flipped the stacks by depositing them onto a PMMA-coated PDMS, followed by placing them on the bottom graphite gate. The final heterostructure has been transferred on a ˜100 um wide and ˜80 μm tall Si/SiO₂ pillar, with pre-pattered gold contacts reaching close to its edge (FIG. 12a). The reason for placing the stack on a pillar rather than on a flat Si/SiO₂ wafer is that this provides mechanical and geometrical flexibility for the tip rotation with respect to the sample, preventing them from touching each other at any point other than at the tip's apex. Next, the inventors have created the electrical contacts by transferring thin (˜10 nm) flakes of graphite to bridge the pre-patterned contacts and the MLG or TBG. FIGS. 12b,c,d show the three variants of heterostructures used in the main text (MLG without tunnel barrier, MLG with tunnel barrier, TBG with tunnel barrier). After assembly, the heterostructures are cleaned by scanning them with an AFM in contact mode to remove polymer residues.

FIGS. 12a-d: QTM flat side substrate and devices. a. SEM image of a Si/SiO₂ pillar with pre-patterned gold contacts. b. Optical image of an MLG/hBN/graphite sample used for in-situ twistronics experiments (FIG. 7h). c. Optical image of a WSe₂/MLG/hBN/graphite sample used for momentum resolved MLG-MLG tunneling experiments (FIGS. 8a-h). d. Optical image of a WSe₂/TBG/hBN sample used for momentum resolved MLG-TBG tunneling experiments (FIGS. 9a-h and 10a-e).

### S3. Configuring a Commercial AFM for QTM Experiments

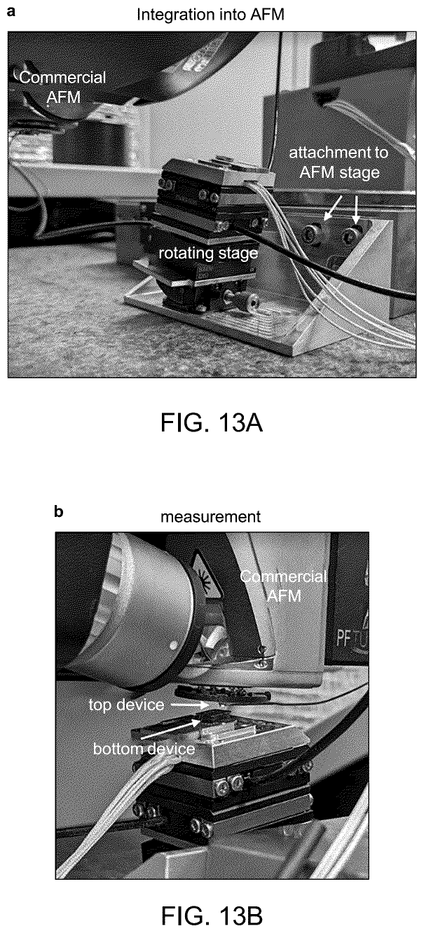

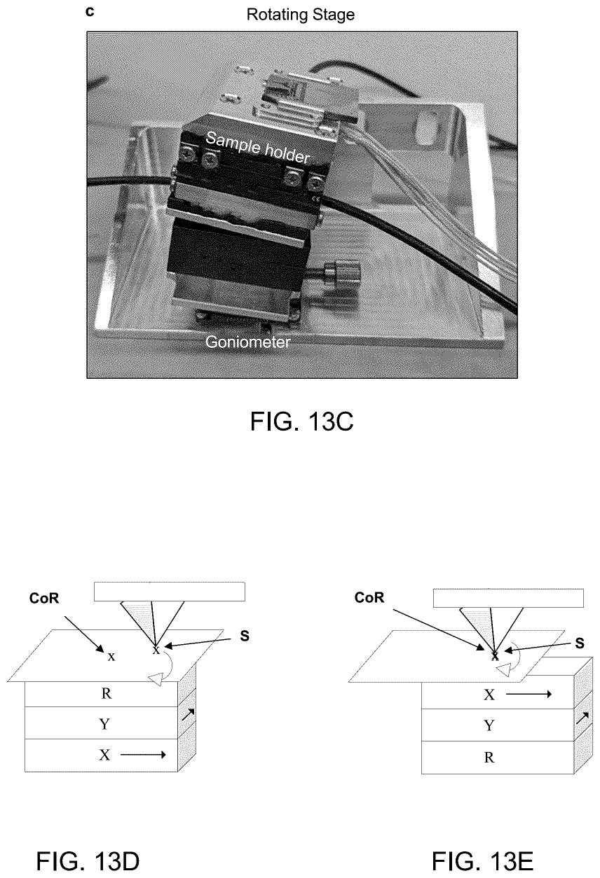

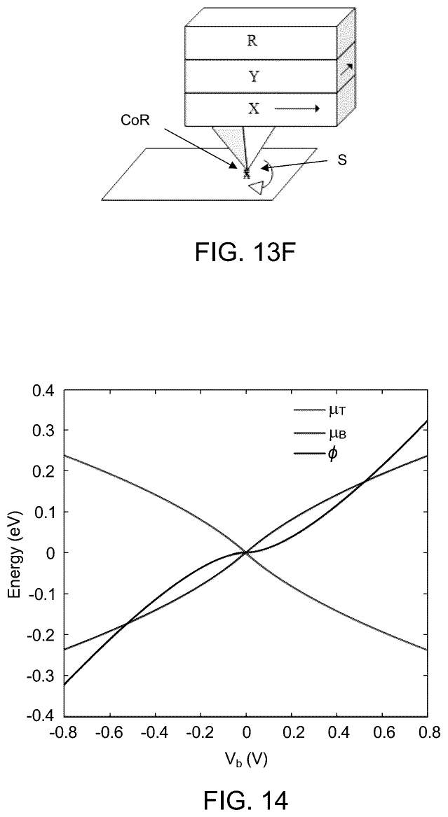

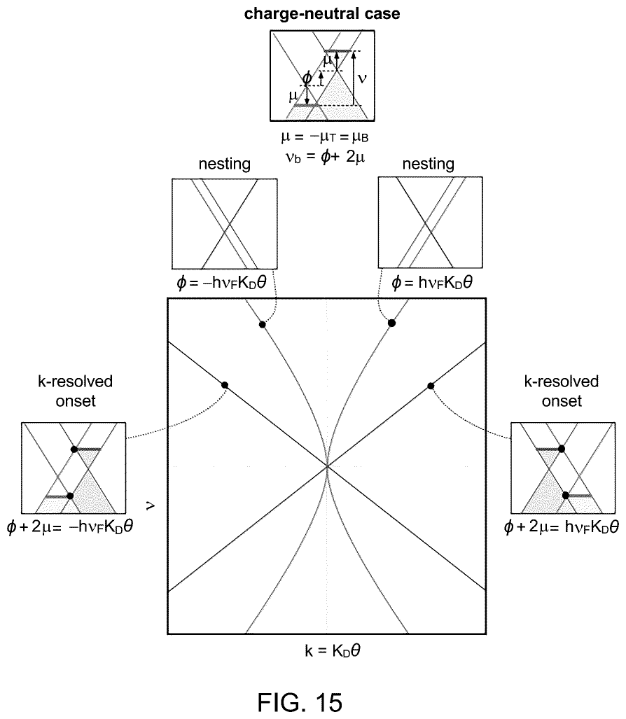

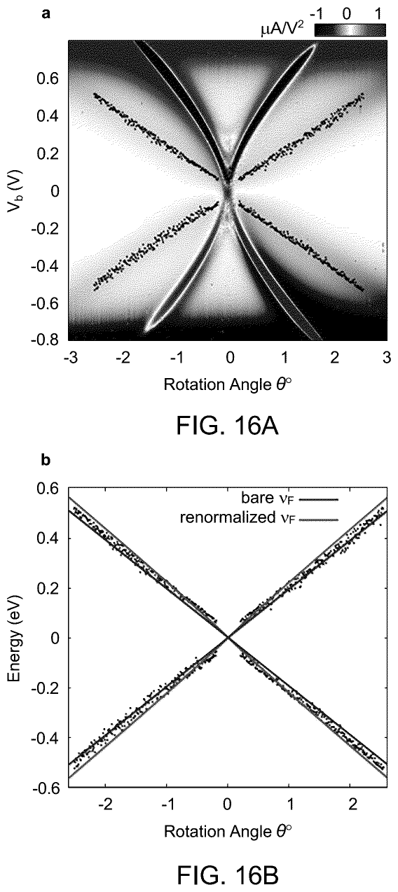

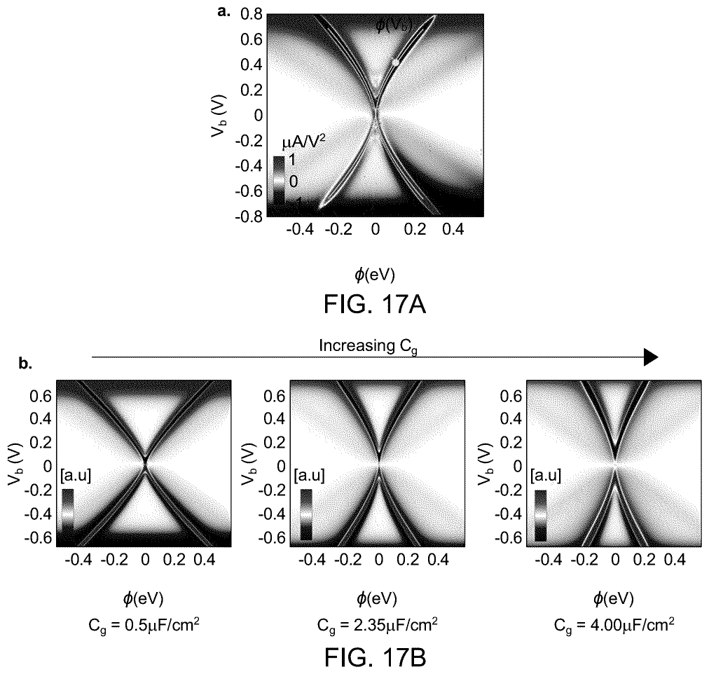

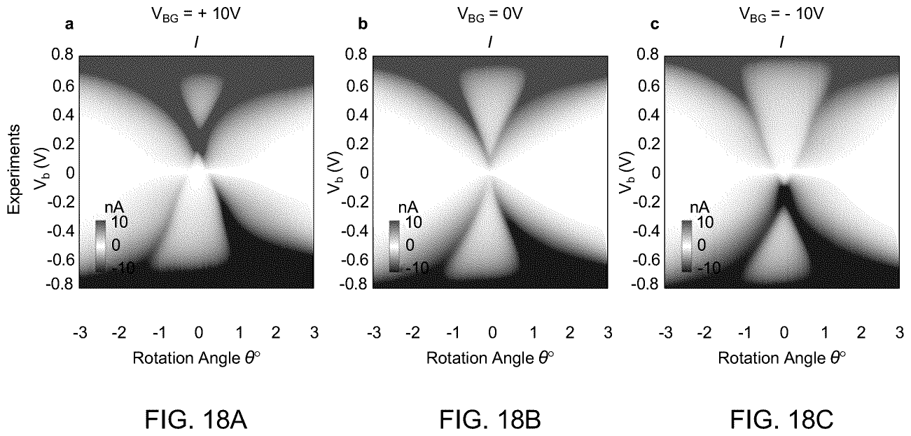

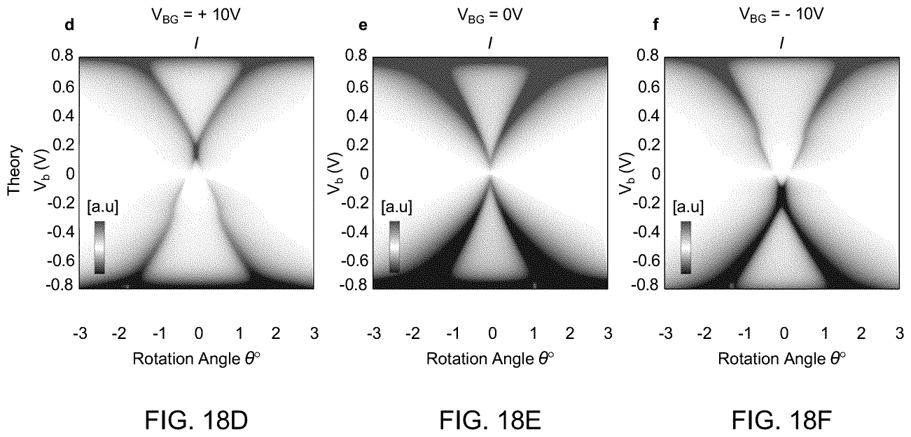

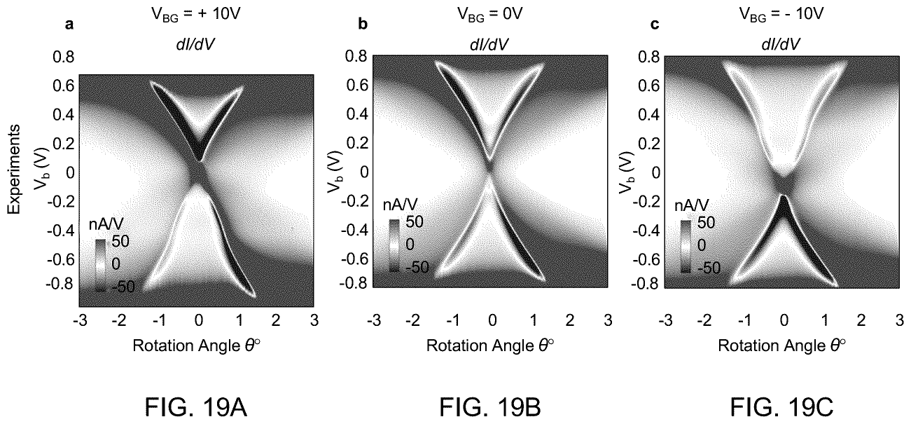

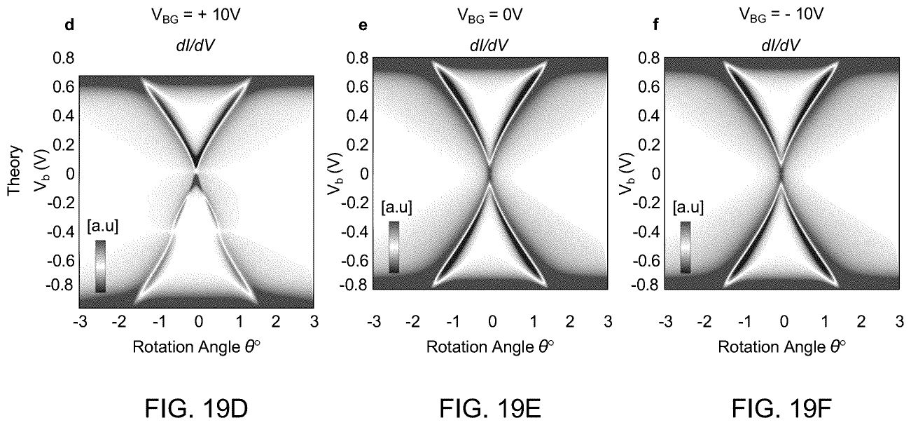

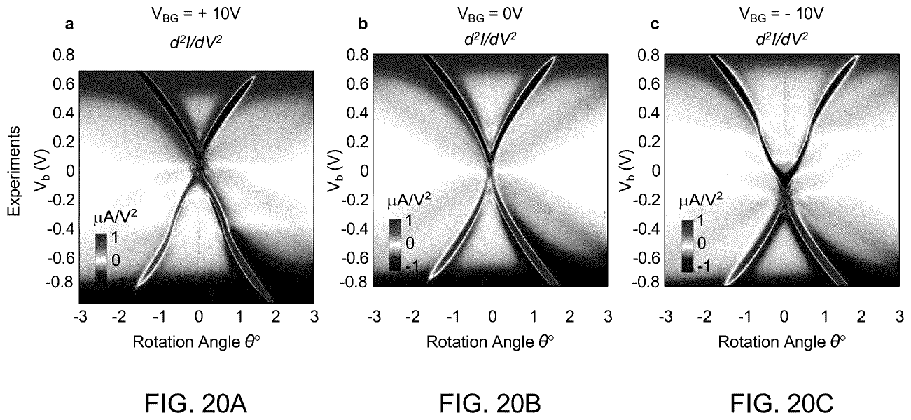

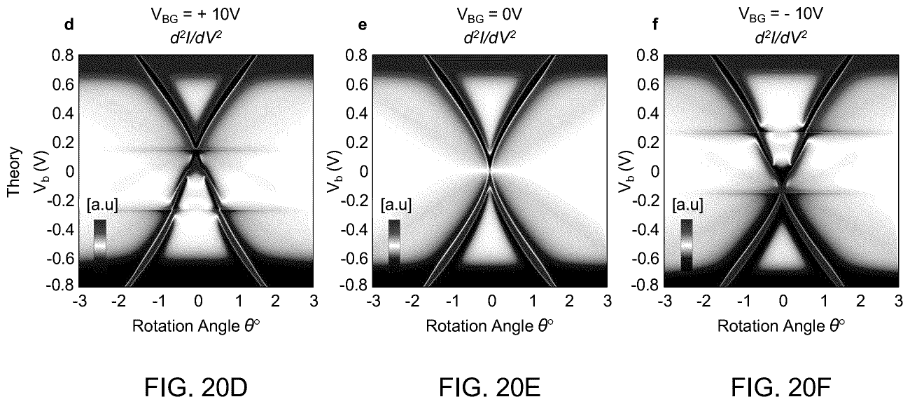

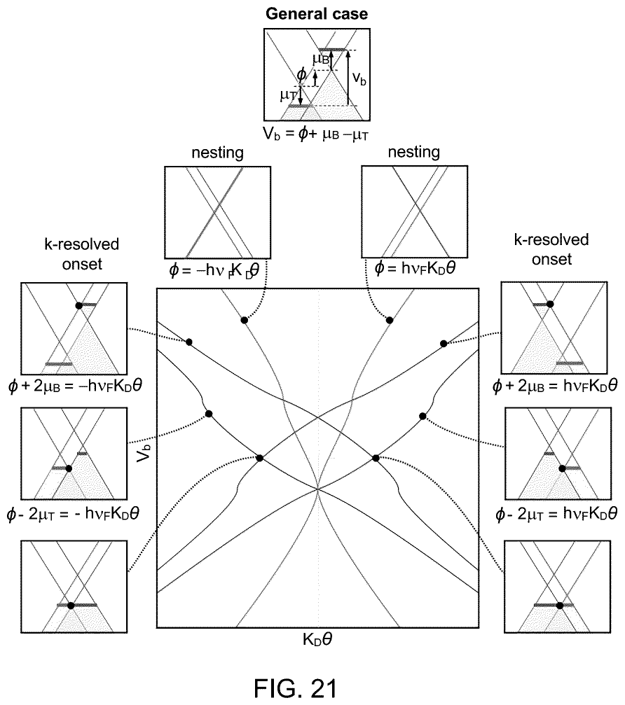

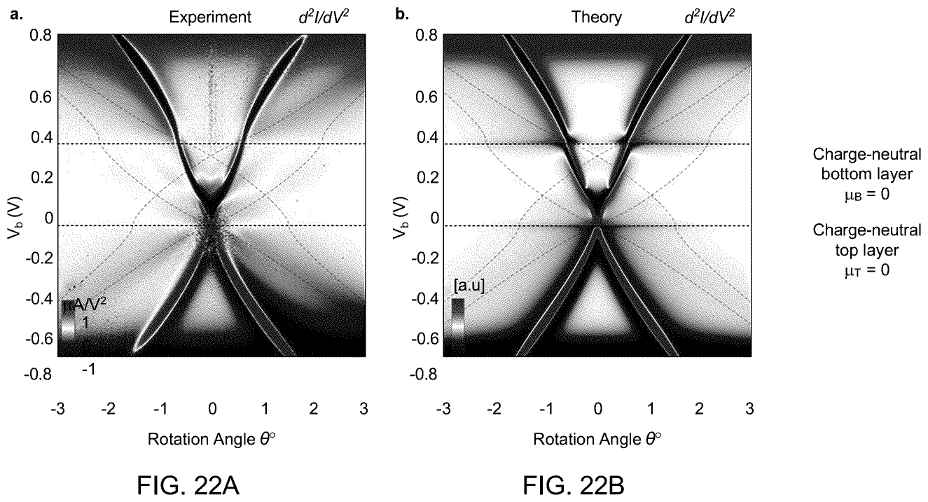

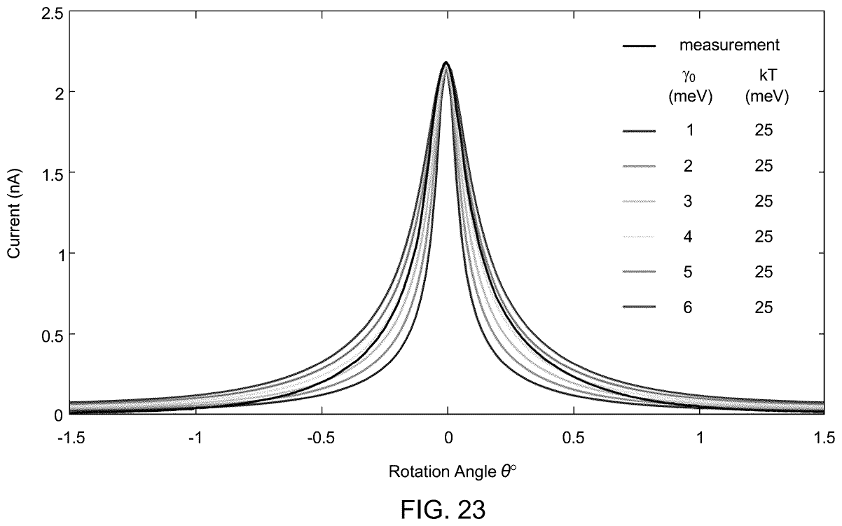

Reference is made to FIGS. 13a-c showing room-temperature QTM measurement setup, wherein FIG. 13a shows custom-built rotator stage integrated into the side of a commercial AFM stage, FIG. 13b side view of the rotator stage facing the AFM scanner and optics, and FIG. 13c shows the components of the custom-built rotating stage.

The inventors' QTM setup used in some experiments following the example of FIGS. 13a-13c has included two parts (1) A custom-built rotating stage housing the bottom devices (2) A commercial atomic force microscope (Bruker Icon) for performing the AFM operations (Force feedback and lateral positioning). Hence, this section further exemplifies various options for configuration of the AFM (some of which are mentioned also in the claims below).

The custom-built rotating stage comprises (from bottom to top): a piezoelectric rotator (attocube), X and Y piezoelectric nanopositioners (attocube) and a sample holder with multiple electrical contacts (FIG. 13c). As also exemplified in the figure, the stage may include a goniometer, depending on the configuration of the AFM. The goniometer may be used to compensate for the built-in angular tilt mismatch between the tip and sample sides in commercial AFMs (˜12 degrees in our AFM) and reduces it to ˜1 degree. The piezoelectric rotator has an optical encoder allowing for closed-loop angular control with ˜1 milli-degree precision.

According to the present disclosure, the two linear nanopositioners are provided, being mounted on top of the piezoelectric rotator, in order to position the device's point of interest (within the sample) in the center of rotation. This custom stage is attached, using a rigid frame, to an existing AFM stage (because of height limitations, in the experimental setup, the inventors had to connect the stage on a side facet of the AFM stage). This adapter has allowed the inventors to use the integrated optics and all standard AFM operations. The AFM has enabled inventors to bring the two vdW surfaces (in the tip and the sample) into contact. Additionally, inventors have used the active force feedback to maintain a constant force during rotation and measurement with a sub-nano-Newton precision. With this QTM setup, the inventors have employed two modalities for the rotation measurements. (1) Continuous contact: Here, the inventors have brought the tip and sample together and rotated whilst maintaining the two surfaces in contact throughout the entire experiment. (2) “Woodpecker”: Here, for every point in the measurement as a function of rotation angle, the inventors have brought the tip into contact with the sample, performed the measurement, disengaged, then rotated by a small angle, and then repeated this sequence to get the full measurement. It should be noted that the inventors have obtained almost identical results from both modalities, and both have been highly reproducible.

The QTM of the present disclosure provides two possible configurations of the AFM and sample to enable accurate and convenient performance of the QTM experiments.

In the first configuration, as exemplified in FIG. 13c, a custom-built rotating stage is added to a commercial AFM including (from bottom to top): a goniometer, piezoelectric rotator, X and Y piezoelectric nanopositioners and a sample holder with multiple electrical contacts. The goniometer compensates for the built-in angular tilt mismatch between the tip and sample sides in commercial AFMs (˜12 degrees in the exemplified AFM of the presently disclosed subject matter) and reduces it to ˜1 degree. In other embodiments, the goniometer may not be required, depending on the specific details of the specific AFM used. The piezoelectric rotator in FIG. 13c has an optical encoder allowing for closed-loop angular control with ˜1 milli-degree precision. However, it is noted that in other embodiments, a different type of encoder may be used. The two linear nanopositioners (e.g., providing X and Y lateral translation of the sample), mounted on top of the piezoelectric rotator, position the device's point of interest (within the sample) in the center of rotation.

It should be noted that a standard scanning microscope has its standard linear motors to allow to move/scan the tip with respect to the sample. The technique of the present disclosure provides using the two linear nanopositioners (lateral units) which are different and used in addition to the standard linear motors of the scanning microscope. The lateral units of the present disclosure are configured and operable to provide the linear lateral translations of the stage such that a selected point of interest of the sample is brought to a center of the lateral rotation of the stage during operation of the SPM.

Reference is made to FIGS. 13d and 13e showing two different configurations of the translational and rotational degrees of freedom. It is crucial to have linear positioners to allow bringing the point of interest to the center of rotation, as rotation operation is being performed. The inventors have found that placing the linear positioners on top of the piezoelectric rotator is advantageous for performing measurements/inspection in which the tip of the AFM is stationary during the experiment and the sample is rotated, as will be explained with reference to FIGS. 13d and 13e. If the rotator is positioned on top of the positioners providing the lateral degrees of freedom, as shown in FIG. 13d, the sample's point of interest, S, will escape from under AFM's tip after each rotational movement of the sample. This will happen either in case the AFM's tip is aligned with the sample's point of interest, or in case at least one of the linear positioners (e.g., X and/or Y) is/are used to bring the sample's point of interest under the AFM's tip. In both cases, the escape of the sample's point of interest, S, from under AFM's tip after each rotational movement of the sample cannot be avoided, since the sample's point of interest is not positioned in/aligned with the center of rotation, CoR, of the piezoelectric rotator. Thus, lateral adjustment of the linear positioner(s) will be required after each rotational movement, making the measurement/inspection less accurate and more complicated.

The inventors, thus, configured the AFM with the modified setup shown in

FIG. 13c and also shown schematically in FIG. 13e, where the two linear nanopositioners (e.g., providing X and Y lateral translation of the sample), are mounted on top of the rotator (e.g., piezoelectric rotator).

The QTM measurement session starts by bringing the AFM's tip in a position of alignment with (on top of) the center of rotation, CoR, of the rotator. In the next step, at least one of the two linear nanopositioners is operated to bring the sample's point of interest, S, to coincide with the center of rotation, CoR, of the rotator (and thus, also with the AFM's tip). The measurement/inspection session is performed by rotating the sample, while the sample's point of interest, S, is maintained under the AFM's tip throughout all rotational positions of the rotator.

In the second configuration, shown in FIG. 13f, the sample may be held static during the measurement session and the AFM's tip may be rotated around the sample's point of interest, S. In some embodiments, the holding stage of the flat sample is equipped with three translational degrees of freedom (XYZ). In this configuration, the carrier of the atomic force microscope cantilever (AFM) is mounted on a rotational degree of freedom (θ) as well as two lateral nanopositioners that allow to position the AFM tip at the center of rotation. As in the first configuration, also in this case, the inventors found that it is highly advantageous to have the linear translation stages mounted on the rotator and closer to the AFM tip. FIG. 13f shows such configuration where the tip is mounted on a rotational degree of freedom and the lateral degrees of freedom (e.g., X and Y) are placed in between the rotational degree of freedom and the tip. The lateral degrees of freedom are used to bring the tip to the CoR of the rotator. The fact that these degrees of freedom are placed between the rotator and the tip means that once the tip is brought into CoR no (or minimal) further corrections are needed during the rotation operation. This is in contrast to the opposite situation where the rotator is mounted closest to the tip, in which case lateral corrections are needed to be applied after every rotation, making the operation less accurate and more complicated.

### S4. Calculation of Momentum Resolved Tunneling in a QTM Junction.

In this section the model is presented used by inventors for calculating the theory panels in FIGS. 8a-h and 9a-h. In addition to the parameters that are scanned in the experiment that are shown in the main text—the twist angle, θ, and bias, V_{b}, the inventors also have included in the model the effect of back gate voltage, V_{BG}, such that it also describes the experiments at finite gate voltages shown in section S6 below. The tunneling current is calculated separately for each combination of the parameters θ, V_{b}, V_{BG}. The inventors first have determined the chemical potential of top and bottom layers and the electrostatic potential shift between them (μ_{T}, μ_{B} and ϕ) by solving the electrostatic equations (S4.1, S4.2) self-consistently with the equations-of-state of the individual layers: μ_{T}(n_{T}) and μ_{B}(μ_{B}). This is described in section S4.1 below. The inventors then have summed up the momentum-conserving tunneling rates for all states within the energy window opened by the bias, between μ_{T} and μ_{B}. This is described in subsection S4.2 below. The equation of state for the TBG is obtained from the Bistrizer-Macdonald continuum model, detailed in section S4.3. Finally, the inventors have added a Norhdeim-Fowler term due to the breakdown of the WSe₂ barrier, described in section S4.4. All expressions include the effects of finite temperature and finite lifetime.

### S4.1. Solving the Electrostatics of the QTM Junction Self-Consistently

The inventors have described the electrostatics of the QTM tunnel junction by a three-plate-capacitor model. The first two plates are the top and bottom active vdW layers (in the tip and sample), which are separated by a tunnel barrier (2 or 3 layers of WSe₂). The third layer is the graphite back-gate, separated by an hBN spacer from the bottom vdW system. The inventors have derived the two following equations:

$$e {V}_{b} = {μ}_{B} - {μ}_{T} - \frac{{e}^{2} {n}_{T}}{{C}_{g}} , \qquad ( S4 \text{.1} )$$

$$e {V}_{BG} = {μ}_{B} + \frac{{e}^{2} ( {n}_{B} + {n}_{T} )}{{C}_{BG}} , \qquad ( S4 \text{.2} )$$

where V_{b} is the applied bias between the top and bottom layer, V_{BG} is the back gate voltage with respect to the bottom layer, and μ_{B}, n_{B}, μ_{T} and n_{T} are the chemical potential and carrier densities of the bottom and top layer respectively. The geometric capacitance per unit area between top and bottom layers, C_{g}, and between the back-gate and bottom layer, C_{BG}, are given by:

$${C}_{g} = \frac{{ε}_{{WSe}_{2}} {ε}_{0}}{{d}_{{WSe}_{2}}} \qquad ( S4 \text{.3} )$$

$${C}_{BG} = \frac{{ε}_{BN} {ε}_{0}}{{d}_{BN}} \qquad ( S4 \text{.4} )$$

where d_{WSe}_{₂} is the barrier thickness (taken to be 0.58 nm per monolayer of WSe₂), d_{BN} is the hBN thickness (70 nm in the MLG-MLG experiment) in FIGS. 8a-h, and ε_{WSe}_{₂}˜4.63, ε_{BN}≈3.2 are taken to be the corresponding dielectric constants. For MLG, the dependence of carrier density on chemical potential is given by

$${n}_{Gr} = sign ( {μ}_{Gr} ) \frac{{μ}_{Gr}^{2}}{π {ℏ}^{2} {v}_{F}^{2}} ,$$

where v_{F} is the Fermi velocity. For TBG, N_{TBG}(μ_{TBG}) is calculated numerically from the Bistritzer-MacDonald continuum model (section S4 below). The inventors solve together the above equations for μ_{B}, μ_{T} and ϕ, self-consistently. Due to the low carrier density of graphene, the quantum capacitance of the QTM junction is generally of a similar order of magnitude as its geometric capacitance. Consequently, the applied bias changes the chemical potentials of the layers as well as the electrostatic potential between them, ϕ=V_{b}−(μ_{B}−μ_{T}). In FIG. 14 the inventors have plotted the dependence of ϕ, μ_{B} and μ_{T} vs. V_{b} calculated for the parameters of the MLG-MLG experiment in FIGS. 8a-8h in the main text. The inventors have been able to see that in this experiment, a change of V_{b} indeed leads to a same order of magnitude of change in all these quantities. It can also be seen that μ_{B}=−μ_{T} due to the assumption of overall charge neutrality, which describes well the experiment in FIGS. 8a-8h with V_{BG}=0. As explained in section S5, experimentally, it is possible to directly determine the dependence ϕ(V_{b}) from the nesting line in FIG. 8c. Specifically, the inventors have seen that the nesting feature in FIGS. 8c, f fits well the experiment if we take C_{g}=2.35 μF/cm², consistent with thickness and dielectric constant values mentioned above.

FIG. 14. The bias dependence of top/bottom chemical potential μ_{T/B} and electrostatic potential ϕ for MLG-MLG tunneling junction.

### S4.2 Momentum-Resolved Tunneling Current Calculation

After solving the electrostatics and obtaining the chemical potential and band alignment between top and bottom layers, the inventors have proceeded to calculate the tunneling current. The theoretical model is based on the Bistritzer-MacDonald expression for momentum resolved tunneling between two layers. The model assumes that the tunneling is well described by Fermi's golden rule, namely, that a carrier tunnels coherently only once across the junction and not multiple times back and forth. This assumption is valid for all the experiments in the Additional Description with Supplementary Information that involve a tunneling barrier between the two vdW layers and is implied from the fact that the resistance of the tunnel junction is much larger that the resistance along the vdW layers themselves. With these approximations, the tunneling current is given by:

$$I = \frac{{eg}_{s}}{2 π} \int dE ( {f}_{B} ( E ) - {f}_{T} ( E + ϕ ) ) \times {\sum }_{{k}_{T} , {k}_{B}} {\vert {T}_{{k}_{T} {k}_{B}^{′}}^{αβ} \vert}^{2} {A}_{B} ( {k}_{B}^{′} , E ) {A}_{T} ( {k}_{T} , E + ϕ ) \qquad ( S4 \text{.5} )$$

Here g_{S}=2 accounts for the spin degeneracy. The functions f_{B}(E) and f_{T}(E+ϕ) are the Fermi-Dirac distribution functions of the bottom and top layers, while ϕ is the electrostatic potential that shifts the relative position of energy bands. Tₖ_{_{T}}_{k′}_{_{B}}^{αβ} is the tunneling matrix element between a state with momentum k_{T} on the top layer to one with momentum k′_{B} in the rotated Brillouin zone of bottom layer. The functions A_{B} and A_{T} are the spectral functions for the bottom and top layers:

$${A}_{T} ( E , {k}_{T} ) = \frac{2 {γ}_{T}}{{( E - {ϵ}_{T} ( k ) )}^{2} + {γ}_{T}^{2}}$$

where ∈_{T}(k) is the energy bands of the top layer. γ_{T} is the corresponding inverse electron lifetime (the inventors elaborate on this lifetime in section S7). Similar formula applies to the bottom layer.

Eq. (S4.5) requires three conditions to be met for a tunneling event to be allowed. The Pauli principle requires the tunneling electron to originate from a full state and arrive to an empty state. This is imposed by the difference between the two Fermi functions. Energy conservation requires the energy difference between the state of origin and the state of destination to differ by ϕ. This is encoded in the energy arguments of the Fermi functions and the spectral functions. And momentum conservation requires the states of origin and destination to have the same momentum. These three requirements are typically met by a curve in momentum space, whose characteristics are determined by μ_{b}, μₜ, ϕ and, most importantly, by the energy spectra of the two layers. The contribution of the states along that curve is determined by the density of states and by the value of the tunneling matrix element at that momentum.

Following Bistritzer-MacDonald, the tunneling matrix element is given by:

$${T}_{{k}_{T} {k}_{B}^{′}}^{a β} = \frac{1}{{Ω}_{0}} {\sum }_{s , {s}^{′}} {\sum }_{{G}_{T} , {G}_{B}} {t}_{{k}_{B}^{′} + {G}_{B}} 〈 {u}_{{k}_{T} , s} \vert {T}_{{G}_{T} , {G}_{B}} \vert {u}_{{{k}^{′}}_{B} , {s}^{′}} 〉 {δ}_{{k}_{T} + {G}_{T} , {k}_{B}^{′} + {G}_{B}} \qquad ( S4 \text{.6} )$$

where |uₖ_{_{T}}_{,s} [symbol] and |u_{k′}_{_{B}}_{,s′} [symbol] are the wavefunctions on the top and bottom layers, s and s′ are the band indices, primed wave vectors are rotated with the twist angle, G_{T}, G_{B} are reciprocal lattice vectors of the top and bottom layers, α, β are sublattice indices, and t_{k′}_{_{B}}_{+G}_{_{B}} is the Fourier transform of the finite-range interlayer hopping amplitude (discussed below). In a matrix form in the sublattice basis the tunneling matrix element is given by:

$${T}_{{G}_{1} , {G}_{2}} = ( \begin{matrix}{e}^{{iG}_{T} {τ}_{t}^{A} - {iG}_{B} {τ}_{b}^{A}} & {e}^{{iG}_{T} {τ}_{t}^{A} - {iG}_{B} {τ}_{b}^{B}} \\ {e}^{{iG}_{T} {τ}_{t}^{B} - {iG}_{B} {τ}_{b}^{A}} & {e}^{{iG}_{T} {τ}_{t}^{B} - {iG}_{B} {τ}_{b}^{B}}\end{matrix} ) {e}^{{iG}_{T} \cdot {d}_{T} - {iG}_{B} \cdot {b}_{B}} \qquad ( S4 \text{.7} )$$

Here τₜ^{A} and τₜ^{B} are the sublattice positions of atoms A and B within the unit cell of the top layer; d_{T} is the lateral displacement vectors for these two layers. The BM model assumes that the tunneling amplitude t_{k′}_{_{B}}_{+G}_{_{B}} decays exponentially with the absolute value of momentum measured with respect to the origin in momentum space. Thus, the inventors have considered tunneling events within the first Brillouin zone and approximate t_{k′}_{_{B}}_{+G}_{_{B}}≈t₀, which is independent of momentum. Consequently, in the summation of G_{T} and G_{B} reciprocal lattice vectors to obtain T_{G}_{_{T}}_{,G}_{_{B}} only three processes are relevant:

$${T}_{1} = ( \begin{matrix}1 & 1 \\ 1 & 1\end{matrix} ) {e}^{{iG}_{T} \cdot {d}_{T} - {iG}_{B} \cdot {d}_{B}} \qquad ( S4 \text{.8} )$$

$${T}_{2} = ( \begin{matrix}1 & {e}^{+ i \frac{2 π}{3}} \\ {e}^{- i \frac{2 π}{3}} & 1\end{matrix} ) {e}^{{iG}_{T} \cdot {d}_{T} - {iG}_{B} \cdot {d}_{B}} \qquad ( S4 \text{.9} )$$

$${T}_{3} = ( \begin{matrix}1 & {e}^{- i \frac{2 π}{3}} \\ {e}^{+ i \frac{2 π}{3}} & 1\end{matrix} ) {e}^{{iG}_{1} \cdot {d}_{T} - {iG}_{2} \cdot {d}_{B}} \qquad ( S4 \text{.10} )$$

In addition, the tunneling amplitude t₀ is affected by the energy of tunneling electrons and the tunneling barrier shape V(z). This is described by the WKB approximation:

$$V ( z ) = {Δ}_{c} - \frac{\vert ϕ \vert}{d} z \qquad ( S4 \text{.11} )$$

$${{t}_{0} = exp \{ - \frac{1}{ℏ} {\int }_{0}^{d} {( 2 m * ( V ( z ) - E ) )}^{\frac{1}{2}} dz \} = exp \{ - \frac{1}{ℏ} \frac{2 d}{3 \vert ϕ \vert} ( 2 m \text{*)}}^{\frac{1}{2}} ( {( {Δ}_{c} - E )}^{\frac{3}{2}} - {( {Δ}_{c} - E - \vert ϕ \vert )}^{\frac{3}{2}} ) \} \qquad ( S4 \text{.12} )$$

where Δ_{c} is the distance from the Dirac point to the conductance band edge of WSe₂ relative to the graphene. E is the energy of the tunneling electron. d is the barrier width and m* is the effective mass in the z direction of WSe₂, where the inventors have assumed a parabolic dispersion. The inventors have considered here only the conduction and not the valence band edge since it is significantly closer in energy to the Dirac point. The inventors have also ignored the in-plane momentum dependence of Δ_{c}.

### S4.3 Band Structure of TBG Based on Bistrizer-MacDonald Model

The inventors have used the continuum model to calculate the band structure of TBG. For each graphene layer, the lattice vectors are

$${a}_{1} = \sqrt{3} {a}_{0} ( \frac{1}{2} , \frac{\sqrt{3}}{2} ) , {a}_{2} = \sqrt{3} {a}_{0} ( - \frac{1}{2} , \frac{\sqrt{3}}{2} ) .$$

a₀=0.142 nm is the carbon-carbon bond length and the sublattice vectors A, B are δ_{A}=a₀(0,0), δ_{B}=a₀(0,1). The Hamiltonian is given by

$$H = {H}_{b} + {H}_{t} + {H}_{inter} \qquad ( S4 \text{.13} )$$

$${H}_{b} = {\sum }_{q , ξ , s} {a}_{b , s , ξ}^{†} ( q ) ξℏ {v}_{f} {R}_{+} q \cdot σ {a}_{b , s , ξ} ( q ) \qquad ( S4 \text{.14} )$$

$${H}_{t} = {\sum }_{q , ξ , s} {a}_{t , s , ξ}^{†} ( q ) ξℏ {v}_{f} {R}_{-} q \cdot σ {a}_{t , s , ξ} ( q ) \qquad ( S4 \text{.15} )$$

$${H}_{inter} = {\sum }_{q , {q}^{′} , ξ , s} {a}_{t , s , ξ}^{†} ( q ) ( {T}_{{q}_{b} , ξ} ( q , {q}^{′} ) + {T}_{{q}_{tr} , ξ} ( q , {q}^{′} ) + {T}_{{q}_{tl} , ξ} ( q , {q}^{′} ) ) {a}_{b , s , ξ} ( {q}^{′} ) \qquad ( S4 \text{.16} )$$

a_{b,sξ}⁺ is the electron creation operator for electrons on the bottom layer with sublattice index s and valley index ξ. R_{±} is the rotation matrix of top and bottom layer by twist angle

$$\pm \frac{θ}{2} : cos ( \frac{θ}{2} ) + i {σ}_{y} sin ( \frac{θ}{2} ) .$$

The interlayer coupling matrix is given by:

$${T}_{{q}_{b} , ξ} ( q , {q}^{′} ) = ( \begin{matrix}AA & AB \\ w & w\end{matrix} ) {δ}_{q - {q}^{′} , {q}_{b}} \qquad ( S4 \text{.17} )$$

$${T}_{{q}_{tl} , ξ} ( q , {q}^{′} ) = ( \begin{matrix}{w}_{AA} & {w}_{AB} {e}^{- i ξ \frac{2 π}{3}} \\ {w}_{AB} {e}^{+ i ξ \frac{2 π}{3}} & {w}_{AA}\end{matrix} ) {δ}_{q - {q}^{′} , {q}_{tl}} \qquad ( S4 \text{.18} )$$

$${T}_{{q}_{tr} , ξ} ( q , {q}^{′} ) = ( \begin{matrix}{w}_{AA} & {w}_{AB} {e}^{+ i ξ \frac{2 π}{3}} \\ {w}_{AB} {e}^{- i ξ \frac{2 π}{3}} & {w}_{AA}\end{matrix} ) {δ}_{q - {q}^{′} , {q}_{tr}} \qquad ( S4 \text{.19} )$$

where

$${q}_{b} = \frac{8 π sin ( \frac{θ}{2} )}{3 \sqrt{3} d} ( - 1 , 0 ) , {q}_{tl} = \frac{8 π sin ( \frac{θ}{2} )}{3 \sqrt{3} d} ( - \frac{\sqrt{3}}{2} , \frac{1}{2} ) , {q}_{tr} = \frac{8 π sin ( \frac{θ}{2} )}{3 \sqrt{3} d} ( \frac{\sqrt{3}}{2} , \frac{1}{2} ) ,$$

d is the interlayer distance. w_{AA} is smaller than w_{AB} due to the lattice reconstruction in the AA region, and the inventors adopt the value: w_{AA}=88 meV, w_{AB}=110 meV.

### S4.4 Nordheim-Fowler Contribution and WSe₂ Barrier Breakdown

In the MLG-MLG junction, the tunneling spectrum shows a breakdown of the WSe₂ tunneling barrier. This is modeled within the WKB approximation. At large bias, the bending of the WSe₂ bands is large enough such that electrons can directly tunnel from the graphene into the conduction band states of WSe₂. This is the Nordheim-Fowler field emission regime, described by:

$${{t}_{{WSe}_{2}} = exp \{ - \frac{1}{ℏ} {\int }_{0}^{{d}_{0}} {( 2 m * ( V ( z ) - E ) )}^{\frac{1}{2}} dz \} = exp \{ - \frac{1}{ℏ} \frac{2 d}{3 \vert ϕ \vert} ( 2 m \text{*)}}^{\frac{1}{2}} {( {Δ}_{c} - E )}^{\frac{3}{2}} \} \qquad ( S4 \text{.20} )$$

$${d}_{0} = ( {Δ}_{c} - E ) * \frac{d}{\vert ϕ \vert} \qquad ( S4 \text{.21} )$$

Assuming that Δ_{c} is momentum independent, then the tunneling current is also momentum independent, and is given by:

$${I}_{{WSe}_{2}} = \frac{{eg}_{s}}{2 π} {\int }_{{Δ}_{c} - \vert ϕ \vert}^{∞} dE {t}_{{WSe}_{2}}^{2} {f}_{MLG} ( E ) {DOS}_{MLG} {DOS}_{{WSe}_{2}} \qquad ( S4 \text{.22} )$$

The inventors have found the values m*=1.07mₑ and Δ_{c}=0.55 eV fit the experiments, consistent with the values reported in the literature.

### S5. Understanding MLG-MLG Momentum Resolved Tunneling Experiments

In the MLG-MLG momentum-resolved tunneling experiment the inventors have identified two main features in the measured d²I/dV² vs. V_{b}, and θ (FIG. 8c): lines of momentum resolved ‘onset’ condition, appearing along a straight-X feature, and ‘nesting’ lines, appearing along a curved-X feature. In this section, the inventors have derived the equations that describe these conditions for the case of a charge-neutral system. The experiments in the Additional Description, performed with V_{BG}=0V, are to a very good approximation a charge-neutral system. By comparing these experiments to the formulas derived here, the inventors have extracted the density dependence of the Fermi velocity and electronic compressibility in this system. In the next section the inventors will show additional measurements done with non-zero V_{BG}, and derive the corresponding equations for the general case of a non-charge-neutral system.

In the charge-neutral case, the carrier density of the bottom layer is equal in magnitude and opposite in sign to that in the top layer:

$${n}_{T} = - {n}_{B} \qquad ( S5 \text{.1} )$$

Since MLG is electron-hole symmetric to a good approximation in the energy range probed in our experiments, Eq. S5.1 translates to:

$${μ}_{T} = - {μ}_{B} ≡ μ \qquad ( S5 \text{.2} )$$

The electrostatic equation that connects the applied bias, chemical potentials in the two layers, and their relative energy band shift (=electrostatic potential, ϕ) reads (illustrated in top panel, FIG. 15):

$${V}_{b} = ϕ + 2 μ \qquad ( S5 \text{.3} )$$

FIG. 15. Schematic of the charge-neutral MLG-MLG tunneling experiment (FIGS. 8a-8h in main text). The main panel shows the analytically derived lines in the θ−V_{b} plane, which correspond to the momentum-resolved ‘onset’ and ‘nesting’ conditions. Right and left insets show the theoretically calculated energy band alignments at select points along these lines. Top inset shows how the bias divides between the chemical potential of the two layers, μ=−μ_{T}=μ_{B}, and the relative electrostatic energy shift of the bands, ϕ.

### S5.1 Momentum-Resolved Onset Condition

At a given bias voltage, momentum conserving tunneling onsets when the Fermi surface of one layer touches the empty bands of the other layer. For the charge-neutral case, this condition happens simultaneously for the Fermi surfaces of the top and bottom layers (right and left insets, FIG. 15), when:

$$ϕ + 2 μ = \pm ℏ {v}_{F} {K}_{D} θ \qquad ( S5 \text{.4} )$$

Combining equations S5.4 and S5.3, the inventors have got a simple relation for the onset condition,

$${V}_{b} = \pm ℏ {v}_{F} {K}_{D} θ \qquad ( S5 \text{.5} )$$

Effectively, this relation is the Dirac equation of graphene, but with energy E and momentum k replaced by V_{b} and K_{D}θ, respectively.

This simple relation appears only in the charge neutral case (the general case is discussed below), which is a good approximation for the experiments performed at V_{BG}=0V, allowing the inventors to directly compare them with equation S5.5. In FIG. 16a the inventors have plotted the measured d²I/dV² in the MLG-MLG (reproduced from FIG. 8c) and trace the peaks (dips) that occur at positive (negative) bias at the onset conditions. The points obtained from this tracing, shown by black dots in FIG. 16b, fit well a linear Dirac dispersion (blue) with a Fermi velocity of v_{F}=(1.05±0.02)*10⁶ m/s, consistent with previous measurements in graphene. In principle, the Fermi velocity in graphene is known to be renormalized by interactions and becomes logarithmically faster as the energy of the electrons approaches the Dirac point. This renormalization depends on the fine structure constant in graphene α=e²/∈ℏv_{F}. Since α depends on the dielectric coefficient of the surrounding environment, when graphene is encapsulated in a dielectric material (in our case WSe₂ and hBN at its opposite sides), the value of the fine structure constant is close to one, and the velocity renormalization is rather small, about 10% change in velocity per one decade in energy. The inventors' experiments have had two MLG layers, which screen better than the single MLG. On length scales larger than the separation of the two MLG layers (˜1 nm in our experiment), they act as a single layer with double the density of states, effectively dividing the relevant fine structure constant, and the velocity renormalization by another factor of 2. The red curve in FIG. 16b shows the renormalized velocity calculated for our case. Visibly, the effect of renormalization is small, and within the errors in the determination of the onset peaks, both renormalized and un-renormalized expressions for the Fermi velocity fit well.

FIGS. 16a-b. a. Measured d²I/dV² from FIG. 8c, where the inventors traced the local maximum (minimum) at positive (negative) bias, along the ‘onset’ features (black dots). b. Plot of the black dots from panel a together with bare Dirac dispersion (Eq. S5.5) with v_{F}=1.05·10⁶ m/s (blue) and Dirac dispersion that is renormalized by interactions.

### S5.2 Nesting Condition

Nesting between the Dirac bands of the top and bottom layers happens when these bands overlap along a line of the Dirac dispersion. In this situation, a large number of energy-momentum conserving states become available to tunnel between the layers. Unlike the onset condition, the nesting condition is independent of the band filling, and therefore it directly probes the energy dispersion. At a given twist angle θ, the Dirac dispersion of one of the MLG is shifted in momentum by k=K_{D}θ relative to the other. Shifting the Dirac bands in energy by

$$ϕ = \pm ℏ {v}_{F} {K}_{D} θ \qquad ( S5 \text{.6} )$$

will bring the two MLG Dirac dispersions into nesting. This condition is similar to the onset condition in equation S5.5, except that here ϕ replaces V_{b}.

The nesting line in the measurement allows us to read out directly the energy shift between the bands for every V_{b}. FIG. 17a plots the measurement after rescaling the rotation angle axis using equation S5.6. In these new axes the nesting line gives directly ϕ(V_{b}).

Once the dependence ϕ(V_{b}) is determined from the measurement, it is straightforward to obtain from it the geometric capacitance, C_{g}, and quantum capacitance, C_{q}, of the system. By differentiating Eq. S5.3 with respect to ϕ, the inventors have obtained,

$$\frac{{dV}_{b}}{d ϕ} = 1 + 2 \frac{d μ}{dn} \frac{dn}{d ϕ} = 1 + 2 \frac{{C}_{g}}{{C}_{q}} \qquad ( S5 \text{.7} )$$

which provides a direct relation between the local slope of the nesting line and the ratio of geometric to quantum capacitances. Hence, for system with different geometric capacitances the nesting line will have a different shape. This is demonstrated in FIG. 17b, which shows the theoretically calculated graphs with increasing value of C_{g} between the different panels. For the case of a smaller geometric capacitance (left panel, FIG. 17b), the slope of the nesting line approaches 1, as required by Eq. S5.7. In this limit, which corresponds to the case of a thick tunneling barrier, most of the applied bias goes into shifting the bands, and only a small fraction of it goes to increasing the chemical potentials. In the opposite limit (right panel), where the geometric capacitance is large (corresponding to a thin barrier), the bias hardly shifts the energy bands but mostly changes their occupation. The center panel in FIG. 17b has a nesting line that matches closely the dependence observed in the experiment (FIG. 17a). This has allowed the inventors to determine the geometric capacitance in this experiment to be C_{g}=2.35 μF/cm². The inventors could see that for a typical width of tunneling barriers (2-4 monolayers) and with the typical density of states of MLG, the experiments are generally in an intermediate regime in which the geometric and quantum capacitances are of comparable magnitude. Eq. S5.7 also shows that once C_{g} is determined, the local slope of the nesting line provides the quantum capacitance of the system. Eq. S5.7 was derived for the symmetric (charge-neutral) case of two MLG layers. In the general case when two systems are different, or they are the same but have different carrier densities, then 2/C_{q} in Eq. S5.7 should be replaced by the in-series sum of the quantum capacitances of the two systems, 1/C_{q}^{T}+1/C_{q}^{B}.

FIGS. 17a-b. Rescaling rotation angle θ to the electrostatic potential ϕ. a. d²I/dV², measurement from FIG. 8c with θ axis converted to ϕ using the relation ϕ=ℏv_{F}K_{D}θ. After rescaling, the nesting line (yellow extracted from peak fitting) gives directly ϕ(V_{b}). b. Calculated d²I/dV² spectrum for geometric capacitances C_{g}=0.50, 2.35 and 4.00 μF/cm².

S6. Additional Experiments: Back-Gate Dependence of MLG-MLG k-Resolved Tunneling

In FIGS. 8a-h the inventors have showed momentum resolved tunneling experiments between two MLG layers. Here the inventors have presented additional data, showing how these measurements evolve with back gate voltage. FIGS. 18a-f-20a-f show measurements of I, dI/dV and d²I/dV², respectively, vs. θ and V_{b}, now as a function of back gate voltage. The top row in each figure shows measurements done at three values of the back-gate voltage, V_{BG}=−10V, 0V, +10V. The bottom row shows the corresponding theoretical calculations, based on the BM expression for momentum resolved tunneling between two parallel layers. Whereas the measurement at V_{BG}=0V is symmetric between positive and negative bias, the measurements at V_{BG}=−10V, +10V are asymmetric in bias. Focusing on the measurements of d²I/dV² (FIGS. 20a-f), in which the features are the sharpest, the inventors can see that while for V_{BG}=0V the crossing point of the curved-X is at zero bias, for finite V_{BG} it shifts to finite bias (positive bias for V_{BG}=+10V and negative bias for V_{BG}=−10V). In addition, the symmetric X shape at V_{BG}=0V evolves into a “bell-shape” that is asymmetric with respect to bias. However, if the inventors flip the bias axis and the sign of the current in the V_{BG}=−10V measurement it becomes almost identical to the measurement at V_{BG}=+10V. Namely, the data obeys the following symmetry: I(θ, V_{b}, V_{BG})=−I(θ, −V_{b}, −V_{BG}) and similarly d²I/dV² (θ, V_{b}, V_{BG})=−d²I/dV²(θ, −V_{b}, −V_{BG}).

To interpret the experiments with finite back-gate voltages, the inventors have allowed for the chemical potentials of the two layers to be different and have generalized the analysis to include a finite V_{BG}, following equations S4.1-S4.4. The resulting ‘onset’ and ‘nesting’ lines in this more general case are shown in FIG. 21. The inventors have seen that the theory recovers the asymmetric bell-shaped ‘nesting’ line, observed experimentally. This shape generalizes the functional dependence of ϕ vs. V_{b} (Eq. S5.7) to now include two unequal inverse quantum capacitances in the layers, which add in series. In addition, the inventors have seen that now each ‘onset’ line splits in two, since the Fermi surfaces in both layers have a different size and they touch the empty bands in the other layer at different twist angles.

FIGS. 22a-b overlays the calculated ‘onset’ lines on the measured d²I/dV² at V_{BG}=−10V, as well as on the corresponding theoretical calculation. Although room temperature smearing has almost eliminated all the detailed structure related to the ‘onset’ conditions, the inventors still have been able to resolve in the experiment faint peaks that follow the predicted ‘onset’ lines. Another feature that is clearly visible both in theory and experiment are the horizontal lines (dashed black) along which the d²I/dV² flips sign. Each such line corresponds to one of the MLG layers going across charge neutrality, namely either μ_{T}=0 or μ_{B}=0. Overall, the inventors have been able to see that the theory captures most of the details in the experiment rather accurately.

FIGS. 18a-f: Back-gate voltage dependence of momentum-resolved tunneling current in a MLG-MLG junction a-c. Tunneling current, I, measured in the junction in FIGS. 8a-8h (MLG/trilayer WSe₂/MLG) as a function of θ and V_{b}, for three values of the back-gate voltage V_{BG}=+10V, 0V, −10V respectively. d-f. Corresponding theoretical calculations

FIGS. 19a-f: Back-Gate voltage dependence of dI/dV. The same measurement as in FIGS. 18a-f but now showing the (simultaneously measured) conductance, dI/dV. a-c. Experiment. d-f. Theory.

FIGS. 20a-f: Back-Gate voltage dependence of d²I/dV². The same measurement as in FIGS. 18a-f, 19a-f but now showing the second derivative, d²I/dV², obtained by numerically deriving the data in FIG. 19 a-c. Experiment. d-f. Theory.

FIG. 21: Schematic of the MLG-MLG tunneling junction for experiments with a finite back gate voltage. The main panel shows the theoretically derived lines in the θ−V_{b} plane, which correspond to the momentum-resolved ‘onset’ and ‘nesting’ conditions. Compared to the charge-neutral case, the ‘nesting’ line becomes “bell-shaped” and asymmetric in bias, and the ‘onset’ lines split to four lines. Right and left insets show the theoretically calculated energy band alignments at select points along these lines. Top inset shows how the bias divides between the chemical potential of the two layers, μ_{T} and μ_{B}, and the relative electrostatic energy shift of the bands, ϕ.

FIGS. 22a-b. a. Measured and b. Calculated d²I/dV² vs. θ and V_{b}, at V_{BG}=−10V (similar to FIGS. 20c,f). The overlaid black dotted lines correspond to the theoretically calculated k-resolved ‘onset’ conditions, as shown in FIG. 21. Horizontal dashed lines indicate the two biases at which each one of the MLG crosses through charge neutrality (μ_{B}=0 or μ_{T}=0).

S7. Electron Lifetime in MLG-MLG k-Resolved Tunneling Experiment

The dominant mechanism setting the width of the features in the inventors' measurement is thermal smearing. All measurements so far have been performed at room temperature, leading to k_{B}T˜25 meV smearing entering via the Fermi-Dirac functions in Eq. S4.5. To quantitatively explain our data, the inventors find that they should also include smaller smearing due to finite electron lifetime. The electron lifetime is encoded in the spectral functions of the bottom and top layers,

$${A}_{B} ( ϵ , k ) = \frac{2 {γ}_{B}}{{( ϵ - {ϵ}_{B} ( k ) )}^{2} + {γ}_{B}^{2}} and$$

$${A}_{T} ( ϵ , k ) = \frac{2 {γ}_{T}}{{( ϵ - {ϵ}_{T} ( k ) )}^{2} + {γ}_{T}^{2}} ,$$

where ∈_{B}(k) and ∈_{T}(k) are the energy bands of these layers, and γ_{B}, γ_{T} are their corresponding inverse electron lifetimes. Finite lifetime leads to a Lorentzian broadening of the spectral functions, which could be directly observed in the width of the features in the measurements.

FIG. 23 plots the measured I vs. θ at small bias, V_{b}=40 mV, (black line, same as the inset in FIG. 8a in the Additional Description). Compared with theoretical curves broadened by k_{B}T=25 meV and with various inverse lifetime values, γ₀, the inventors see that the value that best fits the measurement is γ₀˜4 meV. At higher biases (of the order of the Fermi energy) the inventors generally have observed shorter lifetimes. The dependence of the lifetime on energy is expected to be complicated in this energy range. The inventors have found a reasonably good fit to the phenomenological expression used previously, where γ=γ₀+γ₁|∈−μ|, with the γ₀ above and γ₁≈0.035.

The data shown in FIG. 23 allows for determining the electron lifetime at low bias. Black curve corresponds to the measured tunneling current, I vs. rotation angle θ, at small bias V_{b}=40 mV, for the junction in FIGS. 8a-8h (same as the right inset in FIG. 8a). Colored curves in the figure correspond to the theoretically calculated k-resolved tunneling current (see text) with room temperature broadening k_{B}T=25 meV and various values of inverse electron lifetime, γ₀ (see key).

### S8. Understanding MLG—TBG Momentum Resolved Tunneling Experiments

In this section, the inventors explain the various features observed in the momentum resolved tunneling experiments between MLG and TBG, shown in FIGS. 9a-9b. The inventors first have used a simple toy model to explain the main mechanism leading to the quantitative energy band mapping in their experiment—tracing the bands of the sample with a Dirac point of the probe. As the inventors show, this mechanism directly probes the dispersion of the bands and is insensitive to their filling. The inventors then expand the discussion to include additional momentum-resolved tunneling ‘onset’ features that appear when the Fermi level of one side (tip/sample) crosses the energy bands of the other side. The inventors end by showing how these features appear in the full momentum resolved calculation, which includes the multitude of energy bands obtained within the BM model of TBG as well as finite temperature effects.

S8.1 First Toy Model—Tracing Energy Bands with a Dirac Cone.

Here the inventors show the ability of using a Dirac cone to trace the energy bands of a sample, i.e., a method to read off the samples band structure. The inventors conceive a toy model of a probe layer with a Dirac dispersion scanning a system with arbitrary energy bands. For simplicity, the inventors set the tunneling matrix element to be a momentum-independent constant. The results of the toy model depend on the relative Fermi velocity of the probe and system: v_{F}_{_{probe}} and v_{F}_{_{syst}} Close to the intersection point with the probe's dispersion, the system's band can be linearized with Fermi velocity v_{F}_{_{syst}}. The energy offset between the Dirac point of the probe and the system's band is denoted by Δ_{ε}. This offset can be tuned by changing the bias voltage between the probe and the system. The inventors have considered three situations: 1. v_{F}_{_{probe}}>v_{F}_{_{syst}}; 2. v_{F}_{_{probe}}=v_{F}_{_{syst}}; 3. v_{F}_{_{probe}}<v_{F}_{_{syst}} The tunneling occurs in an energy window set by the bias voltage, where the states in the system are empty and the states in the probe are full (or vice versa). The inventors denote this energy window by ε₁≤ε≤ε₂. For simplicity, the inventors set T=0 and neglect the electron lifetimes (i.e., the inventors treat the electrons as free).

In the case where v_{F}_{_{probe}}>v_{F}_{_{syst}}, the intersection between the energy surfaces of the probe and the system is an ellipse. The inventors assume that the entire ellipse is contained within the energy window [ε₁, ε₂] where the tunneling takes place. Then, using Eq. (S4.5), the inventors obtain:

$$I ∝ {\vert {T}_{TB} \vert}^{2} \frac{\vert Δε \vert}{4 π {v}_{{F}_{probe}}^{2}} \frac{{( {v}_{{F}_{probe}} / {v}_{{F}_{syst}} )}^{3}}{{[ {( {v}_{{F}_{probe}} / {v}_{{F}_{syst}} )}^{2} - 1 ]}^{3 / 2}} , ( {v}_{{F}_{probe}} > {v}_{{F}_{syst}} ) \qquad ( S10 \text{.1} )$$

where T_{TB} is the tunneling matrix element. Hence, the current is minimal when the Dirac point coincides the system's dispersion (|Δε|=→0). At this point, d²I/dV² is strongly peaked. Thus, in this situation, the peak in d²I/dV² can be used to directly read off the system's band structure (see FIGS. 24a, b). In the limit v_{F}_{_{probe}}=→v_{F}_{_{sys}}, the size of the elliptical intersection between the two dispersion diverges, and it extends outside the window [ε₁, ε₂]. Hence, Eq. (S10.1) is not applicable in this limit.

If v_{f}_{_{probe}}=v_{f}_{_{syst}}, the intersection between the energy surfaces is a parabola. The tunneling current is

$$I ∝ {\vert {T}_{TB} \vert}^{2} \frac{\sqrt{2} \vert Θ ( Δε ) {ε}_{2} + Θ ( - Δε ) {ε}_{1} {\vert}^{3 / 2}}{3 {( 2 π )}^{2} {v}_{{F}_{probe}}^{2} {\vert Δε \vert}^{1 / 2}} , ( {v}_{{F}_{probe}} = {v}_{{F}_{syst}} ) \qquad ( S10 \text{.2} )$$

Interestingly, the current diverges as |Δε|→0. This divergence corresponds to the nesting condition in the MLG-MLG tunneling junction. The divergence is regularized by introducing a curvature to the bands, or a finite lifetime of the electrons in the system and the probe.

Finally, for v_{F}_{_{probe}}<v_{F}_{_{syst}}, the intersection is a hyperbola. In this case, the singular part of the current at small |Δε| is

$$I ∝ - {\vert {T}_{TB} \vert}^{2} \frac{\vert Δε \vert ln \vert \frac{Θ ( Δε ) {ε}_{2} + Θ ( - Δε ) {ε}_{1}}{Δ ε} \vert}{4 π {v}_{{f}_{probe}}^{2}} \frac{{( {v}_{{F}_{probe}} / {v}_{{F}_{syst}} )}^{3}}{{[ 1 - {( {v}_{{F}_{probe}} / {v}_{{F}_{syst}} )}^{2} ]}^{3 / 2}} \cdot ( {v}_{{F}_{p r o b e}} < {v}_{{F}_{s y s t}} ) \qquad ( S10 \text{.3} )$$

I.e., in this case, the current has a maximum at Δε=0. At this point, d²I/dV² shows a minimum. This is the case for the Dirac point of TBG—with slower Fermi velocity—tracing the MLG dispersion.
S8.2 Second Toy Model—Explaining the k-Resolved ‘Onset’ Features

In the previous section the inventors have explained the main features in their experiment that visualize the energy bands as resulting from tracing with a Dirac point. In addition to these, the inventors have seen features in the measurement (FIGS. 9a-h) that correspond to ‘onset’ conditions of the momentum resolved tunneling. These occur whenever the Fermi surface of one side (tip/sample) crosses the energy bands of the other side. In this section, the inventors use a more elaborate model that captures these ‘onset’ features and identifies their origin. The inventors will further show that these ‘onset’ features are strongly smeared by temperature, whereas the ‘Dirac matching’ features discussed in the previous subsection are largely insensitive to temperature.

To capture the essential physics, the inventors have used a second toy model that includes Dirac bands that represent the MLG and two parabolic bands, ∈_{k±}=±(Ak²+W/2), which mimic the conduction and valence flat TBG bands along the K_{bot}−M−Kₜₒₚ trajectory in momentum space. In addition, the model also keeps track of the chemical potentials in both systems. The Dirac and Parabolic bands are shown explicitly in FIG. 24a. For simplicity, the inventors have focused only on a relative rotation angle of θ=0° between the MLG and TBG and calculate the current and its derivatives as a function of bias. FIG. 24b, shows I vs. V_{b} calculated within this model, assuming a low temperature (k_{B}T=1 meV). The corresponding d²I/dV² is shown in FIG. 24c. For the electrostatics, the inventors have assumed a simple linear relation between the chemical potential of the layers and the applied bias, μ_{T}=−0.4V_{b} and μ_{B}=0.2V_{b}, which approximates rather well the full electrostatics of the real MLG-TBG junction.

At small V_{b}, the current is zero since there are no energy-momentum conserving states in the tunneling energy window (represented by a white window in FIG. 24a and insets to FIG. 24b) between the chemical potentials of the two layers (red and blue dashed lines). Then, at a finite V_{b} (˜0.18V for the parameters of FIG. 24b), the current exhibits a sharp step increase, that occurs when the Fermi level of the Dirac band (red dashed) crosses the occupied parabolic energy bands (left inset, FIG. 24b, crossing indicated by the black arrows). This is the ‘onset’ point where momentum conserving current first becomes available. At this bias, at zero temperature, the current discontinuously jumps to a finite value because a full circle of energy-momentum conserving states shared by the Dirac and parabolic bands becomes abruptly available. In the second derivative, d²I/dV², the step of I shows up as a plus-minus dipole (FIG. 24c). With a further increase of V_{b}, the Dirac cone shifts down with respect to the parabolic bands and the circle of energy-momentum matched states (now deep below the Fermi energy) shrinks. Consequently, the current decreases linearly with V_{b}. It reaches a minimum when the Dirac point exactly crosses the parabolic band and the circle shrinks to a single point (center inset, FIG. 24b). In the second derivative, this minimum translates to a peak. This is the ‘Dirac matching’ condition, discussed in the previous section. Upon a further increase of V_{b}, the energy-momentum conserving circle of states grows back again, leading to a linear increase of I, until a second onset condition occurs, where the Fermi level in the parabolic bands (dashed blue) crosses the empty Dirac bands (right inset, FIG. 24b). This second onset leads to another step in I and to a second diploe in d²I/dV².

The calculation in FIGS. 24a-c was performed with a low temperature, such that it would be easy to identify the various features. Before relating the predicted features with the inventors' experiment, the smearing of different features at elevated temperatures is discussed.

FIGS. 24a-c: A second toy model, explaining the momentum resolved features. a. Schematic band alignment of a toy model comprising of Dirac (red) and parabolic (blue) bands. The Fermi levels in the Dirac and parabolic bands are marked by dashed red and blue lines, correspondingly. The bias, V_{b}, gives the distance between these two Fermi energies. Also indicated are the chemical potentials of the top and bottom layers, μ_{T} and μ_{B}, and the energy band shift (=the electrostatic potential), ϕ. Darker regions around the Fermi energies represent the thermal smearing due to room temperature. b. and c. are the calculated/and d²I/dV² as a function of V_{b} at θ=0°. Three distinct features are marked by dashed lines. Top insets show the calculated relative band alignment between the Dirac and parabolic bands, that correspond to these features. Black arrows represent the energy-momentum matching states at every condition.

### S8.3 Temperature Dependence of ‘Onset’ and ‘Dirac Matching’ Features

FIG. 25 shows temperature dependence of tunneling vs. bias in the second toy model; the figures plot the current and its second derivative at θ=0° at two temperatures. The figure shows how the ‘onset’ and ‘Dirac matching’ features evolve between low temperature (k_{B}T=1 meV, blue) and room temperature (k_{B}T=25 meV, dashed red). Clearly, the steps in I that correspond to the ‘onset’ conditions gets smeared with temperature (panel a). The corresponding dipoles in d²I/dV² (panel b) are also smeared. Thus, their amplitude is significantly reduced. In contrast, the d²I/dV² peak that corresponds to the ‘Dirac matching’ condition is hardly affected by the temperature. This highlights the different mechanisms at play—the ‘onset’ conditions occur when a Fermi energy crosses an available band. Temperature broadens the Fermi-Dirac distribution around the Fermi energy, which leads to smearing of these features. In contrast, the ‘Dirac matching’ feature occurs deep inside the bias window. If the temperature is smaller than the distance between the Dirac point and the edges of the bias window, then these features would be unaffected by the thermal smearing. Instead, their width represents the intrinsic electronic lifetime.

S8.4 Comparing the Second Toy Model with the Experiment

The inventors have compared the second toy model with the measurements. FIG. 26a shows a zoom-in of the central part of one of the flat bands in the measurement in FIG. 9d, where it exhibits a parabolic shape. The inventors could see that a single band generates three curved features in d²I/dV², marked A, B, and C in the figure, corresponding to a maximum/minimum/maximum (red/blue/red) of d²I/dV². The toy model, calculated with k_{B}T=25 meV (FIG. 26b) qualitatively reproduces all three features. FIGS. 26c, d show I vs. V_{b} along a line cut at θ=0° (black dashed line in panels a, b) in the measurement and model, respectively. FIGS. 26e,f plot the corresponding d²I/dV² traces. By comparing this cut to FIG. 25 the inventors could see that the pair of A/B (maximum/minimum) features correspond to the d²I/dV² dipole that results from the first ‘onset’, and that feature C (maximum) is the peak that corresponds to the ‘Dirac matching’. To see this more directly, the inventors have plotted in FIG. 26g the band alignment in the model for the transition point between the A and B features, and for the peak of the C feature. Indeed, the inventors could see that the assignment fits well these two conditions, even in this higher temperature calculation. In the experiment (FIG. 26e), the inventors see the same features, at similar biases, although the relative amplitudes are somewhat different. The inventors also note that in the experiment these features are sitting on top of a background current that increases with V_{b}. This background corresponds to thermally activated current above the WSe₂ barrier, which is present in the experiment and not in the simple toy model.

FIGS. 26a-g. a. Measured d²I/dV² vs θ and V_{b} from FIG. 9d, zoomed-in around features originating from the TBG flat bands. Three features are marked by A, B and C (red, blue, red). b. Corresponding calculation based on the toy model in section S8.2 with k_{B}T=25 meV. c. I vs. V_{b} along a line cut at θ=0° in the measurement (dashed black line in panel a). d. Similar linecut through the model calculation in panel b. e. and f. corresponding second derivative, d²I/dV², vs. V_{b} traces. g. The band alignments that correspond to the V_{b} points marked in panel f. Red/blue bands correspond to the Dirac and parabolic bands. Red/blue dashed lines are the Fermi energies in these two systems. The gray area marks the energies outside the bias window.

S8.5 the Full Calculation—Origin of the Features in the MLG-TBG k-Resolved Tunneling.

Having identified the main features in our experiments using toy models, the inventors have arrived to showing how these features appear in the full calculation

(FIG. 9e), which includes the multiple TBG bands (flat and remote) of the BM continuum model.

In FIG. 27a the inventors have reproduced the theory plot of FIG. 9e, showing d²I/dV² as a function of θ and V_{b}, and highlight special points at which the inventors show the calculated band alignment. FIG. 27b plots the same points over a traced-out version of the measurements. In the rest of the panels, the inventors have presented the calculated band alignments along each of the traced features. In panel c the inventors have shown five points along the flat band feature (blue). The theory-derived band alignments at these points are shown in the right panels. The inventors have clearly seen that along this feature the Dirac point of the MLG traces the TBG flat band. In panel d, the inventors have followed the band alignment along the traced-out purple feature. Notably, here the right Dirac cone of the TBG flat bands is tracing the bands of the MLG. In panel e, the inventors have shown points along the ‘remote bands’ features. The band alignment diagrams show that this feature appears when the MLG Dirac point is tracing these bands, similar to the mechanism through which the flat bands are traced.

The inventors have concluded that the MLG Dirac feature that appears prominently in their measurement (indicated by purple lines in FIG. 27b) allows to convert the applied V_{b} to the actual energy shift between the bands. The procedure is similar to that in the MLG-MLG experiment: given that the v_{F} in their MLG probe is known, they have been able to relate the angle along which the feature appears to the energy shift between the bands by ϕ=ℏv_{F}K_{D}θ (inventors have used here one of the two Dirac features observed in the measurement, and measure θ from its crossing point). The ϕ(V_{b}) extracted in this way is shown in FIG. 28 (red dots) and compared to the theoretically calculated curve based on the inverse compressibility of TBG and MLG, which add up in series in the electrostatic solution. The inventors have found that these agree well. This method of using the MLG probe dispersion, which inherently appears in the inventors' measurements, allows to convert the V_{b} axis into an energy shift and plot directly the E(k) relation of the imaged bands. The inventors have used this in FIGS. 9a-h and 10a-e to directly compare the bands with the theoretical predictions.

FIGS. 27a-e. a. Calculated d²I/dV² vs. θ and V_{b} similar to FIG. 9e, but with overlayed points for which the inventors present the band alignment. b. tracing of the major features in panel a, which include the TBG flat bands (blue), MLG Dirac bands (purple) and TBG remote bands (black) c. band alignment for five points along the TBG flat bands features. d. Same, for five points along the MLG Dirac features e. Same, for three points along the remote band feature. In the individual panes the MLG and TBG bands are plotted by red and blue, their Fermi energies are plotted by correspondingly colored dashed line, and the greyed-out area shows the region that is outside the bias window.

FIG. 28. The energy band shift, ϕ, as a function of V_{b}, (red dots) extracted from the feature that follows the MLG bands in the MLG-TBG measurement in FIG. 9d. The black line is the theoretically calculated ϕ(V_{b}) using the inverse compressibilities of MLG and TBG and a geometric capacitance C_{g}=1.90 μF/cm².

Experiments with a Probe of a Smaller Lateral Size

Additionally, the inventors have checked that their experimental techniques are useful also for providing probes with a vdW heterostructure of support and active layers and forming a plateau of at least one size being about 10 nm at the apex. While such a size would not lead to a momentum resolution achievable with probes with plateaus of more than 50 nm size, they are useful for measuring local parameters of the electronic structure, and have a higher chance not to suffer from debris than those CAFM tips which have to be coated with harder tip materials or coatings like conductive diamond-like coatings or platinum silicide mentio.

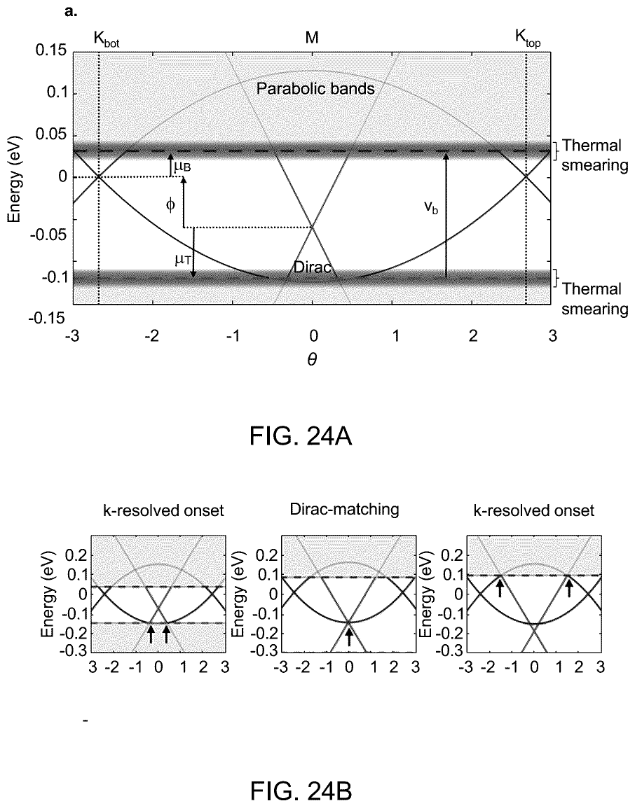

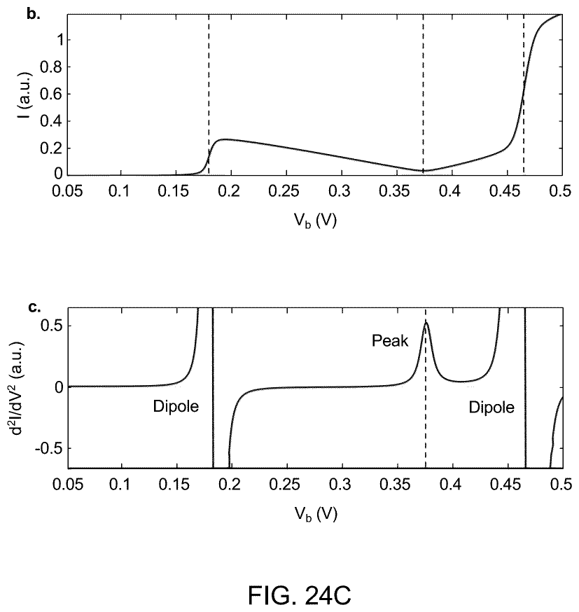

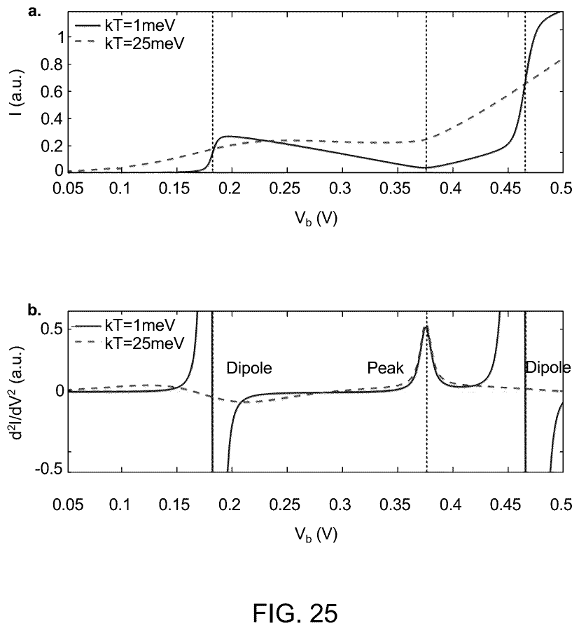

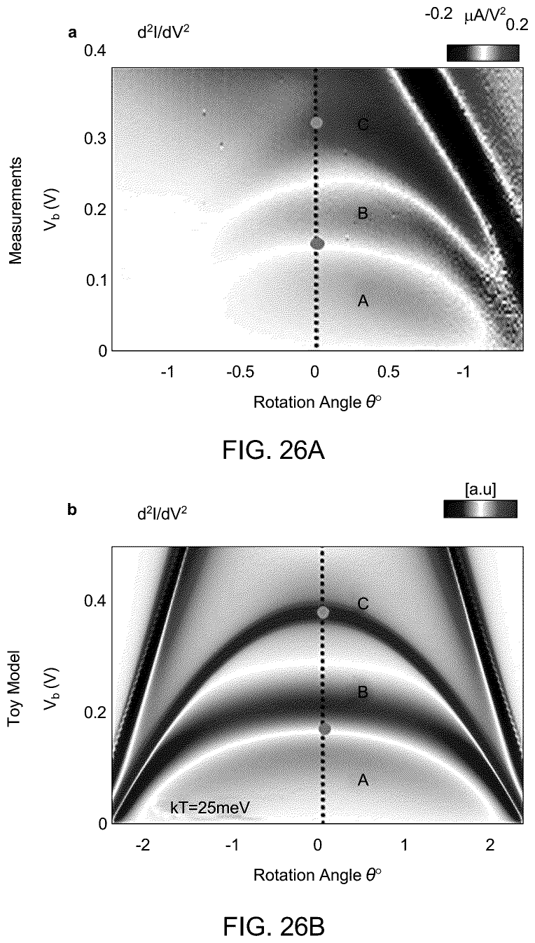

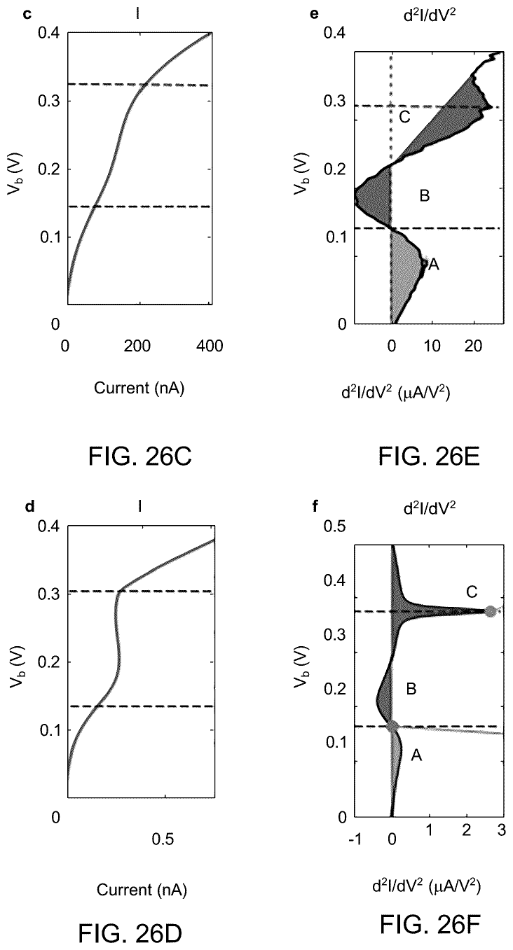

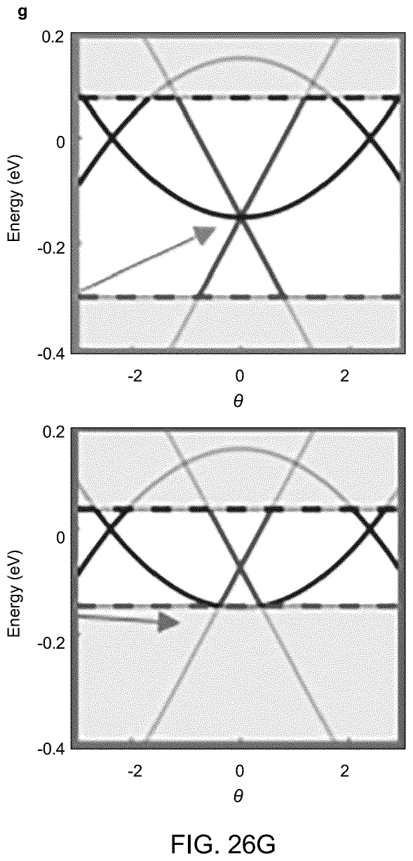

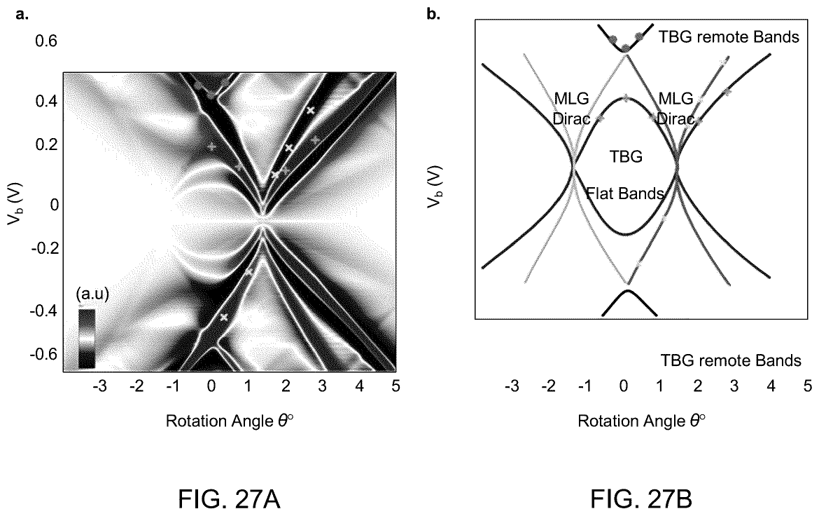

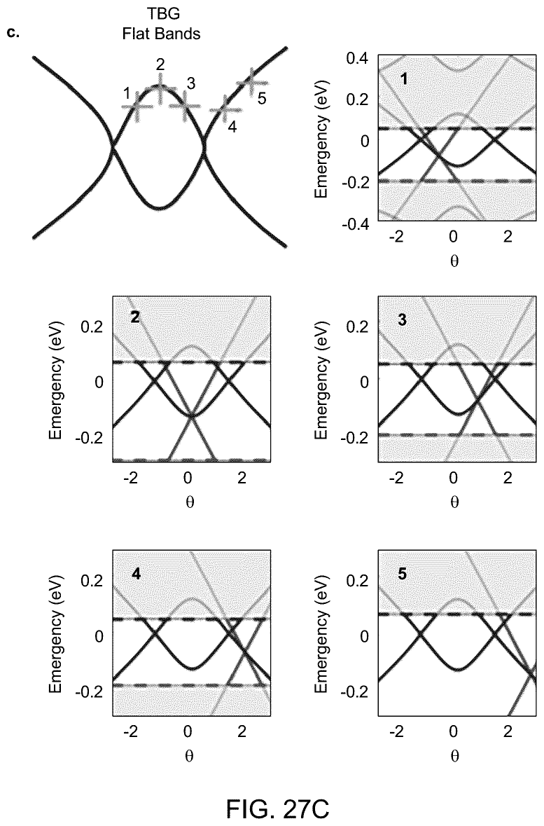

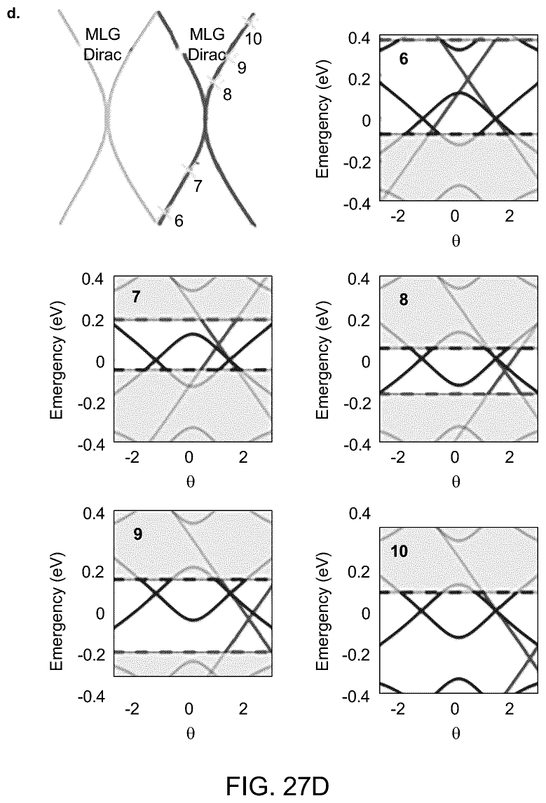

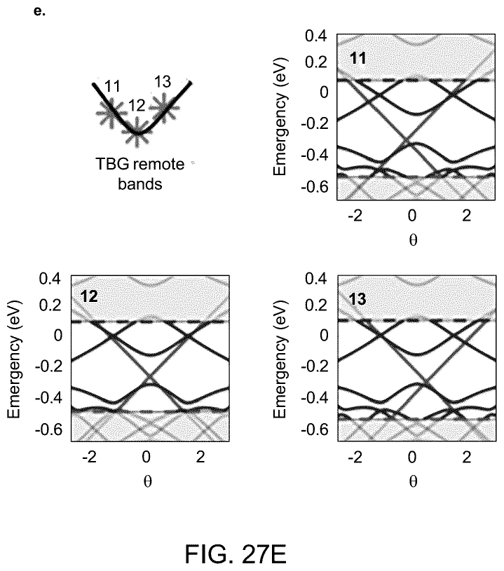

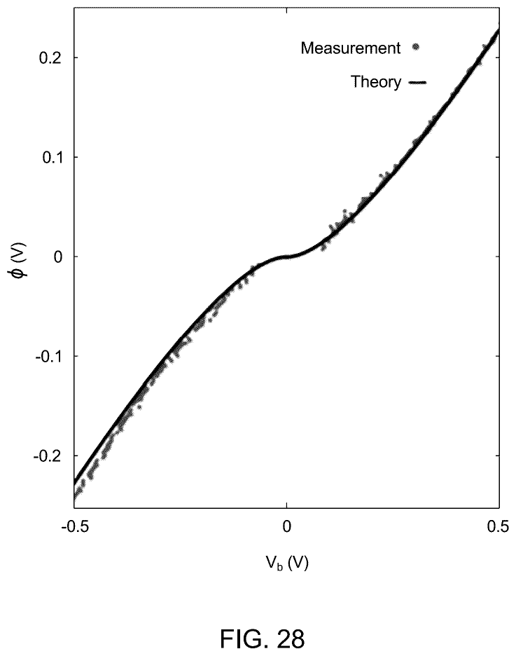

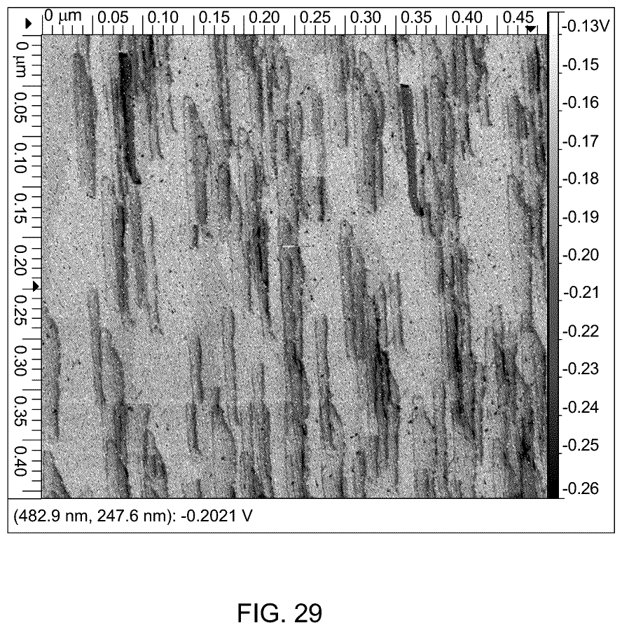

The inventors have fabricated such a probe and measured a current through it to a conductive sample coated with a defect-assisted tunnel layer having multiple atomic defects. Thus, the probe was moved along the surface of the sample and was imaged multiple times by these defects. Such an image of the whole area of sample is presented in FIG. 29: it includes multiple images of the elongated tip of about 10 nm size in one direction and 100 nm a perpendicular direction.

The coupling between electrons and phonons is one of the fundamental interactions in solids, underpinning a wide range of phenomena such as resistivity, heat conductivity, and superconductivity. However, direct measurements of this coupling for individual phonon modes remain a significant challenge. In the present disclosure, the inventors introduce a novel technique for mapping phonon dispersions and electron phonon coupling (EPC) in van der Waals materials. By generalizing the quantum twisting microscope to cryogenic temperatures, the inventors demonstrate its capability to map not only electronic dispersions via elastic momentum-conserving tunnelling, but also phononic dispersions through inelastic momentum-conserving tunnelling. Crucially, the inelastic tunnelling strength provides a direct and quantitative measure of the momentum and mode resolved EPC. This technique is used to measure the phonon spectrum and EPC of twisted bilayer graphene (TBG). Surprisingly, it is found that unlike standard acoustic phonons, whose coupling to electrons diminishes as their momentum goes to zero, TBG exhibits a low energy mode whose coupling increases with decreasing twist angle. It is shown that this unusual coupling arises from the modulation of the inter-layer tunnelling by a layer-antisymmetric “phason” mode of the moiré system.

The technique of the present disclosure thus provides for probing a large variety of neutral collective modes that couple to electronic tunnelling, including plasmons, magnons and spinons in quantum materials.

Electron-phonon coupling (EPC) plays a key role in determining the thermal and electrical properties of quantum materials. In monolayer graphene, for instance, an exceptionally weak EPC5 results in ultra-high electronic mobility, micrometer-scale ballistic transport6 and hydrodynamic behavior. In contrast, the nature of EPC in moiré systems is much less understood. Various theories have attributed superconductivity and the “strange metal” behavior in magic-angle twisted bilayer graphene (MATBG) to a strong coupling of electrons to optical or acoustic phonons. Specifically, it has been emphasized that in addition to the phonons of the individual layers, twisted interfaces with quasiperiodic structures exhibit unique phononic modes involving an anti-symmetric motion of atoms in the two layers. These modes, dubbed moiré phonons or phasons resemble acoustic modes and constitute a new set of low-energy excitations. It was proposed that phason modes may induce strong electronic effects because the moiré pattern acts as an amplifier-small shifts on the atomic scale lead to significant distortions of the moiré pattern, which in turn strongly couples to the moiré energy bands.

Existing techniques for probing phonon dispersions and EPC rely on inelastic scattering of photons (ARPES, Raman and X-Ray), electrons (EELS), or neutrons as well as on indirect measurement through the effect of EPC on electrical resistance. However, it remains challenging to extract the EPC quantitatively, especially for the low-energy acoustic modes, which are central to the physics at low temperatures.

In the present disclosure, the inventors developed a novel cryogenic quantum twisting microscope (QTM) and used it to directly map the phonon spectrum and mode-resolved EPC in twisted bilayer graphene (TBG). The measurements of the conductance between continuously twistable graphene layers, described below, reveal a series of steps indicative of inelastic tunnelling processes involving phonon emission. The evolution of these steps with twist angle demonstrates that these processes are momentum resolved. The inventors have utilized these effects to generate a full map of the phonon dispersion. By controlling the Fermi levels of the graphene layers and their contact interface area, the inventors have precisely determined the mode- and momentum-dependent EPC. Interestingly, the inventors observe a low energy mode whose coupling increases with decreasing twist angle. It is shown below that this results from a layer-antisymmetric phason mode that couples directly and strongly to the inter-layer tunnelling and its significance is discussed for the low-temperature physics of TBG.

Measuring Phonon Dispersion with the Cryogenic QTM

Reference is made to FIGS. 30a to 30h showing the measurement of phonon dispersion with the novel cryogenic QTM of the present disclosure.

FIG. 30a shows the cryogenic QTM of the disclosure, which includes two nanopositioner towers facing each other (main panel). One tower is equipped with three translational degrees of freedom (XYZ) and carries a flat sample. The opposing tower holds an atomic force microscope cantilever (AFM) and has a rotational degree of freedom (θ) as well as two lateral degrees of freedom for positioning the AFM tip at the center of rotation. The entire assembly is cooled down in vacuum to liquid helium temperatures. The inset of FIG. 30a shows schematically the experiment, in which inventors bring into contact a van der Waals (vdW) heterostructure on the tip with a flat vdW heterostructure on the bottom sample, creating a two-dimensional interface, typically a few hundred nanometers across in both directions. vdW attraction between the two heterostructures self-cleans the contact area, leading to a pristine interface. This arrangement allows the inventors to form a continuously twistable interface between the two vdW materials at T=4K. The tip and sample remain in continuous contact throughout the experiment, including during any twisting or scanning operation. Self-sensing AFM cantilevers equipped with piezoresistive elements are used for monitoring and maintaining a constant force, ensuring that the contact interface's area remains constant during the scans. The QTM junctions described herein do not have a tunnelling barrier separating the two conducting sides (apart from FIGS. 32b and 32c where defects in WSe₂ barrier were used to image the tip shape). This means that the resistance of the tunnel junction, especially at low twist angles or at high bias can be comparable or lower than the resistance of the contacts or of the bulk of the 2D layers leading from the contact to the junction. The inventors obtain this contact resistance from measurement close to zero degrees twist angle, and then directly calculate how much bias drops on the contact resistance and how much drops on the junction, V_{b}, which is the variable used throughout the description.

The inventors begin the experiments with a twisted interface formed between two graphite layers, both several tens of nm thick shown schematically in FIG. 30b. The bias across the interface, V_{b}, is set, and the tunnelling current, I, and conductance, G=d I/dV_{b} are measured. FIG. 30c shows a measurement of G vs. twist angle, θ for V_{b}=0 mV (black curve) and 50 mV (blue curve). At zero bias (black), G exhibits a pronounced peak at

θ=0° (limited by contact resistance, R_{c}˜500Ω) and smaller peaks at commensurate angles of θ=21.8° and θ=38.2°. These peaks correspond to elastic momentum-resolved tunnelling due to the overlap of the Fermi surfaces on both sides of the interface. At

θ=0°, this is due to the alignment of the Dirac points at the corners of the first Brillouin zone (BZ), and at θ=21.8°, 38.2° the overlap occurs at higher BZs. Away from commensurate angles, the Fermi surfaces do not overlap, and the zero bias conductance reflects momentum-non-conserving processes in the experiments, which may originate from atomic defects or tip edges. Remarkably, the measured G at θ=30° is about six orders of magnitude lower than at θ=0°, demonstrating extreme level of momentum conservation to a few parts per million. At finite bias (V_{b}=50 mmm, blue), G increases significantly across all twist angles, indicating the activation of inelastic tunnelling channels. The bias dependence of G at θ=30° (FIG. 30d) shows that it rises in steps, signifying the onset of discrete inelastic tunnelling processes. Similar steps were observed in scanning tunnelling microscopy studies of graphene and with fixed-angle tunnelling devices and were associated with inelastic electron tunnelling mediated by phonon emission.

Given that the QTM is a momentum-resolved tunnelling probe, it is natural to ask whether the observed inelastic processes are momentum-conserving by probing their evolution with twist angle. FIG. 30e shows G measured over a wide range of twist angles (θ=0°-55°) and as a function of V_{b}, revealing again that G increases in steps with bias. Importantly, the inventors observe that the turn-on bias of these steps varies smoothly with θ. This becomes even more apparent when plotting the second derivative, d²I/dV_{b}² (FIG. 30f), which exhibits sharp peaks at the steps' turn-on biases. The measurement reveals a rich spectrum of low-energy peaks that slowly disperse with θ. The peaks exhibit a mirror symmetry about θ=30°, as well as a mirror symmetry between positive and negative biases. Near θ=21.8° and θ=38.2°, additional peaks are observed which disperse more rapidly with θ. Recalling that θ and V_{b} are proxies for momentum and energy and that near θ=21.8° and θ=38.2° the tunnelling is elastic and is probing the electronic bands that disperses with the Fermi velocity, the inventors recognize that the observed low energy peaks reflect modes that are significantly slower than the electronic Fermi velocity. The theoretically calculated phonon spectrum of graphite (dashed black) shows excellent agreement with the slowly dispersing peaks.

To understand these observations, momentum space is considered. FIG. 30g shows the Fermi surfaces in k-space of the top (blue) and bottom (red) graphite layers, and FIG. 30h shows the corresponding energy bands. Although graphite's band structure is rather complex, it is easy to see that if two graphite flakes are twisted with respect to each other by more than a few degrees, the momentum mismatch between their bands is too large to allow elastic momentum-conserving tunnelling. However, phonons have much shallower dispersion, thus phonon emission at a small V_{b} may suffice to supply the missing momentum, qₚₕ=2K_{D} sin(θ/2) (FIG. 30h, K_{D} is the Dirac point momentum) in an inelastic tunneling process across the interface. Phonon emission turns on when the bias is larger than the phonon energy at this momentum, e V_{b}>ℏωₚₕ(qₚₕ). Thus, the positions of the d²I/dV_{b}² peaks in the θ−V_{b} plane directly trace the phonon spectrum. Indeed, overlaying the theoretically calculated spectrum for bulk graphite (dashed lines) over the experiment shows excellent agreement. Specifically, the inventors can identify various acoustic (TA, ZA) and optical (LO, TO, ZO) branches and follow their dispersion across a wide momentum range, spanning a substantial portion of the BZ. The observed mirror symmetry about θ=30° can be understood from the fact that for each electron tunnelling from the K point in the top layer and emitting a phonon corresponding to θ, there is an equivalent process with an electron tunnelling from the K′ point and emitting a phonon corresponding to (60°−θ). However, since graphite has a complex band structure, and the twisted interface between graphite flakes has phonons both in the graphite's bulk and at the interface, it is instructive to switch to a simpler system that will allow us to better understand the underlying electron-phonon coupling mechanisms.

### Electron-Phonon Coupling in Twisted Bilayer Graphene

In the following, the system of twisted bilayer graphene (TBG) in which electron phonon coupling is believed to be of prime importance is described with reference to FIGS. 31a to 31i. The inventors create a tunable TBG system by bringing an hBN-backed monolayer graphene, placed on a tip, into contact with another monolayer graphene on a bottom sample that incorporates a buried graphite gate (FIG. 31a). When in contact, the Dirac cones of the two graphene layers, now at the corners of a mini-BZ, hybridize to yield the TBG energy bands (color-coded in FIG. 31c by layer weight). The G and d²I/dV_{b}² in this twistable TBG, measured as a function of θ and V_{b}, are shown in

FIGS. 31d and 31e. The steps in G (peaks in d²I/dV_{b}²) disperse with V_{b}, demonstrating that the phonon spectrum in TBG, mapped by this measurement, is similar to that in bulk graphite (dashed lines).

A key feature of the momentum-resolved inelastic tunnelling technique of the present disclosure is that it allows to directly determine the mode- and momentum-dependent EPC. As will be shown below, the height of the step in G, or equivalently the area under the peak in d²I/dV_{b}² is directly proportional to the strength of the EPC. Looking at the measurements in FIGS. 31d and 31e, the inventors recognize that the EPC varies significantly between the different phonon branches. Around V_{b}˜160 mm, a pronounced step in G is seen that corresponds to the optical phonons (LO and TO). Indeed, strong EPC to optical phonons is expected in monolayer graphene and is believed to play an important role in MATBG. More puzzling behaviors are observed in the acoustic branches: first, while the peaks corresponding to the out-of-plane and transverse modes (ZA and TA) are evident, the longitudinal mode (LA) is conspicuously missing. It has been theoretically proposed that unlike transverse phonons, which are gauge phonons, longitudinal phonons cause unit cell volume changes that lead to charge fluctuations, whose screening should strongly suppress the EPC. However, screening should be relevant for momenta comparable to the Fermi momenta, while the measurement described herein shows that the LA mode's absence extends to much higher momenta. Second, and even more surprising is the twist-angle dependence of the peak height (highlighted in color in a detailed view of the TA branches at positive and negative bias, FIG. 31f). Instead of decreasing with decreasing momentum, as typically anticipated for acoustic modes, the measured EPC actually increases.

To understand these unusual observations, the inventors consider the relevant electron-phonon coupling mechanisms in TBG. The experiment described herein, measures tunneling between the two layers, with electrons scattering between momentum states in their corresponding Dirac cones with a momentum shift of q_{M}=2K_{D} sin(θ/2) (FIG. 31b). This momentum mismatch is provided by a mini-BZ zone boundary phonon, commensurate with the moiré periodicity, emitted through electron-phonon coupling.

The simplest EPC occurs within the layer (an “in-layer” mechanism, FIG. 31g): a phonon modulates the in-layer hopping amplitudes, t_{∥}, scattering the electron within the layer. However, since the measurement of the disclosure probes electrons tunnelling between the layers, this EPC appears in a second-order process: initially, an electron tunnels to a high-energy virtual state with the same momentum in the other layer, with amplitude α=t_{⊥}/(ℏv_{f}K_{D}θ)<<1, followed by phonon emission through in-layer EPC, or vice versa (FIG. 31g). In TBG, there exists another “inter-layer” mechanism that couples electrons to anti-symmetric vibrations of the two layers (FIG. 31h), whose acoustic branch is the TBG's phason. These anti-symmetric vibrations stretch the inter-layer bonds and therefore modify the tunnelling amplitudes between the layers, t_{⊥} (FIG. 31h). This leads to an inter-layer EPC that already contributes to tunneling current in a first-order process.

The unusual behavior of the phason's EPC becomes apparent in the limit of q_{M}→0. The strength of EPC is proportional to the stretching of the atomic bonds by a vibration whose amplitude is the phonon's zero-point-motion (ZPM), ξ_{ZPM}=\sqrt{ℏ/2Mω_{M}} (ω_{M} is the phonon frequency and M is the carbon atom mass). For in-plane bonds, the stretching by ξ_{ZPM} is distributed over many bonds, N˜(q_{M}α)⁻¹ (FIG. 31g), and thus in the limit q_{M}→0, the corresponding in-layer EPC goes to zero, as expected for an acoustic mode. Interestingly, when the layers vibrate anti-symmetrically, the inter-layer bond stretching is directly given by ξ_{ZPM}, independent of q_{M} (FIG. 31h). For a linearly dispersing phason peak height (ωM˜q_{M}) the zero point motion grows with decreasing q_{M} as

$${ξ}_{ZPM} ∼ \frac{1}{\sqrt{{q}_{M}}} ,$$

predicting that as long as ℏv_{F}q_{M}>>t_{⊥} its inter-layer EPC should increase as 1/\sqrt{q_{M}} in the limit q_{M}=→0. In contrast, if q_{M} is held fixed and the wavevector q→0, the EPC to the phason mode vanishes. This can be understood from the fact that a q=0 displacement of the phason mode shifts the moiré pattern uniformly, which does not change the energy of the electronic states for incommensurate twist angles.

To study this quantitatively, the inventors use the QTM's ability to tune and measure key experimental parameters in-situ. The inelastic conductance step in the experiment is directly related to the interlayer, g_{inter-layer}, and in-layer, g_{in-layer}, EPCs via:

$$Δ G = β {A}_{tip} {v}_{B} {v}_{T} ( {\vert {g}_{inter - layer} \vert}^{2} + {α}^{2} {N}_{layer} {\vert {g}_{in - layer} \vert}^{2} ) \qquad ( 1 )$$

where

$$β = {N}_{f} {N}_{b} \frac{2 π {e}^{2}}{ℏ} \frac{{a}^{2} \sqrt{3}}{2} ,$$

N_{f}=4 is the flavor degeneracy (spin/valley), N_{b}=3 is the number of Bragg scattering processes, N_{layer}=2 is the number of layers, a=0.246 nm is lattice constant of graphene and α was defined above. The experiment-specific parameters in Eq. (1) are the tip contact area (Aₜᵢₚ) and the density of states (DOS) of the bottom and of the top layers (v_{B} and v_{T}) all of which can be tuned and measured in-situ.

FIGS. 32a to 32g describe results of experiments related to the area and density of states (DOS) dependence of electron-phonon coupling induced inelastic tunneling. To determine the dependence on tip contact area, the inventors utilize unique QTM capabilities to both modify and image the tip area in-situ. The imaging is achieved by spatially scanning the tip along fixed atomic defects (on an adjacent area with defects in a WSe₂ layer). The current measured in such a spatial scan (FIGS. 32b and 32c) reveals multiple copies of the tip shape, each produced when the tip overlaps a single atomic defect. After using mechanical manipulation away from the experimental region to change the tip size, imaging yields a tip area that is enhanced approximately two-fold (FIG. 32b, tip 1). FIG. 32a shows the G vs V_{b} traces measured for the two tip areas (θ=16.8° in both), featuring conductance steps due to the ZA and TA phonon modes. When G normalized by the measured area is plotted, the curves collapse on each other (FIG. 32a insert), demonstrating that the area dependence quantitatively is captured.

To investigate the dependence on the DOS, the inventors tune the carrier densities in both the top (nₜ) and bottom (n_{b}) layers using a back gate, thereby tuning their DOS according to the Dirac relation: v_{T}˜\sqrt{|n_{T}|} and v_{B}˜\sqrt{|n_{B}|}. FIGS. 32d and 32e display G and d²I/dV_{b}² measured vs. back gate voltage, V_{bg}, and V_{b}, exhibiting steps in G (peaks in d²I/dV_{b}²) that correspond to various phonon modes (labels). Notably, the amplitude of these steps progressively increases with V_{bg}. This is demonstrated in FIG. 32f, which plots G vs V_{b} along linecuts at V_{bg}=2V, 9 V (dashed vertical lines in FIG. 32d). To relate these observations to the DOS, an electrostatic model of the junction is employed that accurately captures the neutrality points of both layers (red and blue dashed lines). The model shows that to a good approximation, both n_{b} and nₜ vary linearly with V_{bg}, implying that v_{T}v_{B}˜\sqrt{|n_{T}∥n_{B}|}. Consequently, it predicts that ΔG should vary linearly with V_{bg}, and that the slope of this linear dependence should flip sign when the carriers' polarity changes. FIG. 32g plots the continuous evolution of ΔG_{TA} with V_{bg} extracted from FIG. 32d, as well as traces extracted from similar maps measured at two other twist angles. Interestingly, for all angles, the measurements show the predicted linear dependence of ΔG_{TA} On V_{bg} and the slope's sign flipping upon carriers' polarity change (full model shown in dashed lines). Most strikingly, ΔG_{TA} increases with decreasing twist angle, showing that the coupling to the TA mode becomes stronger as q_{M} decreases.

The inventors can now determine the EPC from the experiments. Starting with the optical phonons, the inelastic conductance step near V_{b}=160 mV is extracted from FIG. 31d, divided by 2 to account for the approximate degenerate LO and TO modes, normalized by the measured prefactors in Eq. (1), and the resulting quantity, ΔG/2βAₜᵢₚv_{T}v_{B}, is plotted vs. θ in the inset of FIG. 33a (dots). This is compared with the theoretically predicted in-layer (α²N_{layer}|g_{in-layer}|²) and inter-layer (|g_{inter-layer}|²) contributions, calculated using existing models 50. The theory reveals that for optical phonons the inter-layer EPC is negligible, and thus the coupling g_{TO} can be directly extracted by identifying the measurement with the in-layer term. Plotted as a function of θ (main panel), it can be seen that g_{TO} is weakly dependent on θ and amounts to 300-350 meV approximately twice larger than determined by ARPES and in good agreement with Raman.

FIG. 33c analyzes the EPC of the gauge (TA) acoustic phonon, comparing its measured and normalized conductance step (ΔG_{TA}/βAₜᵢₚv_{T}v_{B}, plotted vs. θ in the inset (dots)) with theoretically calculated in-layer and inter-layer terms (lines). Notably, the in-layer coupling contributes negligibly to the gauge acoustic phonons EPC so that the inter-layer coupling, which exists only for a layer antisymmetric mode (phason mode) is dominant. Identifying the measured ΔG_{TA} with this mechanism thus directly provides the gauge phason EPC, gₚₕₐₛₒₙ, plotted vs. θ in the main panel. Remarkably, it can be seen that gₚₕₐₛₒₙ increases with decreasing twist angle as 1/\sqrt{q_{M}}(dashed line). The importance of this coupling becomes evident when it is compared with the measured mode energy, ℏω_{qM}, that diminishes linearly with q_{M} (FIG. 33d). It is noted that the theory also explains the absence of the LA mode in the experiment described here, resulting from an orthogonality between its momentum and polarization.

To contextualize the results of the present disclosure to the observed superconductivity and strange metal behavior in MATBG, it is instructive to consider the dimensionless coupling,

$$λ = \frac{2 {θ}^{2}}{W} \frac{{g}_{{q}_{M}}^{2}}{ℏ {ω}_{{q}_{M}}} ,$$

obtained by integrating the EPC over the mini-BZ (SI 10, W is the flat band width). The inelastic tunnelling measurements of the disclosure extend down to θ=6°, below which they are overwhelmed by elastic tunnelling current. However, to estimate the importance of EPC to the physics near the magic angle, the results are crudely extrapolated to lower angles, assuming that the observed dependence of the phason EPC on q_{M} persists to the magic angle. The inventors obtain that λ_{gauge_phason}=1.1/W [meV]. Additionally, the inventors get that each optical mode contributes λ_{optical}=0.45/W [meV]. Recalling that there are four intervalley-coupling optical modes (LO/TO, Top/Bottom layers), it is found that the phason and optical modes have comparable and possibly important contributions to superconducting pairing. Optical phonons, on the other hand, have too high energy to contribute to the observed linear-in-T resistivity (strange metal) behavior, and here the coupling to the phason is the major source of scattering.

In summary, using the first realization of a cryogenic QTM, the inventors demonstrate a novel technique for measuring phonon dispersions as well as mode- and momentum-resolved EPC in vdW materials. The findings of the disclosure reveal that the phason coupling is at least as important to the physics of TBG as the coupling to optical phonons, and that both couple rather strongly to the electronic degrees of freedom. More generally, the method demonstrated here is applicable to a broad class of vdW materials as well as to mapping the dispersions and couplings of other collective modes including plasmons magnons or spinons making it a powerful new tool for studying collective behavior in quantum materials.

The drawings and the examples of the present disclosure present just some examples of the invented systems and methods. Many variations are possible within the scope of the disclosure, and they can provide ground to further claims than listed below.

1. A probe for mechanically contacting a sample and for use in conducting measurements on the sample, the probe comprising:
a tip having a core with an apex, where the apex is covered by a layer arrangement comprising at least a support layer of a vdW material and an active layer presenting a 2D material of not more than 10 monolayers coupled by vdW forces, the active layer being placed on the support layer at said apex and being thereby further away from the core than the support layer at said apex, wherein
an outer layer of said layer arrangement is an exposed layer,
the layer arrangement is configured to form, upon contact with a planar surface, a contact area with a linear dimension of at least 10 nm.

2. The probe of claim 1, wherein the layer arrangement is configured to conduct an electric current in a lateral dimension through the active layer and in a vertical dimension from the active layer to the planar surface.

3. The probe of claim 1, wherein the core is configured as a generic 3D structure manufactured by one of the following techniques: additive deposition, 3D nano-printing or nano-etching.

4. The probe of claim 1, wherein said exposed layer of the layer arrangement is the active layer.

5. The probe of claim 1, wherein the layer arrangement has one of the following configurations:
(i) the layer arrangement further comprises a tunnel barrier layer which is placed on the active layer and is said exposed layer and is thereby configured to present a flow path for a tunneling current between the active layer and the planar surface, the layer arrangement being configured to conduct the electric current, besides via said tunneling, substantially in the lateral dimension through the active layer;
(ii) the layer arrangement further comprises a defect-assisted tunneling layer which is placed on the active layer and is said exposed layer and comprises at least one atomic defect which presents a flow path for a tunneling current between the sample and the 2D material, the layer arrangement being configured to conduct the electric current, besides via tunneling via the at least one atomic defect in the defect-assisted tunneling layer, and substantially in the lateral dimension and through the active layer;
(iii) the layer arrangement further comprises a gate electrode layer covering the apex and being closer to the core than the support layer.

6. The probe of claim 1, wherein the layer arrangement further comprises a defect-assisted tunneling layer which is placed on the active layer and is said exposed layer and comprises at least one atomic defect which presents a flow path for a tunneling current between the sample and the 2D material, the layer arrangement is configured to conduct the electric current, besides via tunneling via the at least one atomic defect in the defect-assisted tunneling layer, substantially in the lateral dimension and through the active layer, each of the at least one atomic defect has a peak of tunneling conductance at a certain unique voltage between a point on the active layer closest to this defect and a point on the exposed surface of the defect-assisted tunneling layer closest to this defect.

7. The probe of claim 1, wherein said contact area has a linear dimension of at least 20 nm, or 50 nm, or 100 nm, or 150 nm, or 1 μm in one direction.

8. The probe of claim 1, wherein the exposed layer has one of the following configurations: the exposed layer has a flat plateau at the apex; and the exposed layer has a convex surface region at the apex configured to flex under contact with the planar surface into a plateau comprising said contact area.

9. The probe of claim 1, further comprising at least one electrical contact electrode connected to the active layer.

10. The probe of claim 1, wherein there is a space filled with vacuum, or a gas, or a fluidic matter between a section of the layer arrangement and the core.

11. The probe of claim 1, wherein a height of the core is larger than 1 μm and/or smaller than 10 mm.

12. A Scanning Probe Microscope (SPM) apparatus comprising:
a stage configured to carry a sample,
a head configured to hold an Atomic Force Microscope (AFM) cantilever or a Scanning Tunneling Microscope (STM) probe,
a rotation motor configured and operable to perform rotation of the stage with respect to the head or of the head with respect to the stage, and
a control unit configured and operable to control said rotation to provide a desired orientation alignment between the stage and the head.

13. The SPM apparatus of claim 12, further comprising one or more linear motors configured and operable to perform linear lateral translations of the stage in a plane of said rotation, the control unit being further configured and operable to control the linear lateral translations of the stage, such that a selected point of interest of the sample is brought to a center of the rotation during operation of the SPM.

14. The SPM apparatus of claim 13, wherein said one or more linear motors are arranged on top of said rotation motor, thereby providing that, once the linear lateral translations of the stage bring the point of interest to an alignment position with the center of the rotation, said alignment position is maintained during the rotation.

15. The SPM apparatus of claim 12, further comprising an AFM cantilever or an STM probe mounted on said head.

16. The SPM apparatus of claim 12, further comprising the probe of claim 1 mounted on said head.

17. The SPM apparatus of claim 12, characterized by at least one of the following:
the rotation motor and the control unit are configured and operable to provide the rotation of the stage with respect to the head or the head with respect to the stage with an accuracy better than 5 degrees, or 1 degree, or 0.1 degree, or 0.01 degree;
the control unit comprises an output unit configured to send at least one control signal, being an electronic or electromagnetic signal, to the motor;
the stage configured to carry the sample is configured for mounting into an AFM stage or an STM stage,
the stage configured to carry the sample is formed integrally with an AFM stage or an STM stage;
further comprises a positioning unit comprising at least one nanopositioner configured to shift the stage along a straight line.

18. The SPM apparatus of claim 12, further comprising at least one of the following:
a rotation angle measurement unit configured to measure a rotation angle by which the stage has been laterally rotated with respect to the head, or the head has been rotated with respect to the stage, and to send a signal indicative thereof to the control unit, the control unit being configured to control the rotation based on said signal to implement the desired orientation alignment;
at least one tilting unit configured to change a tilt of at least one of the stage and the head to provide alignment between an exposed surface of the sample and one of the AFM cantilever and the STM probe;
a first contact electrode configured to connect to the sample, and a second contact electrode configured to connect to a contact electrode of the AFM cantilever or the STM probe.

19. A Scanning Probe Microscopy (SPM) apparatus, comprising the probe of claim 1, and being configured and operable as one of the following: an Atomic Force Microscope (AFM), a Conductive AFM (CAFM), or a Scanning Tunneling Microscopy (STM).

20. The SPM apparatus of claim 19, being configured as the AFM or STM and comprising:
a stage configured to carry a sample,
a head configured to hold an AFM cantilever or an STM probe to probe a sample carried by the stage,
a rotation motor configured and operable to perform rotation of the stage with respect to the head or of the head with respect to the stage, and
a control unit configured and operable to control said rotation to provide a desired orientation alignment between the stage and the head.

21. The SPM apparatus of claim 20, further comprising one or more linear motors configured and operable to perform linear lateral translations of the stage in a plane of said rotation, the control unit being configured and operable to control the linear lateral translations of the stage such that a selected point of interest of the sample is brought to a center of the rotation during operation of the SPM.

22. The SPM apparatus of claim 21, wherein said one or more linear motors are arranged on top of said rotation motor, thereby providing that, once the linear lateral translations of the stage bring the point of interest to an alignment position with the center of the rotation, said alignment position is maintained during the rotation.

23. The SPM apparatus of claim 19, being configured as the AFM or STM and comprising:
a stage configured to carry a sample,
a head holding an AFM cantilever or the STM probe to probe a sample carried by the stage,
a motor assembly comprising a rotation motor configured and operable to perform rotation of the head, and
a control unit configured and operable to control the rotation of the head with respect to the stage to provide a desired orientation alignment between them.

24. The SPM apparatus of claim 23 further comprising one or more linear motors configured and operable to perform lateral translations of the head with respect to the stage, the control unit being further configured and operable to control the lateral translations of the head to locate a center of rotation of the AFM cantilever or the STM probe in an alignment position above a point of interest of the sample.

25. The SPM apparatus of claim 19, characterized by at least one of the following:
the rotation motor and the control unit are configured and operable to provide the lateral rotation of the stage with respect to the head with an accuracy better than 5 degrees, or 1 degree, or 0.1 degree, or 0.01 degree;
the control unit comprises an output unit configured to send an at least one control signal, being an electronic or electromagnetic signal, to the motor;
the stage configured to carry the sample is configured for mounting into an AFM stage or an STM stage,
the stage configured to carry the sample is configured for mounting to a side of an AFM stage or an STM stage,
the stage configured to carry the sample is formed integrally with an AFM stage or an STM stage;
further comprises a positioning unit comprising at least one nanopositioner configured to shift the stage along a straight line.

26. The SPM apparatus of claim 19, further comprising at least one of the following:
in a rotation angle measurement unit configured to measure a rotation angle by which the stage has been laterally rotated with respect to the head, and send a signal indicative thereof to the control unit, the control unit being configured to control the lateral rotation based on said signal to implement the desired orientation alignment;
at least one tilting unit configured to change a tilt of at least one of the stage and the head to provide alignment between an exposed surface of the sample and one of the AFM cantilever and the STM probe; and
a first contact electrode configured to connect to the sample, and a second contact electrode configured to connect to a contact electrode of the AFM cantilever or the STM probe.

27. The SPM apparatus of claim 19, further comprising:
a first contact electrode configured to connect to the sample, a second contact electrode configured to connect to a contact electrode of the AFM cantilever or the STM probe,
a voltage source configured to apply an electrical voltage between the first electrode and the second electrode, and
a current measurement unit configured to measure a resulting electrical current.

28. The SPM apparatus of claim 27, wherein the voltage source is tunable, and the SPM apparatus further comprises a voltage source control unit configured to vary electrical voltage to scan an electronic structure of the sample.
